(19) United States
(12) Patent Application Publication
(10) Pub. No.: US 2011/0129210 A1
(43) Pub. Date: Jun. 2, 2011

(54) Heros journey 9shooter bracket and totem potem pole micro mini mount apparatus, system, and method for connecting multiple cameras, stills cameras, video cameras, DSLRs, monitors, microphones, flashes, radio receivers, recording devices, mounts, power packs, and more

(75) Inventor: Elliot McGucken, Los Angeles, CA (US)

(73) Assignee: Dr. Elliot McGucken, LA, CA (US)

(21) Appl. No.: 12/928,006

(22) Filed: Dec. 1, 2010

Related U.S. Application Data
(60) Provisional application No. 61/283,240, filed on Dec. 1, 2009.
(60) Provisional application No. 61/398,334, filed on Jun. 24, 2010.
(60) Provisional application No. 61/401,482, filed on Aug. 13, 2010.

(51) Int. Cl. G03B 17/00; G06Q 30/00

(52) U.S. Cl. 396/422; 705/26.5

(57) ABSTRACT

A camera bracket mounting apparatus offering superior simplicity, versatility, and flexibility is disclosed, allowing one to more easily and flexibly combine a plurality of components serving and enhancing the simultaneous capture of video, stills, and/or audio, fostering improved art and commerce. Camera-related devices are becoming smaller while possessing more functionality, calling for the mounts disclosed in this invention allowing novel, simple, and flexible combinations of cameras, mics, lights, radio receivers, flashes, monitors, flash-shoe adapters, flash-shoe mounts, ball-head flash-shoe adapters, threaded screw mounts, and more. Components are becoming smaller, naturally suggesting this invention's smaller and more versatile brackets and mounts. This invention surfs the trends of increased functionality and miniaturization, allowing novel and flexible manners for mounting and combining cameras and devices, and it can be used with monopods, tripods, and DSLR rigs, and it can be mounted above and below cameras, rotated at custom angles, and easily modified and expanded.

### FIELD OF INVENTION

The present invention pertains to camera brackets and mounting devices, and more particularly to simpler, more flexible, and smaller mounting brackets and devices which surf the current trends towards miniaturization of cameras and devices. The current invention allows one to mount and configure multiple cameras, mics, lights, audio receivers, and more. The present invention serves the new paradigm of the Renaissance Man photographer, who seeks to capture some combination of optimum audio, video, and stills. The field of brackets and mounting devices for cameras is a crowded field, and thus small innovations go a long way.

The inventions herein have been embodied in multiple manners and referred to with names including the 45SURFER, the 9SHOOTER, the Dual 45 Dueler, Micro Mini Mounts, Mini Micro Mounts, and Totem Pole Mounts. Hero's Journey Nine Shooter System/Totem Pole Mount™/Mini Multi Mount™/Micro Multi Mount™/and Method for Attaching or Combining a Plurality of Mounts/Adapters/Devices, AudioNideo/Stills Equipment, and Recording Devices Including Digital Cameras, Mounts, Mics/Mounts, Hot Shoe Mounts, Cold Shoe Mounts, Adapters, Tripod Mounts, Ball Socket Swivel Mounts, Stills Cameras, Video Cameras, HD Video Cameras, and DSLR Cameras, and Combo Stills-Video Cameras serving the new paradigm of the Renaissance Man Photographer.

A History of the Invention: Once upon a time people argued that sailing and surfing were very different activities, requiring very different gear and movement. Then, one day, someone put a sail on a surfboard, and a brand new sport was born—windsurfing. Then people argued that flying kites and surfing very different activities, requiring very different gear and movement. Then, one day, someone flew a kite while standing on a surfboard, and a brand new sport was born kite-surfing. So 9shooting is a brand new sport combining the best of photography and stills shooting! Yes, it takes a bit of learning but rising generations will embrace it. The greater point is the same as windsurfing & kite-sailing—have fun catching *both* the wind and waves!! The present invention allows the artist—the photographer, and videographer, and audio engineer—to maximize their productivity and creativity, enhance their art, and augment their commercial endeavors. The present invention will lead to increased revenue streams and new opportunities for art. As many current photographers are losing their identity and business as DSLRs become more powerful and cheaper, they would be well off surfing these trends and learning video.

However, many photographers do not want to learn new skills, nor embrace change. Instead of surfing the towering waves of innovation, many professional photographers would prefer to be drowned by them, and thus this invention, which surfs the waves of innovation, has oft countered expert opinion over the past year.

The present invention—the 9shooter and totem pole mount—goes out to all those embarking on epic heroes journeys. Hero's Journey Entrepreneurship™ Principle #14: Innovate & create. Today's crazy=tomorrow's common sense. Walt Disney: I believe in being an innovator. Abraham Lincoln: The best way to predict your future is to create it. Arthur Schopenhauer: All truth passes through three stages. First, it is ridiculed. Second, it is violently opposed. Third, it is accepted as being self-evident. Steve Jobs: The ones who are crazy enough to think that they can change the world, are the ones who do. Albert Einstein: For an idea that does not at first seem insane, there is no hope. Victor Hugo: Greater than the tread of mighty armies is an idea whose time has come. (Surf that idea whose time has come! Like Dr. E's 9shooter™ surfs the simultaneous shooting of stills and video!) Steve Wozniak (the cofounder of Apple®): The only way to come up with something new—something world-changing—is to think outside the constraints everyone else has. You have to think outside the limits everyone else has set. Sir Richard Branson: The best, most solid way out of a crisis in a changing market is through experiment and adaptation. Businesses surf the waves of changing circumstances, and I can't offhand think of any industries whose best players are not constantly engaged in reinvention of one sort or another. Business Stripped Bare, p. 215 Mark Twain: The innovator is a crank, until his ideas succeed. Steve Jobs: Innovation distinguishes between a leader and a follower. George Bernard Shaw: The reasonable man adapts himself to the world; the unreasonable one persists in trying to adapt the world to himself. Therefore all progress depends on the unreasonable man. Thomas Jefferson: I like dreams of the future better than the history of the past. Peter F. Drucker: Innovation is the specific instrument of entrepreneurship. The act that endows resources with a new capacity to create wealth. Thomas Alva Edison: Keep on the lookout for novel ideas that others have used successfully. Your idea has to be original only in its adaptation to the problem you're working on. Fyodor Dostoyevsky: Innovators and men of genius have almost always been regarded as fools at the beginning (and very often at the end) of their careers. Einstein: Anyone who has never made a mistake has never tried anything new. Steve Jobs: Pretty much, Apple and Dell are the only ones in this industry making money. They make it by being Wal-Mart. We make it by innovation. Ludwig von Mises: What counts alone is the innovator, the dissenter, the harbinger of things unheard of, the man who rejects the traditional standards and aims at substituting new values and ideas for old ones. Joseph Campbell: A hero ventures forth from the world of common day into a region of supernatural wonder: fabulous forces are there encountered and a decisive victory is won: the hero comes back from this mysterious adventure with the power to bestow boons on his fellow man. Albert Einstein: Imagination is more important than knowledge. For knowledge is limited to all we now know and understand, while imagination embraces the entire world, and all there ever will be to know and understand. Jack Bogle: The innovation in the productive part of our economy adds value to our society. The financial sector, by definition, subtracts value. Steven Jobs: The system is that there is no system. That doesn't mean we don't have process. Apple is a very disciplined company, and we have great processes. But that's not what it's about. Process makes you more efficient. But innovation comes from people meeting up in the hallways or calling each other at 10:30 at night with a new idea, or because they realized something that shoots holes in how we've been thinking about a problem. It's ad hoc meetings of six people called by someone who thinks he has figured out the coolest new thing ever and who wants to know what other people think of his idea. And it comes from saying no to 1,000 things to make sure we don't get on the wrong track or try to do too much. We're always thinking about new markets we could enter, but it's only by saying no that you can concentrate on the things that are really important. —The Seed of Apple's Innovation in Business Week (12 Oct. 2004) Steve Wozniak: I hope you'll be as lucky as I am. The world needs inventors—great ones. You can be one. If you love what you do and are willing to do what it takes, it's within your reach. And it'll be worth every minute you spend alone at night, thinking about what it is you want to design or build. I promise.

THE NEW PARADIGM OF A RENAISSANCE MAN PHOTOGRAPHER: Today's photographer must know something of sound, audio, video, and of course stills; and they must be prepared to capture all of these as the need arises. So it is that photographers are becoming “Renaissance Men,” 9shooting stills and video simultaneously.

A NEW ERA OF MICRO-MOUNTS AND PORTABLE MINI-BRACKETS FOR THE NEW ERA OF DSLR/VIDEO CAMERAS AND CAMERAMAN. Cameras are getting smaller and more powerful while packing more and more features. Components such as microphones, lights, flashes, audio decks, and transceivers are also getting smaller and smaller, so should not the mounting brackets become smaller? More and more is being expected from photographers and videographers, so should not brackets and mounting systems allow for more and more components, as well as flexibility, portability, and customizability?

A mounting apparatus for supporting a plurality devices including cameras, microphones, audio recorders, and monitors which all can be rotated relative to one-another is presented herein. This mounting apparatus comprises: an L-shaped bracket arm; a second L-shaped bracket arm connected to the first such that said first bracket is manually adjustable to any of a range of different angular positions relative to said second bracket arm to provide flexibility in relatively positioning the cameras and devices which may be attached to either of the two brackets, where both said first bracket and said second bracket have a plurality of holes for attaching and mounting mounts and devices. A camera bracket mounting device offering superior simplicity, versatility, and flexibility is disclosed, allowing one to more easily combine a multitude of components serving and enhancing the simultaneous capture of video, stills, and/or audio, fostering improved art, capturing capabilities, and commerce. Camera-related devices are becoming smaller while possessing more functionality, calling for the mounts and bracket systems disclosed in this invention allowing novel, simple, and flexible combinations of cameras, mics, lights, radio receivers, flashes, monitors, flash-shoe adapters, flash-shoe mounts, ball-head flash-shoe adapters, threaded screw mounts, and more. Components are becoming smaller, naturally suggesting this invention's smaller and more versatile brackets and mounts. This invention surfs the trends of increased functionality and miniaturization, allowing novel and flexible manners for mounting and combining cameras and devices, and it can be used with monopods, tripods, and DSLR rigs, and it can be mounted above and below cameras, rotated at custom angles, and easily modified and expanded.

The present invention, also known as the Nine Shooter™ bracket and Totem Pole™ mount serves the new paradigm of the renaissance-man photographer. The paradigm shift occurred with the miniaturization of mics and lights as well as the releases of video-capable cameras such as the Canon 5d Mark ii, which was recently used to film a House episode, and the Canon EOS 7d which was used by director Robert Rodriguez for music videos. And now with the smaller EVIL cameras which also have HD video capabilities, never has the need for small, light, portable brackets and mounting systems been greater. NE And EVIL cameras may benefit from the miniaturization of all these components. The 45surf® Dual 45 Dueler™. Never go into a shoot without it.™ The 45SURFER: It's cool to surf stills, but sometimes you've cowboy and shoot some stills. The 9SHOOTER: When one shot just isn't enough.

The advantage of the Nine Shooter is its simple usefulness. Invented by Dr. Elliot McGucken Nov. 25, 2009 HJE Principle #7: Simplify (dx4/dt=ic) Warren Buffett: The business schools reward difficult complex behavior more than simple behavior, but simple behavior is more effective. Leonardo da Vinci: Simplicity is the ultimate sophistication. Newton: Nature is pleased with simplicity, and affects not the pomp of superfluous causes. Kant: rudiments or principles must not be unnecessarily multiplied (entia praeter necessitatem non esse multiplicanda). Einstein: The grand aim of all science . . . is to cover the greatest possible number of empirical facts by logical deductions from the smallest possible number of hypotheses or axioms. Richard Feynman: You can always recognize truth by its beauty and simplicity. Vincent Van Gogh: How difficult it is to be simple. Galileo: Nature does not multiply things unnecessarily; that she makes use of the easiest and simplest means for producing her effects; that she does nothing in vain, and the like. Sir Isaac Newton: Truth is ever to be found in simplicity, and not in the multiplicity and confusion of things. Albert Einstein: Most of the fundamental ideas of science are essentially simple, and may, as a rule, be expressed in a language comprehensible to everyone. John C. Bogle: The power of simplicity . . . our central business philosophy is the essence of simplicity: Owning a share in the entire stock market, or the entire bond market—and then holding it forever—happens to be the surest route to long-term investment success. Albert Einstein: Any intelligent fool can make things bigger, more complex, and more violent. It takes a touch of genius—and a lot of courage—to move in the opposite direction. Dr. E: The Pareto Principle (the 80/20 rule) states that in many arenas and activities, roughly 80% of the results come from 20% of the effort. Thus one ought focus on the 20% of one's most profitable customers and eliminate 80% of one's greatest wasters of time and resources. But too, one must always, always, back everything with 100% honor, character, and integrity; and always, always treat others 100% as one would want to be treated. Voltaire stated that “the perfect is the enemy of the good,” but nobody wants to fly on a “good” airline which crashes “only” 20% of the time, and a Beethoven Symphony with 20% of the notes out of place would be useless. In art, business, and life, err on the side of perfection. Steven Jobs: If you read the Apple's first brochure, the headline was “Simplicity is the Ultimate Sophistication (from Leonardo da Vinci!)” What we meant by that was that when you first attack a problem it seems really simple because you don't understand it. Then when you start to really understand it, you come up with these very complicated solutions because it's really hairy. Most people stop there. But a few people keep burning the midnight oil and finally understand the underlying principles of the problem and come up with an elegantly simple solution for it. But very few people go the distance to get there.” The Gold 45 Revolver

Some descriptive titles for the present invention have included: System and Method for attaching film and photography equipment including digital video and dslr cameras. System and Method for Attaching or Combining a Plurality of Recording Devices Including Digital Cameras, Stills Cameras, Video Cameras, HD Video Cameras, and DSLR Cameras, and Combo Stills-Video Cameras with Adjustable Angle Mount System and Method for attaching film and photography equipment including digital video and dslr cameras. System and Method for Attaching or Combining a Plurality of Recording Devices Including Digital Cameras, Stills Cameras, Video Cameras, HD Video Cameras, and DSLR Cameras, and Combo Stills-Video Cameras with Adjustable Angle Mount The Nine Shooter: Versatile System and Method for attaching a plurality of camera and recording devices, microphones, lights, flashes, transceivers, receivers, hard drives, external storage, meters, monitors, and more.

Since the original provisional patent was filed in December, 2009 for The 45surf® Dual 45 Dueler™, numerous other developments have spurred its continuous development. Around April, 2010, Canon released the HFS 200 and other cameras with Dynamic Image Stabilization: “Dynamic SuperRange Optical Image Stabilization with Powered IS.” Canon Exclusive: Dynamic SuperRange Optical Image Stabilization (HFS11) For smooth movie capture, the PowerShot SX210 IS also features a new Dynamic Image Stabilizer. A technology inherited from Canon video cameras, Dynamic IS further reduces the shake caused by a user's movement, such as walking. When movies have been captured, the integrated HDMI mini connection offers a lossless way to share video —and images —on HDMI-compatible devices including HDTV screens.—http://www.dpreview.com/news/1002/10020804canonpowershotsx210.asp

1) All of a sudden, the dynamic optical stabilization makes the dual 45dueler and the mounting of a video camera (or dslr video camera or point and shoot stills/video camera) alongside a dslr make even more sense. (Since dslrs have video and video cameras have still capabilities, the terms “dslrs” and “stills camera” and “video cameras” can be exchanged throughout this document and its figures.)

2) The simple two-L brackets of the Nine Shooter lend themselves to many variations in mounting, orientation, and component hosting/carrying. Also, by using Dual 45 Dueler/ Nine Shooter Bracket as an S-shaped bracket, one can easily mount a video camera below the camera with a tripod, as shown in the figures below. This provides greater stabilization for both the camera and video camera and may be used to shoot distant moving objects such as surfers or athletes, or fashion shows. One could also mount a single I bracket above the camera or below the camera.

3) Furthermore, with the continuing miniaturization of high-quality components, more and more photographers, photojournalists, videographers, documentarians, and event/wedding photographers will be capturing stills, audio, and video simultaneously, and if not always simultaneously, then they will be prepared to catch them easily and efficiently, without taking too much time to grab different devices out of their bags and set them up. There is far greater upside to mounting an H video camera below a dslr and letting it run continuously, recording to an SD or other card, than there is downside. Perhaps one will only find a few useful minutes in a ninety minute recording—perhaps one will find ninety minutes of useful footage. Perhaps one will now and then put their dslr camera into video mode, as the second dedicated video camera gives a different perspective/shot, as well as better audio. When one sees something that ought be videoed, one can concentrate on shooting video from both attached cameras, and then go back to shooting stills with the DSLR and video with the HD Camera.

4) As devices improve in quality and get less expensive, another paradigm shift is powered by the fact that once the devices are bought—once a camera and SD card and audio recorder are bought—it costs nothing extra to record video and audio, thusly meaning that the largest cost is the photographer's time. If one is going to be out on the beach shooting stills anyway, why not add continuous video and audio from multiple devices, on every shoot, for a one-time cost of a couple thousand bucks? The same philosophy applies to all weddings and events such as fashion shows.

THE NINE SHOOTER™ BRACKET AKA THE HERO'S JOURNEY Nine SHOOTER™: The present invention, aka the Hero's Journey Nine Shooter, can be used to combine the following devices: 1) video monitor 2) wireless receiver 3) wireless transmitter 4) video camera 5) hd video camera 6) dlsr 7) evil camera 8) external mics 9) lights 10) panel lights 11) extra mics 12) other devices The 45surf® Dual 45 Dueler™. Never go into a shoot without it.™ Invented by Dr. Elliot McGucken Dec. 25, 2009 Descriptive titles for the present invention include: System and Method for attaching film and photography equipment including digital video and dslr cameras. System and Method for Attaching or Combining a Plurality of Recording Devices Including Digital Cameras, Stills Cameras, Video Cameras, HD Video Cameras, and DSLR Cameras, and Combo Stills-Video Cameras with Adjustable Angle Mount: System and Method for attaching a plurality of cameras or digital imaging devices. System and Method for attaching a plurality of digital imaging devices. System and Method for attaching a plurality of digital recording devices. System and Method for attaching a plurality of camera and recording devices. The Double Dueler™ or Dual Dueler™ or Dual 45 Dueler™ or 45surf Dueler™ is a maverick device that allows one to attach two cameras together so as to maximize one's productivity, while also gaining the full benefits of devices dedicated to both video and digital stills. The 45surf Dual Dueler™ is a maverick device that allows one to attach two cameras together so as to harness the optimum power of hd video and stills cameras during a single shoot.

As digital imaging instruments become smaller and smaller, the potential to use two or more in tandem beckons. Digital video cameras such as the Nikon D90 and Canon 5d Mark II now both incorporate video, though there are many complaints about the inferiority of the video as well as the sound as to that found on miniature, lightweight dedicated high-def video cameras such as the canon hv30/hv40 and Canon Vixia HF100, and Canon HF10 SD, and Canon VIXIA HF S100 HD Flash Memory Camcorder with 10× Optical Zoom, and other similar cameras that record to both minidv tapes and SD memory chips and compact flash memory chips.

A few years ago it would have been daunting or inconceivable even to mount bulky, high-quality cameras such as the Canon GL2 underneath or above a digital SLR, but with the miniaturization of components, it is becoming easier and easier to couple two or more devices, dedicated to different tasks, together. Combining two such devices would have resulted in a bulky, unwieldy combination. Multiple factors lead to the development of the 45 Dueler™: 1) High-quality digital imaging equipment is getting smaller and lighter (a top-notch dslr and hd video camera today, when combined, may weigh less than a single hd video camera or dslr from just a few years ago!) 2) Digital storage is becoming cheaper and cheaper, both in the forms of hard drives and flash memory. With 16 gig sd memory cards going for thirty bucks and terabyte hard drives costing less than $1,000, there is plenty of storage room both stills and hd video from all your shoots! 3) Both online video and high-quality stills are becoming more and more important to businesses. 4) Digital SLRs which shoot video are not as good at video as dedicated hd video cameras, and hd video cameras which shoot stills are not as good as digital sirs. 5) DSLRs are coming with audio recording capabilities, necessitating better shotgun and external mics, audio mixers, and/or receivers. “Since the 5D Mark II records Full HD video (1920×1080) its picture was quite sharp. It couldn't quite match what the Canon HF S100 and some of the other high-end HD camcorders were capable of but it was on par with the results we got from the rest of the video-capable DSLR class. Click here to read our full sharpness performance review.”—http://www.camcorderinfo.com/content/Canon-EOS-5D-Mark-11-DSLR-Camera-Review-36784.htm# 6) High-quality digital imaging equipment is costing less and less (a top-notch dslr and hd video camera today, when combined, may cost less than a single hd video camera or dslr from just a few years ago!) 7) Digital SLRs which shoot video are not as good at sound as dedicated hd video cameras. 8) Shooting video with a DSLR interrupts the shooting of stills while eating away at the camera's memory; and one cannot shoot both continuous video and stills with a DSLR, even if it is capable of hd video.

Advantages Over Prior Art:

Advantages of the Present Invention Over the Prior Art Include the Following: This Invention:

1) Allows photographer/videographer to harness full power of both cutting-edge video and photographic equipment. 2) Allows photographer/videographer to shoot continuous stills and continuous videos simultaneously. 3) Provides steadying balance for dslr camera. 4) Provides steadier shooting for hd video cameras. 5) Allows photographer/videographer to capture two forms of video simultaneously, taking advantage of the DSLR's strengths including larger/full frame sensors, variable lens systems, depth of field, as well as strengths of the hd video camera such as its quicker auto-focus for video, zoom, stabilization abilities, face recognition, and other advantages. 6) Provides backup system(s) to capture event if one or the other camera or memory system dies/does not function. 7) Allows the superior sound-recording and stereo-sound systems of the HD video cameras to be utilized. 8) Allows the parent to capture stills/video their kid scoring the goal; of their daughter getting married. 9) Places a large plurality of devices in close proximity so that they may all be monitored and adjusted simultaneously. 10) Allows video journalists to catch the reaction and stills of their subject. 11) Allows for less swapping out of cards in both cameras. 10) The double/dedicate batteries in the overall system allow for more continuous shooting/recording of audio, video, flash, and stills.

Further manifestations of the invention could include additional mounts for flashes, lights, audio equipment, microphones, and other peripherals commonly associated with both photographic cameras and video recording devices. Any device which attaches two or more cameras or digital imaging devices together must both a) provide for the flexibility of moving the devices relative to one another, and b) the strength to hold the relative positioning during movement and vibrations of the cameras/camera-45surf dueler™-system. Any device which attaches two or more cameras or digital imaging devices together must provide for the flexibility of moving the devices relative to one another, as for instance, in the case of a digital video camera and digital slr, the devices might be angled slightly differently so as to better catch the subject in the different formats, as for instance, the dslr shoots form the neck up and the video device shoots full-body, or vice versa. Any device which attaches two or more cameras or digital imaging devices together must provide for the strength to hold the relative positioning during movement and vibrations of the cameras, so that one can shoot with confidence and maintain the desired orientations of the said cameras. In order to illustrate the shortcomings of the dslrs which also shoot video, I posted the following question in the flickr.com user group. Can any of the canon (or Nikon) cameras shoot video and stills simultaneously? 45surf.com™ 45SURF PHOTOGRAPHY™ says: can any of the canon (or Nikon) cameras shoot video and stills simultaneously? for instance, if I am shooting video, can I also be shooting stills? if so, will the rate for stills be slower while it is also shooting video? thanks! Posted at 9:12 PM, 25 Nov. 2009 PST (permalink|edit) J-Fish says: Well you could take screenshots from the videos you make . . . but that's about all. Unless one of the companies magically installs a second sensor in the camera I don't see this happening any time soon. Posted 11 hours ago. ( permalink) the scattered image says: Yes. Posted 11 hours ago. (permalink) [H J. Nee]™ says: that will not happen at the same time b/c the sensor has to refresh its load of electrons COMPLETELY before taking the shot BUT you're taking a video already which continuously feeds it. Posted 9 hours ago. (permalink) jeffery_dan says: If you are videoing with the 7D and press the shutter button it will take a photograph and pause the video for about a second. Posted 9 hours ago. (permalink) PSJ Picdump says: Yes you can with the 5D MkII, but as Jeff says, there is a pause in the video when it happens. Posted 8 hours ago. (permalink) nb|photo (nicbet) says: Some people are grabbing still images off the HD video, in okay quality. Canon themselves even claim it's a technique commonly used by photojournalists . . . www.usa.canon.com/dlc/controller?act=GetArticleAct&ar . . . Posted 7 hours ago. (permalink) Alan Whyte says: or you could always go down the buying a video camera that allows you to take photos at the same time route. Posted 4 hours ago. (permalink)

Harry Pulley says: Simultaneously? Define simultaneous. You can take stills while video is being taken but it will freeze the video for the time it takes to record the still. Or as mentioned above, you get 2MP stills by extracting them from full HD video (1080P is 2MP, 720P is about IMP). Posted 4 hours ago. (permalink) A bunch of beans says: Alan, it's been my experience that the video cameras that can also shoot stills don't take very good photographs. They're ok for family snapshots, but if you're looking for a good-quality shot, they're just not up to par. Posted 3 hours ago. (permalink)

Thanks everyone! I went from a Nikon d300 (which reached its shutter cycle) to a Nikon d90 and Canon 5D mark ii just a couple weeks ago. Love them all! I often take a mini hd camera with me to shoots, such as the canon hv40 or hv30, so I have never tried the video capabilities of the d90 and Canon 5D. When I'm out there shooting stills, I am shooting stills/thinking stills, so to use the Canon 5D all of a sudden to shoot video, or start shooting stills during the video, would result in choppy/ill-conceived video. Models have limited time, so when I'm shooting stills, I need to shoot stills the entire hour or so. :) I'm not sure I'll ever use the video on the cameras. As one can see from the above conversations, as well as others throughout the internet, the dslr doesn't take very good video when compared to the canon hv30/hv40 hf s100 and other cameras devoted purely to hd video capture. And the hd cameras which take stills do not take good stills when compared to the dslrs. When one considers the value of one's time, why not shoot both stills and video at every shoot? When one considers the value of one's time, and just how inexpensive dedicated hd cameras are becoming, why not shoot both stills and video at every shoot? For instance, a Nikon d90, with the same sensor as the Nikom d300, and a dedicated hd camera, can both be bought for less than the price of a Nikon d300. Suppose a celebrity is coming down the red carpet—why not turn the video camera on and shoot, while you're firing stills? You can quickly glance at both the dslr and video monitors to make sure both are operating properly, and that the field of view is accurate. All of this can be pre-adjusted with the approximate distance from which you'll be shooting. Imagine setting up a model to model clothing for a fashion line. As you will be standing in one place, it will be fairly simpler to adjust both cameras for the proper field of view; and once done, you can shoot away! In wedding situations, it is well known exactly where the bride will be walking and where the bride and groom will be standing; all of this can be adjusted for ahead of time, and too, it can be quickly adjusted on the fly! If it turns out you got no good video, dump the files and free up the card When one considers the fleeting character of live events such as weddings, parties, red-carpet-events, and athletic events, the ability to shoot in high-quality video and stills simultaneously becomes paramount. For instance, one cannot make the bride walk down the aisle twice just to capture it both in video and stills. One cannot make the high-school quarterback re-throw the touchdown pass. And as swimsuit models have things to do and places to be, one cannot make them stand forever on the beach, just so one can shoot both video and stills. One cannot make celebrities walk down the red-carpet twice, for both video and stills. Even if the photographer hires an assistant to shoot video, why not also arm them with the Dual 45 Dueler™, and have them shoot both video and stills? As digital capture and storage grow cheaper by the moment, why not have a mounted hd video camera recording the shoot continuously? Surely there is a lot of upside potential for newfound revenue, with a relatively small investment. The Dual 45 Dueler could also be used to connect two hd cameras in tandem, so as to capture the video and the sound in two different manners; for instance, if one wishes to use a mounted or on-board mic on one, and a remote mic (sensenheiser or other) on the other video camera. A 45surf Dual Dueler™ or the 45surf Dueler™ can be easily constructed by one knowledgeable in the art of ball-and-socket mounts and camera mounts. While prior art sells ball and socket swivel mounts independently, for mounting cameras on fixed surfaces, there is no device on the market which attaches one camera's ¼″ mount to another camera's ¼″ mount via a ball-and-socket array allowing for both relative positioning of said two cameras, be they a video and sir camera, or any other form of two cameras. The 45surf Dueler™ combines a plurality of ball-and-socket, arm, and camera-mount apparati together for new and hitherto unseen results, leading to a novel, useful tool for photographers and videographers. The 45surf Dueler™ combines a plurality of ball-and-socket, arm, and camera-mount apparati together for new and hitherto unseen results, leading to a novel, useful tool for photographers and videographers, allowing them to capitalize on the following trends in a novel, hitherto unseen manner: High-quality digital imaging equipment is getting smaller and lighter (a top-notch dslr and hd video camera today, when combined, may weigh less than a single hd video camera or dslr from just a few years ago!) Digital storage is becoming cheaper and cheaper, both in the forms of hard drives and flash memory. With 16gig sd memory cards going for thirty bucks and terabyte hard drives costing less than $1,000, there is plenty of storage room both stills and hd video from all your shoots! Both online video and high-quality stills are becoming more and more important to businesses. Digital SLRs which shoot video are not as good at video as dedicated hd video cameras, and hd video cameras which shoot stills are not as good as digital sirs. High-quality digital imaging equipment is costing less and less (a top-notch dslr and hd video camera today, when combined, may cost less than a single hd video camera or dslr from just a few years ago!) Digital SLRs which shoot video are not as good at sound as dedicated hd video cameras. Shooting video with a DSLR interrupts the shooting of stills while eating away at the camera's memory; and one cannot shoot both continuous video and stills with a DSLR, even if it is capable of hd video. A NEW ERA OF MICRO-MOUNTS AND PORTABLE MINI-BRACKETS FOR THE NEW ERA OF DSLR/VIDEO CAMERAS AND CAMERAMAN. Cameras are getting smaller and more powerful while packing more and more features. Components such as microphones, lights, flashes, audio decks, and transceivers are also getting smaller and smaller, so should not the mounting brackets become smaller? More and more is being expected from photographers and videographers, so should not brackets and mounting systems allow for more and more components, as well as flexibility, portability, and customizability? The Nine Shooter™ bracket and Totem Pole™mount serve the new paradigm of the renaissance-man photographer. The paradigm shift occurred with the miniaturization of mics and lights as well as the releases of video-capable cameras such as the Canon 5d Mark ii, which was recently used to film a House episode, and the Canon EOS 7d which was used by director Robert Rodriguez for music videos. And now with the smaller EVIL cameras which also have HD video capabilities, never has the need for small, light, portable brackets and mounting systems been greater. NEX and EVIL CAMERAS MAY BE USED WITH ALL THIS The 45surf® Dual 45 Dueler™. Never go into a shoot without it.™ The advantage of the Nine Shooter is its simple usefulness. Invented by Dr. Elliot McGucken Dec. 25, 2009. Descriptive titles for the present invention have included: System and Method for attaching film and photography equipment including digital video and dslr cameras. System and Method for Attaching or Combining a Plurality of Recording Devices Including Digital Cameras, Stills Cameras, Video Cameras, HD Video Cameras, and DSLR Cameras, and Combo Stills-Video Cameras with Adjustable Angle Mount. The Nine Shooter: Versatile System and Method for attaching a plurality of camera and recording devices, microphones, lights, flashes, transceivers, receivers, hard drives, external storage, meters, monitors, and more. Since the original provisional patent was filed in 2009 for the The 45surf® Dual 45 Dueler™, numerous other developments have spurred its continuous development. Around April, 2010, Canon released the HFS 200 and other cameras with Dynamic Image Stabilization: “Dynamic SuperRange Optical Image Stabilization with Powered IS.”

Canon Exclusive: Dynamic SuperRange Optical Image Stabilization (HFS11) For smooth movie capture, the PowerShot SX210 IS also features a new Dynamic Image Stabilizer. A technology inherited from Canon video cameras, Dynamic IS further reduces the shake caused by a user's movement, such as walking. When movies have been captured, the integrated HDMI mini connection offers a lossless way to share video—and images—on HDMI-compatible devices including HDTV screens.—http://www.dpreview.com/news/1002/10020804canonpowershotsx210.asp

1) All of a sudden, the dynamic optical stabilization makes the dual 45dueler and the mounting of a video camera (or dslr video camera or point and shoot stills/video camera) alongside a dslr make even more sense. (Since dslrs have video and video cameras have still capabilities, the terms “dslrs” and “stills camera” and “video cameras” can be exchanged throughout this document and its figures.)

2) The simple two-1 brackets of the Nine Shooter lend themselves to many variations in mounting, orientation, and component hosting/carrying. Also, by using Dual 45 Dueler/Nine Shooter Bracket as an S-shaped bracket, one can easily mount it below the camera with a tripod, as shown in pictures below. This provides greater stabilization for bother the camera and video camera and may be used to shoot distant moving objects such as surfers or athletes, or fashion shows. One could also mount a single 1 bracket above the camera or below the camera.

3) Furthermore, with the continuing miniaturization of high-quality components, more and more photographers, photojournalists, videographers, documentarians, and event/wedding photographers will be capturing stills, audio, and video simultaneously, and if not always simultaneously, then they will be prepared to catch them easily and efficiently, without taking too much time to grab different devices out of their bags and set them up. There is far greater upside to mounting an hd video camera below a dslr and letting it run continuously, recording to an SD or other card, than there is downside. Perhaps one will only find a few useful minutes in a ninety minute recording—perhaps one will find ninety minutes of useful footage. Perhaps one will now and then put their dslr camera into video mode, as the second dedicated video camera gives a different perspective/shot, as well as better audio. When one sees something that ought be videoed, one can concentrate on shooting video from both attached cameras, and then go back to shooting stills with the DSLR and video with the HD Camera.

4) As devices improve in quality and get less expensive, another paradigm shift is powered by the fact that once the devices are bought—once a camera and sd card and audio recorder are bought—it costs nothing extra to record video and audio, thusly meaning that the largest cost is the photographer's time. If one is going to be out on the beach shooting stills anyway, why not add continuous video and audio from multiple devices, on every shoot, for a onetime cost of a couple thousand bucks? The same philosophy applies to all weddings and events such as fashion shows. THE NINE SHOOTER™ BRACKET: AKA THE HERO'S JOURNEY Nine SHOOTER™ The Hero's Journey Nine Shooter can be used to combine the following devices: 1) video monitor 2) wireless receiver 3) wireless transmitter 4) video camera 5) hd video camera 6) dlsr 7) evil camera 8) external mics 9) lights 10) panel lights 11) extra mics 12) other devices The 45surf® Dual 45 Dueler™. Never go into a shoot without it.™ Invented by Dr. Elliot McGucken Dec. 25, 2009 System and Method for attaching film and photography equipment including digital video and dslr cameras. System and Method for Attaching or Combining a Plurality of Recording Devices Including Digital Cameras, Stills Cameras, Video Cameras, HD Video Cameras, and DSLR Cameras, and Combo Stills-Video Cameras with Adjustable Angle Mount System and Method for attaching a plurality of cameras or digital imaging devices. System and Method for attaching a plurality of digital imaging devices. System and Method for attaching a plurality of digital recording devices. System and Method for attaching a plurality of camera and recording devices. The Double Dueler™ or Dual Dueler™ or Dual 45 Dueler™ or 45surf Dueler™ is a maverick device that allows one to attach two cameras together so as to maximize one's productivity, while also gaining the full benefits of devices dedicated to both video and digital stills. The 45surf Dual Dueler™ is a maverick device that allows one to attach two cameras together so as to harness the optimum power of hd video and stills cameras during a single shoot. As digital imaging instruments become smaller and smaller, the potential to use two or more in tandem beckons. Digital video cameras such as the Nikon D90 and Canon 5d Mark II now both incorporate video, though there are many complaints about the inferiority of the video as well as the sound as to that found on miniature, lightweight dedicated high-def video cameras such as the canon hv30/hv40 and Canon Vixia HF100, and Canon HF10 SD, and Canon VIXIA HF S100 HD Flash Memory Camcorder with 10× Optical Zoom, and other similar cameras that record to both minidv tapes and sd memory chips and compact flash memory chips. A few years ago it would have been daunting or inconceivable even to mount bulky, high-quality cameras such as the Canon GL2 underneath or above a digital sir, but with the miniaturization of components, it is becoming easier and easier to couple two or more devices, dedicated to different tasks, together. Combining two such devices would have resulted in a bulky, unwieldy combination.

Multiple Factors Lead to the Development of the 45 Dueler™:

1) High-quality digital imaging equipment is getting smaller and lighter (a top-notch dslr and hd video camera today, when combined, may weigh less than a single hd video camera or dslr from just a few years ago!) 2) Digital storage is becoming cheaper and cheaper, both in the forms of hard drives and flash memory. With 16gig sd memory cards going for thirty bucks and terabyte hard drives costing less than $1,000, there is plenty of storage room both stills and hd video from all your shoots! 3) Both online video and high-quality stills are becoming more and more important to businesses. 4) Digital SLRs which shoot video are not as good at video as dedicated hd video cameras, and hd video cameras which shoot stills are not as good as digital sirs. “Since the 5D Mark II records Full HD video (1920×1080) its picture was quite sharp. It couldn't quite match what the Canon HF S100 and some of the other high-end HD camcorders were capable of, but it was on par with the results we got from the rest of the video-capable DSLR class. Click here to read our full sharpness performance review.”—http://www.camcorderinfo.com/content/Canon-EOS-5D-Mark-II-DSLR-Camera-Review-36784.htm# 5) High-quality digital imaging equipment is costing less and less (a top-notch dslr and hd video camera today, when combined, may cost less than a single hd video camera or dslr from just a few years ago!) 6) Digital SLRs which shoot video are not as good at sound as dedicated hd video cameras. 7) Shooting video with a DSLR interrupts the shooting of stills while eating away at the camera's memory; and one cannot shoot both continuous video and stills with a DSLR, even if it is capable of hd video.

Advantages of the Present Invention Over the Prior Art Include:

1) Allows photographer/videographer to harness full power of both cutting-edge video and photographic equipment. 2) Allows photographer/videographer to shoot continuous stills and continuous videos simultaneously. 3) Provides steadying balance for dslr camera. 4) Provides steadier shooting for hd video cameras. 5) Allows photographer/videographer to capture two forms of video simultaneously, taking advantage of the DSLR's strengths including larger/full frame sensors, variable lens systems, depth of field, as well as strengths of the hd video camera such as its quicker auto-focus for video, zoom, stabilization abilities, face recognition, and other advantages. 6) Provides backup system(s) to capture event if one or the other camera or memory system dies/does not function. 7) Allows the superior sound-recording and stereo-sound systems of the hd video cameras to be utilized. 8) Allows the parent to capture stills/video their kid scoring the goal; of their daughter getting married. Allows video journalists to catch the reaction and stills of their subject. 9) Allows for less swapping out of cards in both cameras. 10) The double/dedicate batteries in the overall system allow for more continuous shooting. Further manifestations of the invention could include additional mounts for flashes, lights, audio equipment, microphones, and other peripherals commonly associated with both photographic cameras and video recording devices. Any device which attaches two or more cameras or digital imaging devices together must both a) provide for the flexibility of moving the devices relative to one another, and b) the strength to hold the relative positioning during movement and vibrations of the cameras/camera-45surf dueler™-system. Any device which attaches two or more cameras or digital imaging devices together must provide for the flexibility of moving the devices relative to one another, as for instance, in the case of a digital video camera and digital sir, the devices might be angled slightly differently so as to better catch the subject in the different formats, as for instance, the dslr shoots form the neck up and the video device shoots full-body, or vice versa. Any device which attaches two or more cameras or digital imaging devices together must provide for the strength to hold the relative positioning during movement and vibrations of the cameras, so that one can shoot with confidence and maintain the desired orientations of the said cameras.

MORE Prior Art & the Novelty of the Current Invention:

The following article was published in August, 2010: A DIY 9Shooter: Shooting Stills & Video Simultaneously & Audio Too! *Aug. 31, 2010 *5 comments http://www.diyphotography.net/a-diy-9shooter-shooting-stills-video-simultaneously-audio-too The post below shows a simple way to capture video while taking still pictures. Sure, there is some added weight and yea, video will not get a dedicated person and will just “follow along”, yet, this is a neat way to achieve video with just one person shooting, This is also a great instructional tool for yourself to see how you interact with your model, what things work and what makes them shrink. There are two versions for this mod—a dueler which mounts a DSLR with a video camera and a 9Shooter that also has sound attached. From now on it is all Elliot McGucken. So you want to shoot stills and video simultaneously? Go for it! Rig yourself up a 45surf® 9shooter™ bracket system! How do you build a 45surf 9shooter bracket system? It's kinda simple, and the images are self explanatory, but that's what makes it cool, elegant, and fun, as Leonardo da Vinci once said: Simplicity is the ultimate sophistication. Print this list out along with a picture of the 9shooter so the Home Depot peeps know what you're talking about, hop in your car, and head on over to Home Depot and buy: 45surf model beautiful women hot pretty hot girl 45surf tank top 819, . . . photo video journalism dual 45 dueler 9 shooter totem pole mount hero's journey mount photo video journalism photo journalist patent pending dual 45 dueler™ patent pending nine shooter. 1) Two 3 inch L brackets. (heck buy 4 or more—they cost a couple bucks and can be used in various configurations as seen in the photos) 2) Spray paint and primer of your preferred colors. 3) ¼″-20 thread screws and thumb nuts—get nine of each as these always get lost and are cheap! The thumb screws should be ⅜″ long to mount the cameras and ⅜″ or ½″ long for the bracket hinge, depending on how many washers you use. Remember, you will need to rotate the lower camera relative to the upper one now and then, but the middle hinge—(thumb-screw/washers/bracket/thumb-nut)—should still be tight enough to hold the relative position of the brackets you choose. experiment with different washer placements/nuts/screw lengths to see what works for you! 4) A few metal washers of various sizes to experiment with on the hinge mechanism which connects the two brackets. 5) A few 1″ to 1.5″ neoprene rubber washers to put between the metal bracket and your camera. these are somewhat optional, but they prevent your camera from getting scuffed up. swimsuit bikini.DSC_{—}0090 . . . 1.beautiful 45surf swimsuit model surf cowboy model swimsuit bikini model 067 Well, you're now out about twenty bucks and a few hours waiting for paint to dry, but how much will your productivity increase—especially for the jobs which could benefit from shooting both stills and video simultaneously? Here is an (unedited) sample video from a session, along with the set of images that were taken on that session. (click the image for the full set, please be advised that some of the videos and photographs may be considered not safe for work) IMG_{—}1171, . . . , As the canon HFS 200 (which I use, and other newer canons) has the new amazing dynamic image stabilization, the 9shooter bracket system makes even more sense, as any shake has been replaced by smooth transitions! I have shot about ten shoots with the HFS 200, and have yet to edit and upload the video, but it rocks! While the video produced with this system may be inferior to a video taken by a dedicated videographer, it is often better than having no video recording at all. Here are some ideas of possible uses for the 45surf 9shooter system:1) Shooting swimsuit models! (or any models for that matter) the model's time is valuable and hard drives and SD cards are cheap! let the video track your every shot throughout a 2 hour shoot, and you will have lots of cool video! more than enough for a two minute or ten minute video!2) Shooting weddings —Imagine shooting a two hour wedding, and then being able to offer your clients a ten minute wedding video set to Beethoven, tracking the entire wedding from all the best angles. Yes I know many people say that for weddings you want to shoot a lot of portrait shots, so go ahead and rotate the camera! Sure the video will be sideways, but you can discard a lot footage out of a two hour shoot and still have an awesome ten minute video which would add a lot of value, or hey—use some sideways video to make people laugh. Or crop portrait shots in post from the landscapes—if you shoot with the 5d they will still be huge. And I am working on a portrait-orientation mount. 3) Shooting sports/action/track meets/surfers! I also use the 9 shooter with a monopod with the 9 shooter oriented in the S configuration to shoot surfers. using a canon 7d with a zoom and an HFS200 zoomed in full on the distant surfer, one can shoot continuous stills of the surfer, and the HFS200 naturally tracks them! in fact, in this case, the canon 7d acts as a natural spotting scope for the canon HFS 100/HFS 200 which don't have optical viewfinders. so it's actually easier to shoot video! just think of your canon 7d & zoom as a $2,000 spotting scope. for your $1,000 HFS 200. :) Will upload the footage soon!4) Photojournalism: If you are covering an event, why not leave the video running the whole time you are shooting stills?5) Documentaries: These days the DSLRs shoot video too, so one could go into an interview armed with the power to shoot both stills and two sources of video simultaneously, benefiting from the better audio controls of the canon HFS 10/HFS 200. And too, the HN40 audio system and other mics could be mounted on the nine shooter. 6) Travel: If you're traveling around Paris for a few hours, why not concentrate on getting both awesome video and photography? Now and then you can stop photographing and focus on the videoing only, and vice versa, as the occasion warrants. 7) Real Estate Photography: Imagine if you became the photographer in your community known for shooting both video and photography of all the homes! Real Estate Agents would love you! And with just a bit more time, you could increase revenues. 8) Paparazzi: Imagine how much better TMZ/Perez Hilton/E! would be if all their photographers/videographers had nine shooters! (I actually never go by these sites, but know some people who do, out here in LA) 9) Audio! A camera shutter makes a lot of noise, so why not mount a remote mic close to the action—perhaps on the bride or groom at a wedding or on the speaker at a lecture—with the radio receiver mounted on your 9shooter and plugged into your camera or audio recorder. 10) Everything! So often in the visual arts the moment happens once and is gone forever. Now you have a better way of immortalizing it in both stills and videos. Mount lights, monitors, mics, flashes, receivers, recorders, and more! The 9shooter keeps your flash bracket free, and/or too, it could be mounted atop your camera. About the author: Dr. Elliot McGucken is the photographer behind 45surf and teaches the Arts Entrepreneurship & Technology 101 class. Get the DIYP greatness via RSS, newsletter and TwitterConnect with the community: Facebook Page, Discussions, Readers ProjectsShare Ideas, Setups, Images and Projects on DIYP's Flickr, visit Readers PhotosRelevant Content * DIY Camera Hard Case *Easily Carry Your Bokeh Discs *DIY iPhone/Camera Steadicam *Capture 720P HD With Any LiveView Capable Canon Camera *The Real Story Behind Starbucks—Getting The Perfect White BalanceComments . . . *Aug. 31, 2010 *AndyNo thanks. And stop bursting. *Aug. 31, 2010 *5 comments *ShareWhy did they bother with stills? *Aug. 31, 2010 *VinceIn watching this video I just shook my head. The shutter was clicking constantly and really had me wondering. Why did they even bother with a still camera? Obviously they relied on the spray and pray method of photography. *Aug. 31, 2010 *5 comments * Sharejust trying to demo shooting stills & video simultaneously :) *Aug. 31, 2010 *Elliot i was just trying to demo shooting stills & video simultaneously, so i needed to shoot a lot of stills for this demo! so i kept the finger on the trigger. :) it would have been a boring demo with two or three stills during a two minute video.many photographers shoot in continuous bursts—that is why canon's latest pro-oriented cameras (7d, 1d Mark 4) boast 2 digic processors. if you ever go to a runway fashion shoot, or pro swimsuit shoot, you will witness them shooting in continuous bursts. fps is a major marketing and selling point for cameras, because there is a great demand for high fps in the pro world, where they do not call it “spray and pray” but a pro job and salary. i was shooting with the 5d mark ii which has only one digic processor and is slower than canon's latest, and while i do not normally shoot at such high rates continuously, i was focused on creating a demo for the 9 shooter—showing that one could obtain both useful stills and video simultaneously. :) so i shot a lot of stills in a condensed period of time. Thanks & best, E :) *Aug. 31, 2010 *5 comments *Shareinteract *Sep. 1, 2010 *chii'm surprised that there wasnt a lot of interaction between the model and shooter. I'm usually engaged in light conversation or I'm letting the model know she's doing a great job. Some sort of morale boosting chatter or similar. *Aug. 31, 2010 *5 comments *ShareYes I compliment the models all the time :) *Sep. 1, 2010 *Elliot Yes I compliment the models all the time :) But when shooting a burst sequence, idle chatter will incite them to talk, and when people talk a lot of times it results in the capture of more awkward facial expressions. The model typically does not want to chat when the shutter is going off, but she wants to shoot, and then talk later. & definitely always compliment the models! But if you overdo it will come across as hollow and it will be distracting. Once or twice for each segment of the shoot is probably best, as well as when you find a great angle, share it! But idle chatter for the sake of chatter is probably better left for some other time, as most models would rather shoot than chat during a shoot; and then chat afterwards. And too, it is hard to carry on idle chatter in a sea cave echoing the roar of the breaking pacific, unless you like yelling. :) I′ve probably shot a couple dozen or so shoots with the 9shooter—lots of fun footage! http://www.diyphotography.net/a-diy-9shooter-shooting-stills-video-simultaneously-audio-too started shooting stills & video simultaneously.

More Prior Art & the Novelty of the Current Invention:

When I posted it on the Model Mayhem photography forum, which can be considered a forum of experts, all of whom must be pre-approved by the modelmayhem owners, I came to see that the device was both a) non-obvious and b) novel, and that it countered the opinion of many of the so-called experts. All in all, love it or hate it, nobody had ever seen anything like it! On Dec. 1, 2009, I started a thread on an modelmayhem expert photography forum which demonstrates the novelty of the current invention—here is the thread:

Search Reply123lastPhotographermalibucanyonphotographyPosts: 172 Las Flores, Calif., US here's my new rig for catching video & stills @ the same time:http://45surf.smugmug.com/Other/dslr-wi . . . 4835_TcH5khttp://45surf.smugmug.com/Other/dslr-with-hd-video-dslr-stills/45surf-double-45-dueler-TM/swimsuit/728931993_bkGWP-M.j pghttp://45surf.smugmug.com/Other/dslr-with-hd-video-dslr-stills/45surf-double-45-dueler-TM/swimsuit/728920902_QjqT8-M.jpgit rox to catch both video and stills of this: http://45surf.smugmug.com/Other/dslr-with-hd-video-dslr-stills/45surf-double-45-dueler-TM/swimsuit/728934568_JPqeK-L.jpganyone else shoot video?happy holidays! Dec. 1, 09 07:11 pm Link Quote PhotographerPYPI FASHIONPosts: 35,892 San Francisco, Calif., US No thanks. I don't want my videos to be all shaky and I don't want to shoot still which required smooth movements from one camera position to another. It's possible to brush your teeth and shave at the same time but you're likely to get cuts. How much did you pay for that? I could probably rig one up for under $10 with a trip to Home Depot. Dec. 1, 09 07:15 pm Link Quote PhotographermalibucanyonphotographyPosts: 172 Las Flores, Calif., US the videos and stills are both smooth as if you are shooting continuous stills, you need to keep the camera steady, just like if you are shooting continuous video.smile Dec. 1, 09 07:17 pm Link Quote PhotographerPYPI FASHIONPosts: 35,892 San Francisco, Calif., U malibucanyonphotography wrote: the videos and stills are both smooth as if you are shooting continuous stills, you need to keep the camera steady, just like if you are shooting continuous video.smile I don't know how you shoot but I shoot mostly portrait orientation. I shoot some frames, drop the camera to the side, give some instructions, bring the camera back to my eye, shoot some more, point the camera down and chimp, set the camera down, fix something, etc. You get the idea. That video will look like crap. Dec. 1, 09 07:22 pm Link Quote PhotographerDoug LesterPosts: 8,811 Atlanta, Ga., US I think not. I can't think of a better way to screw up both the stills and video. I move around when I shot, moving the camera from portrait to vertical, from eye level to down low, from left to right and so on. Seems to me that using that rig would be about the same as shooting with still and video camera mounted together on a tripod. Very static! Dec. 1, 09 07:28 pm Link Quote PhotographerPYPI FASHIONPosts: 35,892 San Francisco, Calif., US Here's a better way to shoot both video and still at the same time. If it's good enough for Time magazine, it's good enough for me. It's a little more expensive than the $10 I would have spent at Home Depot.http://www.red.com/ Dec. 1 09 07:32 pm Link Quote PhotographermalibucanyonphotographyPosts: 172 Las Flores, Calif., US It actually is quite steady as when one shoots stills, one must be steady; and when one one shoots video, one must be steady. The mass of the Canon 5d Mark ii actually smooths out the ride of the hd camcorder. I often shoot for a few minutes with the model changing poses in one place, and me walking about her, slowly changing the camera angles. And when you put the camera down, you hit the stop button. It changes my style a bit, but not much; and I get both awesome vids & pics. smile And of course I don't use it all the time . . . but there were just so may times I'd wished I'd had video . . . Dec. 1, 09 07:33 pm Link Quote Photographerc_d_sPosts: 7,327 Lubbock, Tex., US What's the point? Dec. 1, 09 07:37 pm Link Quote PhotographermalibucanyonphotographyPosts: 172 Las Flores, Calif., US i've been working on a documentary which features a lot of photography. a lot more photorgaphers are shooting video now too . . . smile Dec. 1, 09 07:40 pm Link Quote PhotographerG Cobb PhotographyPosts: 11,606 Southaven, Miss., US c_d_s wrote: What's the point?Exactly Dec. 1, 09 07:40 pm Link Quote PhotographerKeith Allen PhillipsPosts: 2,520 Los Angeles, Calif., US Not a chance. I think I see why you're all jazzed on it though . . . it's your product right? And this is smelling more like SPAM than someone excited about a new product now. Dec. 1 09 07:40 pm Link Quote PhotographerGCobb PhotographyPosts: 11,606 Southaven, Miss., US malibucanyonphotography wrote: i've been working on a documentary which features a lot of photography. a lot more photorgaphers are shooting video now too . . . smile Yeah it's common for a model to show up for a nude shoot and the photographer just happens to have a video camera there without discussing it with her too. smile Dec. 1, 09 07:41 pm Link Quote PhotographerAndrew Thomas EvansPosts: 20,245 Minneapolis, Minn., US malibucanyonphotography wrote: http://45surfsmugmug.com/Other/dslr-with-hd-video-dslr-stills/45surf-double-45-dueler-TM/swimsuit/728920902_QjqT8-M.jpgSorry, but can you take this picture down so I . . . Dec. 1, 09 07:42 pm Link Quote PhotographerKeith Allen PhillipsPosts: 2,520 Los Angeles, Calif., US At the very least you should probably post some sample video and stills that were shot at the same time dontcha think? Dec. 1, 09 07:44 pm Link Quote PhotographerPYPI FASHIONPosts: 35,892 San Francisco, Calif., USGreg Cobb Photography wrote: Yeah it's common for a model to show up for a nude shoot and the photographer just happens to have a video camera there without discussing it with her too. smile I keep mine well hidden behind a two way mirror in the changing room. wink Dec. 1, 09 07:44 pm Link Quote PhotographerPYPI FASHIONPosts: 35,892 San Francisco, Calif., US I'm not sure if you know but all the new dslr from major brands going forward will have video capabilities. Many have had that for over a year. Dec. 1 09 07:46 pm Link Quote PhotographermalibucanyonphotographyPosts: 172 Las Flores, Calif., US Keith Allen Phillips wrote: At the very least you should probably post some sample video and stills that were shot at the same time dontcha think? yes! working on it. smile it's a bit of a different mindset, but it's way fun too . . . and productive. Dec. 1 09 07:48 pm Link Quote PhotographerLiving CanvasPosts: 1,888 Minneapolis, Minn., US Andrew Thomas Designs wrote: Sorry, but can you take this picture down . . . ? Gah!!! Noooo! Don't do that It's purty smile Dec. 1 09 07:49 pm Link Quote Photographer45surf PhotographyPosts: 59 Los Angeles, Calif., US Dec. 1 09 09:02 pm Link Quote PhotographerfLOVE PHOTOGRAPHY NYCPosts: 1,057 New York, N.Y., US I'll pass, on this or DSLR video. If I'm gonna shoot motion picture I'll shoot motion picture, and preferably not video but film. As for all the rest I think half of being a photographer is making the decision of when to press the shutter If you're shooting video you're not a photographer, you're a videographer, if you're shooting film you're a cinematographer. I don't understand what some people, and Canon with their latest commercial, are trying to do by seemingly trying to kill the still image . . . makes me sad. -f Dec. 1 09 09:50 pm Link Quote PhotographerAndrew Thomas EvansPosts: 20,245 Minneapolis, Minn., US fLOVE PHOTOGRAPHY NYC wrote: If you're shooting video you're not a photographer, you're a videographer, if you're shooting film you're a cinematographer. “Director of photography”—look it up sometime, you'd be surprised. Dec. 1 09 09:52 pm Link Quote PhotographerfLOVE PHOTOGRAPHY NYCPosts: 1,057 New York, N.Y., US Andrew Thomas Designs wrote:“Director of photography”—look it up sometime, you'd be surprised. Okay, director of photography—noun Movies. the person who is responsible for all operations concerning camera work and lighting during the production of a film. Also called cinematographer.cin•e•ma•tog•rapher [sin-uh-muh-tog-ruh-fer] Show IPA—noun 1. a person whose profession is motion-picture photography. 2. director of photography•pho•tog•ra-phy [fuh-tog-ruh-fee] Show IPA Use photography in a Sentence—noun 1. the process or art of producing images of objects on sensitized surfaces by the chemical action of light or of other forms of radiant energy, as x-rays, gamma rays, or cosmic rays. 2. cinematography.vid•e•og•ra•phy [vid-ee-og-ruh-fee] Show IPA—noun the art or process of making films with a video camera. Related forms: vid•e•og•ra•her, noun Hmmmm . . . funny, I still don't see where they call him a photographer. Let's not confuse words here. Photography is a process . . . as you can see, when you add motion to that process, it becomes Cinematography. Vittorio Storaro seems to agree with me, AC: Why do you prefer the title of “cinematographer” to “director of photography” in the credits? Storaro: Because we aren't directing. That is Warren's job. We are writing with light and motion to tell a story. That distinction is very important and to finish, the definition of a photographer pho•tog•ra•her [fuh-tog-ruh-fer] Show IPA—noun a person who takes photographs, esp. one who practices photography professionally. See -graph means ‘drawn’ or ‘written’, -graphy means the process of the drawing, writing, recording, cine is adding the motion picture aspect, and -er is used in forming nouns designating persons from the object of their occupation or labor. Thanks for the recommendation to look up these terms, makes me feel good when I am reminded I know what I'm talking about. Dec. 1 09 10:51 pm Link Quote Photographer [symbol] Posts: 5,134 New York, N.Y., USI totally agree with the concept of shooting with different media for the same shoot/set up for film/memory/cameras are cheap compared to talent, man hours, set fees, location fees, etc. I have done light painting jobs with 7 cameras set up to capture a different viewpoint or type of film/digital.Film/cameras are cheap. Time and talent even assistants are expensive. A week of a good assistant pay is equal to buying a new camera let alone just renting one. Dec. 1 09 10:56 pm Link Quote Photographer [symbol] IPosts: 5,134 New York, N.Y., US Dec. 1, 09 11:01 pm Link Quote PhotographerPatrick WalbergPosts: 29,485 Salinas, Calif., US mal ibucanyonphotography wrote: anyone else shoot video? happy holidays! Yes, I shoot video! I've done some two fisted shooting, but I don't use a rig like that, plus I'm picky about when and where I do it. I've done it fairly successfully at well lit concerts and red carpet events, but I'm pretty close up for those things and I'm rolling with auto focus. I tried two fisted shooting at a fashion show and failed badly! It's too hard to do both stills and video well. I could see that the quality of my work suffers. Much better to partner up with another photographer of videographer. Dec. 1 09 11:06 pm Link Quote PhotographerPYPI FASHIONPosts: 35,892 San Francisco, Calif., US [symbol] wrote: Dec. 1 09 11:13 pm Link Quote Photographer [symbol] Posts: 5,134 New York, N.Y., US PYPI FASHION wrote Dec. 1, 09 11:13 pm Link Quote PhotographerPYPI FASHIONPosts: 35,892 San Francisco, Calif., US [symbol] wrote: good luck in jail My chimp cannot be compelled to testify against me. Dec. 1 09 11:38 pm Link Quote Photographer [symbol] Posts: 5,134 New York, N.Y., US PYPI FASHION wrote: My chimp cannot be compelled to testify against me. Too true. that was funny. Back to the topic shall we? I believe the future is multiple recordings of big shoots. Especially as the big flicker free HMI's are used more. But hey, photographers have been shooting on film sets with silent boxes for ages. This concept is not new. Stills from movie sets have most often been a separate entity/separate person shooting than the actual film. Look it up to those that do not know. Dec. 1, 09 11:44 pm Link Quote PhotographerWilliam SteelPosts: 299 San Clemente, Calif., US That's retarded. Thanks for the gratuitous ass shot; it has spared you from further mocking. Dec. 1, 09 11:54 pm Link Quote Photographer [symbol] Posts: 5,134 New York, N.Y., US William Steel wrote: That's retarded. Thanks for the gratuitous ass shot; it has spared you from further mocking. Get a grip. It is called a bikini at the beach. What a concept. Dec. 2, 09 12:00 am Link Quote PhotographerWilliam SteelPosts: 299 San Clemente, Calif., US [symbol] wrote: Get a grip. It is called a bikini at the beach. What a concept. no, click his link Dec. 2, 09 12:06 am Link Quote PhotographerfLOVE PHOTOGRAPHY NYCPosts: 1,057 New York, N.Y., US [symbol] wrote: Too true. that was funny. Back to the topic shall we? I believe the future is multiple recordings of big shoots. Especially as the big flicker free HMI's are used more. But hey, photographers have been shooting on film sets with silent boxes for ages. This concept is not new. Stills from movie sets have most often been a separate entity/separate person shooting than the actual film. Look it up to those that do not know. Well the person shooting a feature film, and the one taking the stills in the blimps have two different goals out of their respective materials. I feel that the OP has different feelings in mind. 1 work in the motion picture industry, so I know all about that, but how I view what I shoot in motion picture film vs what I shoot in my still photography, are two different things. The only exceptions to this to me are photojournalism and event documentation(a la weddings) the unpredictable and unrepeatable nature of moments in these fields make them ideal candidates. While I can see the appeal of this to use on models, I just have different views on it all. In photojournalism and say for a wedding, you're there capturing someone else's moments. That news story, or those vows aren't yours, they're someone else's. So to be sure to capture every possible moment that they want . . . makes sense. In say fashion photography though, it is your moment, yours and the model's. You two decide what moments are special as you go, as we all know, most moments captured here aren't special, it's the few that make it, while in the other fields, those people tend to cherish a good many of those moments from you, because that whole event was special for them. Either that or it's that one image or action that summarizes a story, and you want to maximize your odds of getting it. For these approaches for fashion photography would be like every shoot is a wedding, which is silly, or like covering the same news story every time, I'd figure we'd eventually figure out the best places to be etc. As for multiple format recordings, we're already there. They send video crews along to document still shoots, and still photographers along to document film shoots. I just don't see the two as interchangeable in this context as the OP at least seems to. It'd be like taking a screen-grab off a video shooting behind the scenes for SI swimsuit and putting it in the magazine as final product, think how the photographer on that shoot would feel. I love motion pictures, and for certain things seeing a video can tell more than a still, but I could never replace the still image because often that frozen moment can be even more powerful than the moving one. Dec. 2, 09 12:10 am Link Quote PhotographerPYPI FASHIONPosts: 35,892 San Francisco, Calif., US William Steel wrote: no, click his linkHey, when you're selling a C bracket with hole in it, you have to spice it up with some T&A. Dec. 2, 09 12:11 am Link Quote PhotographerfLOVE PHOTOGRAPHY NYCPosts: 1,057 New York, N.Y., USWilliam Steel wrote Dec. 2, 09 12:20 am Link Quote PhotographerWilliam SteelPosts: 299 San Clemente, Calif., US the entire [symbol] website doesn't even mention how much it costs. arent there MM rules against this kind of plugging? youre supposed to enter your email for more info. this scheme is less convincing than the chinese/korean spam i get in my inbox every day asking me to send bank account info to some dude in africa. you should rename this website DEAREST LOVELY ONE. maybe its an honest hook, and you find out the c bracket costs nine easy payments of $9.99, just pay a s&h fee of $59. Maybe . . . Dec. 2, 09 12:29 am Link Quote PhotographerPatchouli NyxPosts: 19,907 Santa Cruz, Calif., US malibucanyonphotography wrote: anyone else shoot video? happy holidays! I've mentioned this in another thread, but the biggest issue for me in using a dual camera for still and moving image isn't the camera but rather being cognizant and trying to deal with the barrel throw vis a vis focus pulls (for instance). You probably don't care about this issue with a lens if you're just using it for stills, but for a motioned picture, different needs/issue. That plus modern AF lenses for still cameras don't have an witness marks and why would they? So then you have to start thinking about accessory focus rigs ala redrock which are of course more money. And focusing with your eye through the viewfinder vs attaching a monitor for critical focusing. And what about audio? etc etc. So the photograph of a hot model shooting with a dslr video is nice, but it's not realistic to me as a real world solution to shooting quality video. Dec. 2, 09 12:49 am Link Quote PhotographerUncle TimPosts: 787 Kaneohe, Hi., US Andrew Thomas Designs wrote: . . . and start reading the thread?here here . . . but don't take it down . . . Dec. 2, 09 01:53 am Link Quote Photographerlawrence James PhotogPosts: 310 Las Vegas, Nev., US I will have to try this I'm curious of the actual turnout. the perspective of the video might be useful. Dec. 2, 09 02:04 am Link QuoteForums>Photography Talk>started shooting stills & video simultaneously . . . Search Replyfirst123lastPhotographerFKVPhotoGraphicsPosts: 23,751 Ocala, Fla., US fLOVE PHOTOGRAPHY NYC wrote: I don't understand what some people, and Canon with their latest commercial, are trying to do by seemingly trying to kill the still image makes me sad. -fl'm not sure if killing the still is their objective] haven't actually worked with the new Canon and wonder if those “videos” have the ability to print out only one frame ala' still???1 think Canon is trying to turn rank amatures into getting those shots that only highly skilled and well acquainted with sports can get? I shot H.S. sports and know how much parents love those “action” shots. Until now, getting one using still camera is virtually impossible for the average GWC. Just curious. Can those “videos” produce quality stills??? Dec. 2, 09 05:08 am Link Quote PhotographerMonito AlanPosts: 11,976 Halifax, Nova Scotia, Canada People who think that shooting video simply consists of applying still photo lighting and then pointing the camera are about one tenth right. And we see the results on youtube: jerky camera, no composition, unplanned movements, lack of direction, copyright ripoff soundtrack, rapid cutting to bedazzle the MTV generation, and most important of all, no story or narrative thread! Scrapbook video is what you get. When they said TV was “chewing gum for the mind”, they hadn't met youtube yet. youtube is bubble gum for the mind. Some people are easily amused. FKVPhotoGraphics wrote: Just curious. Can those “videos” produce quality stills???As I understand it, the video frames are 1920×1080 pixels on the better cameras. That would print a 4×6 inch quality still print. Dec. 2, 09 05:36 am Link Quote PhotographerFKVPhotoGraphicsPosts: 23,751 Ocala, Fla., US Monito—Alan wrote: As I understand it, the video frames are 1920×1080 pixels on the better cameras. That would print a 4×6 inch quality still print. Ah . . . there you have it! Canon can now offer those “live action” stills using the video feature because the average consumer could never hope to catch those percise moments on their own. Talk about point and shoot now it's going big time! Dec. 2, 09 05:50 am Link Quote PhotographermalibucanyonphotographyPosts: 172 Las Flores, Calif., US fLOVE PHOTOGRAPHY NYC wrote: I'll pass, on this or DSLR video. If I'm gonna shoot motion picture I'll shoot motion picture, and preferably not video but film. As for all the rest I think half of being a photographer is making the decision of when to press the shutter If you're shooting video you're not a photographer, you're a videographer, if you're shooting film you're a cinematographer. I don't understand what some people, and Canon with their latest commercial, are trying to do by seemingly trying to kill the still image makes me sad. -fThanks for that—but since one's time or an assistant's time costs far more than an hd video camera these days after a few sessions, by mounting the DSLR & HD camera together, one's productivity is greatly increased. If all of a sudden you see opportunities for epic stills, focus on shooting the stills! But keep a video camera running, especially at 24p, and you may be amazed at the results. For weddings and sports, why not be both the videographer and the photographer? Even in DSLR cameras with video, one has to choose whether to shoot continuous sills or continuous videos. Why not catch the winning goal or the bride kissing the groom in both stills and video? Even if you have an assistant performing one of the tasks such as video, why not back it up with video off your own dual cameras? Dec. 2, 09 06:34 am Link Quote PhotographermalibucanyonphotographyPosts: 172 Las Flores, Calif., US lawrence James Photog wrote:I will have to try this I'm curious of the actual turnout. the perspective of the video might be useful. Yes—1 was pleasantly surprised by this. The thing is, one can continually adjust the relative angles of the cameras to one-another—both vertically and horizontally, and one can continually monitor both without moving one's head. The balance is stable. I change my style a bit—I focus on not jerking the camera but moving it smoothly, which helps both the stills and video . . . It basically lets you aim/pan/shoot a video camera with two hands, and it's smaller than this! http://www.bhphotovideo.com/c/product/5 . . . lizer.htmlhaha. Dec. 2, 09 07:47 am Link Quote PhotographerAndrew Thomas EvansPosts: 20,245 Minneapolis, Minn., US malibucanyonphotography wrote: If all of a sudden you see opportunities for epic stills, focus on shooting the stills! But keep a video camera running, especially at 24p, and you may be amazed at the results. And honestly, video isn't all that much different from stills, only the subjects are moving, the frame could be moving, and the lighting is a little harder . . . Actually, it is harder than shooting stills. Dec. 2, 09 08:33 am Link Quote PhotographerConrad T CurtisPosts: 1 Pasadena, Calif., US it was referred to earlier . . . but here goes another shot . . . http://www.crunchgear.com/2009/03/13/fi . . . s-scarlet/ Dec. 2, 09 08:40 am Link Quote PhotographermalibucanyonphotographyPosts: 172 Las Flores, Calif., US Conrad T Curtis wrote: it was referred to earlier . . . but here goes another shot . . . http://www.crunchgear.com/2009/03/13/fi . . . s-scarlet/cool! can the scarlet shoot simultaneous bursts of 21 megapixel stills and hd video continuously? Dec. 2, 09 08:47 am Link Quote PhotographerKeith Allen PhillipsPosts: 2,520 Los Angeles, Calif., US Still waiting to see some sample stills and video shot at the same time. YOU made this thing right? You have to have some samples available if it's so bad ass. Not trying to be a annoying but this just seems like a horrible idea for MANY very obvious reasons. In fact, I can't see any obvious benefits other than perhaps using it to set up stationary cameras. Could I even do that? Is there a tripod mount on the bottom of the thing? Bottom line is that if you want good stills you shoot with a still camera, if you want good video you shoot with a video camera. Doing both simultaneously with cameras that are physically attached to each other degrades the quality of both. Dec. 2, 09 09:37 am Link Quote PhotographermalibucanyonphotographyPosts: 172 Las Flores, Calif., US Keith Allen Phillips wrote: Still waiting to see some sample stills and video shot at the same time. YOU made this thing right? You have to have some samples available if it's so bad ass. Not trying to be a annoying but this just seems like a horrible idea for MANY very obvious reasons. In fact, I can't see any obvious benefits other than perhaps using it to set up stationary cameras. Could I even do that? Is there a tripod mount on the bottom of the thing?Bottom line is that if you want good stills you shoot with a still camera, if you want good video you shoot with a video camera. Do both with simultaneously with cameras that are physically attached to each other degrades the quality of both. Thanks Keith, I am on the road but will post some videos in the next couple weeks. smileOne thing I found is that shooting video is really just shooting continuous stills, and when I shoot stills, I generally shoot continuously. 1 found that while looking through the canon dslr's viewfinder with my right eye, i could open my left eye and see the video monitor too on the lower hd video camcorder! You can see how that would work:http://45surfismugmug.com/Other/dslr-with-hd-video-dslr-stills/45surf-double-45-dueler-TM/swimsuit/728935257_bWqLo-LjpgAnd I can easily and readily adjust either camera's zoom and the relative angles between them. Of course there will be a couple off-stills when I'm suddenly zooming the video for a particular video shot, and vice-versa; but overall, given a two-hour shoot, I'm goin' in “with both guns a blazin'!” Yes—it is new and different, and the first time I was doing it I was laughing, as I'm thinking “how come I never did this before?” It felt good in my hands and the mass was actually stabilizing. In my past life, I was a physics professor, and as the pivot point is where I grab the DSLR, and as the center of mass is below the pivot point, relative to the gravitational field, it gives it a stable feel. And too, you get to control/steady the video camera with two hands. And yes I'm working on a tripod version or two. Well, I owe you some new video! The video looks great & I will edit some & upload in a couple weeks. And until then, enjoy some old video:http://45surf.com/poetryp.s. attaching a great dslr to a great hd video camera detracts form neither one's power . . . your style will change to become more continuously steady (out of conscious respect for the video), but that is not a bad thing. shooting vertacle stills (or changing between vertical and horizontal stills can still be an issue, but you and still rotate the camera to grab a few!) Dec. 2, 09 09:47 am Link Quote PhotographerfLOVE PHOTOGRAPHY NYCPosts: 1,057 New York, N.Y., US malibucanyonphotography wrote: Thanks for that—but since one's time or an assistant's time costs far more than an hd video camera these days after a few sessions, by mounting the DSLR & HD camera together, one's productivity is greatly increased. If all of a sudden you see opportunities for epic stills, focus on shooting the stills! But keep a video camera running, especially at 24p, and you may be amazed at the results. For weddings and sports, why not be both the videographer and the photographer? Even in DSLR cameras with video, one has to choose whether to shoot continuous sills or continuous videos. Why not catch the winning goal or the bride kissing the groom in both stills and video? Even if you have an assistant performing one of the tasks such as video, why not back it up with video off your own dual cameras?Wow, ok, way to not read the posts in your own thread. If you'd only read a little further down from this post of mine, you'd say made another post, about how you would be wanting to shoot stills and video of things like photojournalism (like sports) and events (like weddings). My issue with it is in things like model shoots, since in your post you have a girl who is clearly either a friend and/or model and that it's neither an event or photojournalistic moment. I'll never agree that you should do both at the same time though, only maybe if you're a journalist in the field by yourself. If I'm shooting stills I'm looking for the right angles, and not concerned about how I move the camera to get there. The video from this would look more like a clip out of Cloverfield or something. If I'm shooting video I'm concerned about composition and movement of myself and the subjects, the whole time. IE I don't see how you could do both without making one of them suffer from trying to do the other, if not make both of them. If it was Dad doing it, and not me trying to do it as a professional, then it's fine, but I don't think the product would be up to my standards. Dec. 2, 09 04:03 pm Link Quote PhotographermalibucanyonphotographyPosts: 172 Las Flores, Calif., US

fLOVE PHOTOGRAPHY NYC wrote: Wow, ok, way to not read the posts in your own thread. If you'd only read a little further down from this post of mine, you'd say I made another post, about how you would be wanting to shoot stills and video of things like photojournalism (like sports) and events (like weddings). My issue with it is in things like model shoots, since in your post you have a girl who is clearly either a friend and/or model and that it's neither an event or photojournalistic moment. I'll never agree that you should do both at the same time though, only maybe if you're a journalist in the field by yourself. If I'm shooting stills I'm looking for the right angles, and not concerned about how I move the camera to get there. The video from this would look more like a clip out of Cloverfield or something. If I'm shooting video I'm concerned about composition and movement of myself and the subjects, the whole time. IE I don't see how you could do both without making one of them suffer from trying to do the other, if not make both of them. If it was Dad doing it, and not me trying to do it as a professional, then it's fine, but I don't think the product would be up to my standards. Thanks for feedback, Yes—it actually changed my style a bit, but just a tiny bit. I'm just a bit more conscious about keeping the camera steady and moving smoothly—which is good for both stills & video! And if all of a sudden I want a still or two, I go for it. Then I quickly glance down with my left eye and see whether or not the the subject is still framed in the camcorder. And generally, there they are! The zoom and thus field of view can easily be adjusted for both the camcorder and the dlsr easily. And I consider shoots with models out on the beach events akin to weddings/sports events/etc., as while shooting the model, things just “suddenly” happen, like the clouds break at sunset (like they did just last night), or the wind kicks up, or a set of huge wave rolls in, or a flock of birds lands behind her. In such cases you only have a few minutes to catch it all, as it's a semi-controlled environment; and now I can catch them both in stills and video. And if need be I can turn the video camera off or ignore it, and vice versa. For outdoor, active shoots on the beach with swimsuit models, it's awesome! Everyone has limited time, and shooting video and stills independently would cost twice as much. My former solution was to tape the shoot from a small, set tripod, but that actaully would miss a lot more shots, as we are always moving around and out of frame, and I would have to reset the tripod on rocks/sand which takes time to do right. Now the model is always right there, wherever I am aiming. And too, unlike the camcorder-set-on-tripod model, the camcorder now shoots all the coolest angles which I am finding with the DSLR! So it makes sense for me. Not all of the vidoe footage will be perfect, but 90%+ will rock out, and even be better than the tripod-mounted, stationary camera! Last night I shot with a Canon 5D Markii under shich was mounted an HV30 tape (24 mbps) camera shooting 24p. The model showed up @ 3 pm, so we had two and only two hours before sundown. & it's awesome fun shooting with both simultaneously. I'll be out there with this new rig.smilep.s. and as cheap as cameras, storage, and tapes are getting, as this system saves hours of models/photographers/assistant videographer's time, it pays for itself in a few shoots. Dec. 3, 09 07:37 am Link Quote PhotographerfLOVE PHOTOGRAPHY NYCPosts: 1,057 New York, N.Y., US malibucanyonphotography wrote: Thanks for feedback, Yes—it actually changed my style a bit, but just a tiny bit. I'm just a bit more conscious about keeping the camera steady and moving smoothly—which is good for both stills & video! And if all of a sudden I want a still or two, I go for it. Then I quickly glance down with my left eye and see whether or not the the subject is still framed in the camcorder. And generally, there they are! The zoom and thus field of view can easily be adjusted for both the camcorder and the dlsr easily. And I consider shoots with models out on the beach events akin to weddings/sports. events/etc., as while shooting the model, things just “suddenly” happen, like the clouds break at sunset (like they did just last night), or the wind kicks up, or a set of huge wave rolls in, or a flock of birds lands behind her. In such cases you only have a few minutes to catch it all, as it's a semi-controlled environment; and now I can catch them both in stills and video. And if need be I can turn the video camera off or ignore it, and vice versa. For outdoor, active shoots on the beach with swimsuit models, it's awesome! Everyone has limited time, and shooting video and stills independently would cost twice as much. My former solution was to tape the shoot from a small, set tripod, but that actaully would miss a lot more shots, as we are always moving around and out of frame, and I would have to reset the tripod on rocks/sand which takes time to do right. Now the model is always right there, wherever I am aiming. And too, unlike the camcorder-set-on-tripod model, the camcorder now shoots all the coolest angles which I am finding with the DSLR! So it makes sense for me. Not all of the vidoe footage will be perfect, but 90%+ will rock out, and even be better than the tripod-mounted, stationary camera! Last night I shot with a Canon 5D Markii under shich was mounted an HV30 tape (24 mbps) camera shooting 24p. The model showed up @ 3 pm, so we had two and only two hours before sundown. & it's awesome fun shooting with both simultaneously. I'll be out there with this new rig.smilep.s. and as cheap as cameras, storage, and tapes are getting, as this system saves hours of models/photographers/assistant videographer's time, it pays for itself in a few shoots. Stop peddling your product. In that last post you stopped asking for opinions, feedback, and comments and just made it a cliche sales pitch. Regardless of what you tell me I will never like this idea. Also the more you talk about cost in relation to excusing this, the more annoyed I am. Dec. 4, 09 12:07 am Link Quote PhotographerDigital Planet DesignPosts: 288 Saint Peters, Missouri, US I can't imagine anything more unwatchable then video from a camera attached to my SLR as I am trying to compose, direct and shoot a model. Maybe this is supposed to be a funny product for gag gifts or something. Whatever, I'm sure you're not supposed to pimp your product here. Dec. 4 09 08:16 am Link Quote PhotographerMark LaubenheimerPosts: 2,554 Seattle, Wash., US Greg Cobb Photography wrote: Exactly+1 are we so cheap we can't find someone to shoot the video while another does stills? how about tf*? Dec. 4, 09 08:35 am Link Quote PhotographerHenri3Posts: 4,971 Minneapolis, Minn., US PYPI FASHION wrote: Here's a better way to shoot both video and still at the same time. If it's good enough for Time magazine, it's good enough for me. It's a little more expensive than the $10 I would have spent at Home Depot.http://www.red.com/I could trade all my cameras, lenses, lighting for this and still wouldn't quite be in the Red. wink Dec. 4, 09 08:41 am Link Quote PhotographerHenri3Posts: 4,971 Minneapolis, Minn., US Or just get an Arri 35 mm camera and do it right. The BIG chip Red Epic version is pretty cool, IMax for dummies. Dec. 4, 09 08:44 am Link Quote PhotographerMark EllisonPosts: 1,117 Brooklyn, N.Y., US Wow I know I'm about to really get flamed but . . . I think it's a great ideal!! (Hear me out before anyone douses me with gas) My main function is as a photographer. That means my MAIN concern is still images. However, I'm looking for every single value-added step that I can take to gain extra profit with low/no extra effort. If I can add a rig like this to my shoots, I can run video as a secondary option. The video camera isn't important at that point as the stills are what my client's ORIGINALLY came to me for. After the shoot, I'll keep my normal workflow for the images. I'II slice up the video into individual clips, eliminating the 90% of it that shows my feet as I talk to the model, is shaky, etc. I'll take the best of those clips, use something automated like ANIMOTO to make it look “shiny and purty”, and offer that up as an extra service to the client. Every client loves it when I show it big-screen because it makes them look like a “SupaStar” when they put it on FB, MySpace, etc. It cost me nothing but the annual subscription (which I can easily recoup in two or three shoots) and after that, I can even use it to promote the studio and my services as much as I like, for free. We, as photographers, have to see the extra value that we can provide the clients these days. Anyone can take a good picture with today's technology. You have to separate yourself from the crowd by what you can offer . . . Okay. I'm getting in my Speedos now, preparing for my gasoline bath . . . EDIT: It's not a good system if you want a linear video of any good length but it's excellent for grabbing clips that can be used elsewhere . . . Dec. 4, 09 08:51 am Link Quote ModelK 1C K H A MPosts: 7,928 Los Angeles, Calif., US I think in cases it could be a good idea. Just make sure the model knows. I don't know that I'd be happy if I went to a shoot and there was a video camera that I didn't know would be there. Dec. 4, 09 08:56 am Link Quote PhotographerPatchouli NyxPosts: 19,907 Santa Cruz, Calif., US malibucanyonphotography wrote: Thanks for feedback, Yes—it actually changed my style a bit, but just a tiny bit. I'm just a bit more conscious about keeping the camera steady and moving smoothly—which is good for both stills & video! And if all of a sudden I want a still or two, I go for it. Then I quickly glance down with my left eye and see whether or not the the subject is still framed in the camcorder. And generally, there they are! The zoom and thus field of view can easily be adjusted for both the camcorder and the dlsr easily. honestly, this sounds like half-assing 2 different ways of capturing images rather than approaching each method creatively and professionally. Dec. 4, 09 09:03 am Link Quote PhotographerfLOVE PHOTOGRAPHY NYCPosts: 1,057 New York, N.Y., US Patchouli Nyx wrote: honestly, this sounds like half-assing 2 different ways of capturing images rather than approaching each method creatively and professionally. Glad someone else agrees with melt's like people today rather have more of a crappy product rather than less of a really good one . . . doesn't make sense. Dec. 4, 09 09:42 am Link Quote Photographedim LaffertyPosts: 1,284 Brooklyn, N.Y., US This has to be a joke, right? big_smile Dec. 4, 09 09:46 am Link Quote PhotographerIs photographyPosts: 1,334 Somerville, N.J., US This is so over the top, and it's not even april yet! Dear OP, ask you models to bring an escort, and the escorts shootd the video . . . . This way they can't have their hands free, to steel you equipment, and they won't have time to take pictures with their P&S, for their personal collection. B&H sells a camcorder for $177 which will do 1080p at 30 frames a second onto sdhc flash . . . . It has a terrible white balance and focus, but it makes great artistic movies when for 2 hours in wxga resolution! Dec. 4, 09 09:58 am Link Quote PhotographerFinearts PhotographyPosts: 706 Cleveland, Ohio, US I hope to get a high end video camera that can take photos at the same time. There are some good HD cameras that say they can do this. Some you can frame grab to get photos when you edit. These cameras cost 3K and more. Dec. 4, 09 10:00 am Link Quote PhotographerDigital SoupPosts: 15,727 Huntington Beach, Calif., US 45surf dual 45 dualer? What? Dec. 4, 09 10:01 am Link Quote Photographer7imagingPosts: 636 Tampa, Fla., US malibucanyonphotography wrote:anyone else shoot video? happy holidays! 80% of my shoots are filmed . . . . I would love the RED system. Dec. 4, 09 10:07 am Link Quote PhotographerLe Beck PhotographyPosts: 3,768 Los Angeles, Calif., US Andrew Thomas Designs wrote: Sorry, but can . . . I thought she was the rig and figured it was a one off custom job. Dec. 4, 09 10:57 am Link Quote PhotographerSmedley WhiplashPosts: 12,599 Billings, Montana, US Kelli Kickham wrote: I think in cases it could be a good idea. Just make sure the model knows. I don't know that I'd be happy if I went to a shoot and there was a video camera that I didn't know would be there. heh heh . . . how on earth could you not know THAT was there? It ain't exactly covert. lol Dec. 4 09 11:29 am Link Quote ModelK 1 C K HA MPosts: 7,928 Los Angeles, Calif., US Smedley Whiplash wrote: heh heh . . . how on earth could you not know THAT was there? It ain't exactly covert. lolloll meant before the shoot silly. But that would be a pretty funny thing to overlook. It seems like it would be really annoying and limit mobility though. I would think setting it up from a tripod would be more effective, or having an assistant filming. Dec. 4, 09 11:33 am Link Quote ModelK ICKH A MPosts: 7,928 Los Angeles, Calif., US Since it DP'd, I'm responding to the post below me. Yes, I know a great photographer in my area and I was talking her up to some girls on my roller derby team. One said, “Well, of course! She's a professional photographer.” Uh . . . yeah That totally means something these days. Dec. 4, 09 11:35 am Link Quote PhotographerPatchouli NyxPosts: 19,907 Santa Cruz, Calif., US fLOVE PHOTOGRAPHY NYC wrote: Glad someone else agrees with melt's like people today rather have more of a crappy product rather than less of a really good one . . . doesn't make sense. oh puhleeze. I don't even have to begin to tell you . . . the shi—that's being passed off as professional video right now. I mean it's one thing if it's “home movies” like old super 8 only modern. But if someone handed me a video made from someone trying to simultaneously keep a still and video camera in focus with a subject that isn't immobile, I'd be tempted to break their C clamp contraption right then and there . . . Dec. 4, 09 11:44 am Link Quote PhotographerAmazing ProductionsPosts: 433 Laguna Beach, Calif., UShttp://45surf.smugmug.com/Other/dslr-with-hd-video-dslr-stills/45surf-double-45-dueler-TM/swimsuit/728920902_QjqT8-M.jpg The more I look at this idea the more I like it. And the dual camera rig is very interesting, also. But how does the union feel about this? You are putting a cameraman out of work. Have you considered wearing one of the cameras on your head like a hat? How might that work? Dec. 4, 09 11:50 am Link Quote PhotographermalibucanyonphotographyPosts: 172 Las Flores, Calif., US lawrence James Photog wrote: I will have to try this I'm curious of the actual turnout. the perspective of the video might be useful. yes—the relative angles between the camcorder and the dslr are adjustable for various persepctives. plus the zooms on both cameras can be varied. takes a bit of learning, but it's kinda like putting a sail on a surfboard—the board's still cutting through the same water, but now it's both the wind and waves one must pay attention to . . . smile Dec. 4, 09 05:40 pm Link Quote PhotographerMonito—AlanPosts: 11,976 Halifax, Nova Scotia, Canada malibucanyonphotography wrote: the relative angles between the camcorder and the dslr are adjustable for various persepctives. plus the zooms on both cameras can be varied. takes a bit of learning, but it's kinda like putting a sail on a surfboard—the board's still cutting through the same water, but now it's both the wind and waves one must pay attention to . . . smileNah, It's like putting a sail on one hull of a catamaran and a V6 engine on the other hull. Dec. 4, 09 06:12 pm Link Quote PhotographerDariolmpiniPhotographyPosts: 8,363 Carmel, Ind., US I'm going to write a blog message about this convergence. I see a lot of resistance to the idea on this thread and I admit I have been too. But I just shot my first few videos myself and I have to say, it is absolutely compelling. Mixing video/audio/stills together is a bad as—media package for just about any event, depending on the intent of the end product. I see the convergence in technology forcing a convergence in the practitioners of both fields, video and stills. And I think we will see that convergence and I am formally here and now coining the phrase, the emergence of the “event artist”. The event artist captures the event, artistically. Neither a pure artist nor a pure photojournalist, but a mix of both, capturing the event artistically, but with a more compelling spin using the available technological media they have at their disposal. Some day it will be immersive, or 3D or some other as yet undeveloped form. And we will be forced to adapt, or be relegated to the remnant heap of increasingly marginalized old-school players.lts reality, its technology, its progress, and it cannot be avoided. Dec. 4, 09 06:31 pm Link Quote PhotographerPYPI FASHIONPosts: 35,892 San Francisco, Calif., US Why is this thinly veiled spam thread still open? I agree that there are valid discussions regarding shooting video at he same time as stills but that discussion should be restarted in a new thread without the sales pitch. Dec. 4, 09 06:33 pm Link Quote PhotographerDarioImpiniPhotographyPosts: 8,363 Carmel, Ind., US Mark Ellison wrote: Wow I know I'm about to really get flamed but . . . I think it's a great ideal!!(Hear me out before anyone douses me with gas)My main function is as a photographer. That means my MAIN concern is still images. However, I'm looking for every single value-added step that I can take to gain extra profit with low/no extra effort. If I can add a rig like this to my shoots , I can run video as a secondary option. The video camera isn't important at that point as the stills are what my client's ORIGINALLY came to me for. After the shoot, I'll keep my normal workflow for the images. I'll slice up the video into individual clips, eliminating the 90% of it that shows my feet as I talk to the model, is shaky, etc. I'll take the best of those clips, use something automated like ANIMOTO to make it look “shiny and purty”, and offer that up as an extra service to the client. Every client loves it when I show it big-screen because it makes them look like a “SupaStar” when they put it on FB, MySpace, etc. It cost me nothing but the annual subscription (which I can easily recoup in two or three shoots) and after that, I can even use it to promote the studio and my services as much as I like, for free. We, as photographers, have to see the extra value that we can provide the clients these days. Anyone can take a good picture with today's technology. You have to separate yourself from the crowd by what you can offer . . . Okay. I'm getting in my Speedos now, preparing for my gasoline bath . . . EDIT: It's not a good system if you want a linear video of any good length but it's excellent for grabbing clips that can be used elsewhere . . . +1 Dec. 4, 09 06:35 pm Link Quote PhotographerDarioImpiniPhotographyPosts: 8,363 Carmel, Ind., US PYPI FASHION wrote: Why is this thinly veiled spam thread still open? I agree that there are valid discussions regarding shooting video at he same time as stills but that discussion should be restarted in a new thread without the sales pitch. What sales pitch? Dec. 4, 09 06:36 pm Link Quote PhotographerDarioImpiniPhotographyPosts: 8,363 Carmel, Ind., US FKVPhotoGraphics wrote: Ah . . . there you have it! Canon can now offer those “live action” stills using the video feature because the average consumer could never hope to catch those percise moments on their own. Talk about point and shoot now it's going big time!Yeah I dont know. The shutter speed cant be too high and since the actual mechanical shutter is jammed open, can never be truly crisp which is one of the hallmarks of those great action sports shots. Soo . . . IDK. You'll get a shot you probably would have missed, but there's going to be an awful lot of blur in it. Maybe it doesnt matter at 4×6 anyway. Its an improvement over a point and shoot, but the camera in general is an improvement over the point and shoot. Seems ridiculous to pay that much for a high end camera just to shoot video with it. Dec. 4, 09 06:40 pm Link Quote PhotographerPYPI FASHIONPosts: 35,892 San Francisco, Calif., U DarioImpini Photography wrote: What sales pitch? I'll give you a hint. The OP of this thread is selling this thing and the sales pitch is in the first post. It starts with http://Dec. 4, 09 06:52 pm Link Quotestarted shooting stills & video simultaneously . . . Search Replyfirst123Photographer DarioImpini PhotographyPosts: 8,363 Carmel, Ind., US Oh I see, OK. Well, I was just responding to the concept; its been heavy on my mind lately as I start to see new possibilities. The particular bent she's going on I think is way besides the point. I think the point of the DSLRs with video is the film-esque quality about the video that you cant get from a cheap camcorder and thats what makes it compelling. Dec. 4, 09 06:59 pm Link Quote PhotographerKeith Allen PhillipsPosts: 2,520 Los Angeles, Calif., US PYPI FASHION wrote: Why is this thinly veiled spam thread still open? I agree that there are valid discussions regarding shooting video at he same time as stills but that discussion should be restarted in a new thread without the sales pitch. DarioImpiniPhotography wrote: What sales pitch? The OP is the maker of that little bracket holding the cameras together. It looks like an awesome product if you never shoot verticals, like crippling your still shooting style and making unwatchable video with the sound of your still camera clicking away on the soundtrack. Can't wait to see the price of this thing hmm. From:—http://www.modelmayhem.com/po.php?thread_id=531686&page=3 I went from a Nikon d300 (which reached its shutter cycle) to a Nikon d90 and Canon 5D mark ii just a couple weeks ago. Love them all! I often take a mini hd camera with me to shoots, such as the canon hv40 or hv30, so I have never tried the video capabilities of the d90 and Canon 5D. When I'm out there shooting stills, I am shooting stills/thinking stills, so to use the Canon 5D all of a sudden to shoot video, or start shooting stills during the video, would result in choppy/ill-conceived video. Models have limited time, so when I'm shooting stills, I need to shoot stills the entire hour or so. :) I'm not sure I'll ever use the video on the cameras. As one can see from the above conversations, as well as others throughout the internet, the dslr doesn't take very good video when compared to the canon hv30/hv40 hf s100 and other cameras devoted purely to hd video capture. And the hd cameras which take stills do not take good stills when compared to the dslrs. When one considers the value of one's time, why not shoot both stills and video at every shoot? When one considers the value of one's time, and just how inexpensive dedicated hd cameras are becoming, why not shoot both stills and video at every shoot? For instance, a Nikon d90, with the same sensor as the Nikom d300, and a dedicated hd camera, can both be bought for less than the price of a Nikon d300. Suppose a celebrity is coming down the red carpet—why not turn the video camera on and shoot, while you're firing stills? You can quickly glance at both the dslr and video monitors to make sure both are operating properly, and that the field of view is accurate. All of this can be pre-adjusted with the approximate distance from which you'll be shooting. Imagine setting up a model to model clothing for a fashion line. As you will be standing in one place, it will be fairly simpler to adjust both cameras for the proper field of view; and once done, you can shoot away! In wedding situations, it is well known exactly where the bride will be walking and where the bride and groom will be standing; all of this can be adjusted for ahead of time, and too, it can be quickly adjusted on the fly! If it turns out you got no good video, dump the files and free up the card When one considers the fleeting character of live events such as weddings, parties, red-carpet-events, and athletic events, the ability to shoot in high-quality video and stills simultaneously becomes paramount. For instance, one cannot make the bride walk down the aisle twice just to capture it both in video and stills. One cannot make the high-school quarterback re-throw the touchdown pass. And as swimsuit models have things to do and places to be, one cannot make them stand forever on the beach, just so one can shoot both video and stills. One cannot make celebrities walk down the red-carpet twice, for both video and stills. Even if the photographer hires an assistant to shoot video, why not also arm them with the Dual 45 Dueler™, and have them shoot both video and stills? As digital capture and storage grow cheaper by the moment, why not have a mounted hd video camera recording the shoot continuously? Surely there is a lot of upside potential for newfound revenue, with a relatively small investment. The Dual 45 Dueler could also be used to connect two hd cameras in tandem, so as to capture the video and the sound in two different manners; for instance, if one wishes to use a mounted or on-board mic on one, and a remote mic (sensenheiser or other) on the other video camera. Prior Art: In order to illustrate the shortcomings of the dslrs which also shoot video, as well as video cameras which shoot stills, I posted the following question in the flickr.com user group. Can any of the canon (or nikon) cameras shoot video and stills simultaneouly? 45surf.com™45 SURF PHOTOGRAPHY™ says: can any of the canon (or nikon) cameras shoot video and stills simultaneouly? for instance, if i am shooting video, can i also be shooting stills? if so, will the rate for stills be slower while it is also shooting video? thanks! Posted at 9:12 PM, 25 Nov. 2009 PST (permalink|edit) J-Fish says: Well you could take screenshots from the videos you make . . . but that's about all. Unless one of the companies magically installs a second sensor in the camera I don't see this happening any time soon. Posted 11 hours ago. (permalink)

the scattered image says: Yes. Posted 11 hours ago. (permalink) [H J. Nee ]™ says: that will not happen at the same time b/c the sensor has to refresh its load of electrons COMPLETELY before taking the shot BUT you're taking a video already which continuously feeds it. Posted 9 hours ago. (permalink) jeffery_dan says: If you are videoing with the 7D and press the shutter button it will take a photograph and pause the video for about a second. Posted 9 hours ago. (permalink) PSJ Picdump says: Yes you can with the 5D MkII, but as Jeff says, there is a pause in the video when it happens. Posted 8 hours ago. (permalink) nb|photo (nicbet) says: Some people are grabbing still images off the HD video, in okay quality. Canon themselves even claim it's a technique commonly used by photojournalists . . . www.usa.canon.com/dlc/controller?act=GetArticleAct&ar . . . Posted 7 hours ago. (permalink) Alan Whyte says: or you could always go down the buying a video camera that allows you to take photos at the same time route. Posted 4 hours ago. (permalink) Harry Pulley says: Simultaneously? Define simultaneous. You can take stills while video is being taken but it will freeze the video for the time it takes to record the still. Or as mentioned above, you get get 2MP stills by extracting them from full HD video (1080 P is 2MP, 720P is about IMP). Posted 4 hours ago. (permalink)

A bunch of beans says: Alan, it's been my experience that the video cameras that can also shoot stills don't take very good photographs. They're ok for family snapshots, but if you're looking for a good-quality shot, they're just not up to par. Posted 3 hours ago. (permalink)

Embodiments of the Invention: The present invention also known as a 9shooter bracket or 45surf Dual Dueler™ or the 45surf Dueler™ can be easily constructed by one knowledgeable in the art of ball-and-socket mounts and camera mounts. While prior art sells ball and socket swivel mounts independently, for mounting cameras on fixed surfaces, there is no device on the market which attaches one camera's ¼″ mount to another camera's ¼″ mount via a ball-and-socket array allowing for both relative positioning of said two cameras, be they a video and slr camera, or any other form of two cameras. The 45surf Dueler™ combines a plurality of ball-and-socket, arm, and camera-mount apparati together for new and hitherto unseen results, leading to a novel, useful tool for photographers and videographers. The 45surf Dueler™ combines a plurality of ball-and-socket, arm, and camera-mount apparati together for new and hitherto unseen results, leading to a novel, useful tool for photographers and videographers, allowing them to capitalize on the following trends in a novel, hitherto unseen manner: High-quality digital imaging equipment is getting smaller and lighter (a top-notch dslr and hd video camera today, when combined, may weigh less than a single hd video camera or dslr from just a few years ago!) Digital storage is becoming cheaper and cheaper, both in the forms of hard drives and flash memory. With 16 gig sd memory cards going for thirty bucks and terabyte hard drives costing less than $1,000, there is plenty of storage room both both stills and hd video from all your shoots! Both online video and high-quality stills are becoming more and more important to businesses. Digital SLRs which shoot video are not as good at video as dedicated hd video cameras, and hd video cameras which shoot stills are not as good as digital sirs. High-quality digital imaging equipment is costing less and less (a top-notch dslr and hd video camera today, when combined, may cost less than a single hd video camera or dslr from just a few years ago!) Digital SLRs which shoot video are not as good at sound as dedicated hd video cameras. Shooting video with a DSLR interrupts the shooting of stills while eating away at the camera's memory; and one cannot shoot both continuous video and stills with a DSLR, even if it is capable of hd video. Another embodiment could consist of two cameras (in this case a dslr and hd video camera) may be attached by the 45surf Dueler™. The 45surf Dueler™ apparatus consists of a plurality of ball and socket joints, extending arms, and standard threaded camera amounts attached to balls. All this this makes for a highly-configurable and adjustable system and method for attaching two cameras so as to maximize the photographer's/filmmaker's/videographer's productivity and output. Another similar embodiment shows that 45surf Dueler™ apparatus will allow for clearance. The extending arms can be adjustable in length, or various lengths of extending arms may be provided in the 45surf Dueler™ package. In this embodiment, two cameras (in this case a dslr and hd video camera) may be attached by the 45surf Dueler™. The 45surf Dueler™ apparatus consists of a plurality of ball and socket joints, extending arms, and standard threaded camera amounts attached to balls. All this makes for a highly-configurable and adjustable system and method for attaching two cameras so as to maximize the photographer's/filmmaker's/videographer's productivity and output. In another embodiment, the present invention or 45dueler may be used to attach two hd video cameras, or any other types of cameras with standard ¼″ threaded camera mounts, most standardly used on tripods. In another embodiment, a stand-alone 45surf Dueler™ may be used to attach any two hd video cameras or digital sir cameras, or any other types of cameras with standard ¼″ threaded camera mounts, most standardly used on tripods. The stand-alone 45surf dueler™ may be readily fashioned from off-the-shelf components or custom machined components. MORE DISCUSSION OF PRIOR ART AND THE NOVELTY OF THE INVENTION: Another advantage is that camera stores will be able to sell more digital cameras, by bundling DSLRs and HD video cameras together. Further arms/brackets could be attached to the standard two-bracket system, so as to provide for the mounting of flashes, audio equipment, further recording devices, and other peripherals. Arms of The present invention could be imagined as a single camera device combining both DSLR and video capabilities with two separate lenses/systems aboard a single body. Or a single lens could feed into two systems. The two display screens on the two cameras may aid in the focusing and view finding, as they can be adjusted to different zooms in a manner that aids the overall view finding. Arms and brackets of different lengths and sizes could be provided in the same Dual 45 Dueler kit™. Extensions could be provided in the kit, along with additional screws, bolts, washers, and nuts. Extensions and arms and additional brackets could be attached when the operator was adding more components to the cameras including flashes, microphones, and other peripherals. In its simplest case, a simple straight piece of metal with two holes in it could be used to extend the device where the brackets attach. In addition to being extended vertically, such pieces of metal could extend the device laterally. The cameras could be arranged differently, such that the Canon Mark ii V could be used to shoot video, while a different stills camera could be placed atop it. Or the brackets could be sized such that two Canon Mark ii V's could be used simultaneously, one for video, and one for stills. Basically, when it comes down to it, the Canon Mark ii V′s and all other cameras can only be fully dedicated to shooting either stills or video, so by combining two of them, one gains a leg-up. THE NINE SHOOTER™ BRACKET: AKA THE HERO'S JOURNEY SEVEN SHOOTER™ Using flash shoe adapter mounts and tripod screw mounts and ¼-20 screw mounts, attached to flash shoe mounts, ball-head, screw mounts, ball-head flash shoe mounts, and all other standard mounts. The Hero's Journey Nine Shooter can be used to combine the following devices and mount the following devices in close proximity to any dslr or video camera, using both the flash mount bracket generally above the camera and tripod screw mount generally below the camera: 1) video monitor 2) wireless receiver 3) wireless transmitter 4) video camera 5) hd video camera 6) dlsr 7) evil camera 8) external mics 9) lights 10) panel lights 11) extra mics 12) other devices The two standard I brackets of the Nine Shooter Can be Combined in the following shapes, as well as others. U bracket above camera. U bracket under camera. C bracket above camera. C bracket below camera. S bracket above camera. S bracket below camera. L bracket above camera. (single bracket) L bracket below camera. (single bracket) L bracket on side of camera when DSLR is used to shoot portrait shots. C bracket or U bracket on side of portrait-oriented shots is also possible. L bracket above and below camera. All the above can be rotated relatively to the camera. Most of the above can be used in conjunction with a tripod. All the above can be used with all sorts of cameras both still and video, dslr, point and shoot, hd, and video, and others with standard tripod/monopod screw mounts and shoe mounts. The below figures illustrate some of the multitudinous manners in which the brackets could be mounted, while either attached by a screw or separated. Many more combinations and orientations of the brackets could be imagined. More brackets and extensions could be easily added, adding to the superiority over the prior art. With just one single 1 bracket, using both sides of the holes, the 9 shooter could hold more mounts than the j cube's 3. With both 1 brackets combined together, it could be more than twice as much, while also offering more flexibility and angling of the brackets, allowing the rotation and position of attached device to be more easily adjusted. The dual 45 dueler may also include a rotating mechanism to shoot portraits and landscape, while yet maintaining the landscape orientation for the video camera throughout. http://www.adorama.com/images/Product/CBDPMK.jpg In the simplest case, a single 1 bracket of the nine shooter may be used to mount a video camera beside the dslr in portrait orientation. Something like the following could be used with the s bracket formation of the 9shooter mounted atop a tripod or monopd: The above may be rotated to shoot portrait orientations, utilizing both brackets to the side of the camera, or only just one bracket, with the video camera mounted above or below the dslr. http://www.usa.canon.com/uploadedimages/FC K/Image/Tips_Techs/Movie Mode Basics/WFT-E4A_Select_Folder.jpg http://www.usa.canon.com/uploadedimages/FCK/Image/Tips_Techs/Movie Mode Basics/5DII_WFTE4A.jpg http://www.usa.canon.com/dlc/controller?act=GetArticleA ct&articleID=2186 The WFT-E4A acts as a USB host, which makes it possible to attach storage devices with far greater storage capacity than CF cards. Small devices such as most USB “keychains” and hard drives with 1.8-inch or smaller disk diameters can be powered by the WFT-E4A, but larger hard drives will require their own independent power supply. Set-up for external storage is fairly straightforward using the EOS 5D Mark II's LCD menu screens, but there are a few rules to follow:—http://www.usa.canon.com/dlc/controller?act=GetArticleAct&articleID=2186 The nine shooter bracket may also be used to mount two dslrs, either upon, or not upon, a tripod. In order to mount them on a tripod, the S configuration of the 1 bracket would be used. Such a mounting could be used to provide for two different scene captures and depths of fields. If the bottom DSLR is rotated facing out away from the bracket so as to fit, with the top one being rotated in the same direction, a monitor can be attached to the bottom dslr and the monitor can be positioned next to the top dslr, with perhaps another 9 shooter bracket. If the bottom DSLR is rotated facing out away from the bracket so as to fit in the above S configuration, with the top one being rotated in the same direction, a monitor can be attached to the bottom dslr and the monitor can be positioned next to the top dslr, with perhaps another 9 shooter bracket. If a tripod or monopod should ever get in the way of the screen on the lower dslr, then a monitor can be used, preferably mounted close to the monitor of the above dslr. Perhaps this will even be better, as the monitor will be closer to the screen of the above dslr—perhaps two monitors could be used, right next to one another even. Additional components which may be added so as to alter orientations of mounted devices. The Nine Shooter can be adjusted easily and added onto with more brackets—both angled and straight. This is another advantage it has over the prior art, with various holes available for many different entities, devices, shoes, mounts, brackets, and extensions. MORE ADVANTAGES OVER PRIOR ART: “The J-CUBE is perfect for the visual journalist that has an DSLR or compact video camera. Designed for any camera with or without a mic clamp, such as the 5D MkII, ID MkIV, 7D, Rebel T1i, Rebel XSi, Nikon D300, D3S, or D90, Canon GL1 or GL2, Sony FX1 or VX2100. The J-CUBE mounts to the shoe mount and gives 3 mounting locations for a microphone (in a shock mount), radio receiver, audio recorder, light, field monitor, or hard disc recorder. “Each J-CUBE is $80 http://web.me.com/jeffyr/Jrod/The_J-CUBE.html The 9 Shooter is superior to the J-Cube in that it can easily and naturally afford more devices, mounting types, angling of brackets, and it can be mounted both below and above the camera, as well as used in conjunction with a tripod running threaded through the nine shooter below the camera, so that the camera still has its flash bracket free for a flash or another device or another nine shooter bracket. The 9 shooter can be mounted both above and below the camera and it more easily allows tripod screw mounts. The 9 shooter can be split into two, with half being mounted above the camera and the other half being mounted below the camera. These pictures were taken during the Jul. 5, 2010 high surf advisory on leo carillo beach. note the extra hole above where additional mounts and devices could be added, including flash shoes, tripod screw mounts, mics, lights, audio recorders, radio receivers/senders, flashes, hard drives, and more. THE NINE SHOOTER DERIVES ITS NAME FROM IT'S ABILITY TO EASILY MOUNT DEVICES IN NINE+ WAYS. There is no reason that mounts/devices cannot be mounted on both sides of the holes, wuch as the case with device/mount 1 & 2 below and 7 & 8. Nstead of holes, the L brackets could be imagined with continuous slots, so that even more devices/mounts could be attached, with continuosly-variable spacing. The below bracket could be easily moved below the DSLR or rotated as a C bracket or s bracket as shown above. The device/mounts could include: hotshoe mounts, pro-screw mounts, cold shoe mounts, flash mounts, microphone mounts ¼″-20 screw mounts, screw mounts of various sizes, tripod mounts, ball and socket mounts, light monitor mounts, and more. The following S bracket attached to a monopod, which could also have been attached to a tripod, as the monopod and tripod heads are similar, was used to photograph and video surfers in May 2010 in California, on a high surf Sunday. Canon HV20, HV30 & HV40 User Forum>Popular HD Camcorders>DSLR and Still Cameras Should I buy an hd video camcorder and DSLR, or just a DSLR with video? User Name Remember Me? Password Register Blogs Blogs Recent Entries Best Entries Best Blogs Blog List Search Blogs FAQ Members List Calendar Today's Posts Search Search Forums Show Threads Show Posts Tag Search Advanced Search Search Blogs Tag Search Advanced Search Go to Page . . . Thread Tools Display Modes 2009 Nov. 29, 12:45 #1 founding films Junior Member Join Date: November 2009 Posts: 10 Should I buy an hd video camcorder and DSLR, or just a DSLR with video? Should I buy an hd video camcorder and DSLR, or just a DSLR with hd video? My friend is looking into getting into wedding photography/videography sports/events photography/videogrpahy and this will be their present. Can any of the DSLR cameras shoot both stills and video at the same time? Or if one chooses to shoot stills, must one stop shooting hd video? With hd video camcorders available for around $500, I might just buy both an hd video camcorder and a DSLR. Any insights on this? Isn't the hd video camcorder easier to use for video/have better audio controls? Thanks for your feedback! founding films View Public Profile Send a private message to founding films Find More Posts by founding films 2009 Nov. 29, 12:51 #2 CycleWriter Curmudgerator Join Date: March 2008 Location: LaLa Land Posts: 6,683 Quote: Originally Posted by founding films Any insights on this? Please read the FAQ. This forum is filled with info on everything you asked, but we consider ourselves more of a self-service forum than an on-demand help desk. Search is your friend and we prefer you post to an existing related thread rather than start a new one. Welcome to the forum. To all Newbies: Have you read this FAQ before posting? Or watched this short video? If you haven't, then don't complain when 1 close or move your thread. The world is a dangerous place, not because of those who do evil, but because of those who look on and do nothing.—Albert Einstein CycleWriter View Public Profile Send a private message to CycleWriter Find More Posts by CycleWriter 2009 Nov. 29, 13:42 #3 founding films Junior Member Join Date: November 2009 Posts: 10 Which HD Camcorder has the best stills/Which DSLR has the best HD video? I apologize if this has been answered elsewhere, but I could find no consenus after searching. I hope this thread may prove to be a concise place for others to find the answers to these questions in one place. Thanks! Which HD Camcorder has the best stills/Which DSLR has the best HD video? I need to buy one as a present for a potential future pro wedding/sports/events photographer. Thanks a lot! Happy Holidays all! Last edited by founding films; 2009 Nov. 29 at 14:01 . . . founding films View Public Profile Send a private message to founding films Find More Posts by founding films 2009 Nov. 29, 14:29 #4 Bif Join Date: November 2007 Location: San Angelo Tex. Posts: 955 Quote: Originally Posted by founding films Should I buy an hd video camcorder and DSLR, or just a DSLR with hd video? My friend is looking into getting into wedding photography/videography sports/events photography/videogrpahy and this will be their present. Can any of the DSLR cameras shoot both stills and video at the same time? Or if one chooses to shoot stills, must one stop shooting hd video? Any insights on this? My insight comes from “getting into” wedding and events photography starting in the 1960's. Your friend has a very daunting task ahead involving a lot of learning before trying to seriously invest/have someone invest in equipment to “get into” it. Some serious research including following what is being done on these forums and other forums is in order to gain some very basic knowledge. For beginning wedding work I suggest the mpix.com forums where a few knowledgeable people participate in discussions. Your friend will have to “wade through” a bunch of clueless “shuttermoms” to get there. I suggest your friend start out with a DSLR to begin getting the feel of getting control of photography and creating visuals. An HD camcorder can be added when appropriate image making skills have been achieved with the DSLR. The DSLR capable of HD video can be a boon to the well experienced photographer/videographer who understands it supplements but really does not replace the camcorder. Also, one person can not realistically do both video and still imagery at an event. In my time I've photographed a “ton” of weddings and there is no way I could have split myself between still photography and wedding video at the same event. These days, the folks doing quality video at events are using multiple cameras and paying special attention to audio. I think an appropriate gift for your friend would be a good DSLR (and most of them are good). My personal prejudice is that the Canon line is excellent. If your friend understands enough real photography theory to appreciate it, I would recommend the Canon 7D (which also does video but he/she should resist being distracted from learning still photography in the early stages) which gives the photographer phenomenal control over digital imagery. Another excellent “starter” would be the Canon T1i (also does video but that is limited on this model) which comes with a “kit” lens that zooms from usable wide angle to portrait length telephoto. The T1i also affords an amazing degree of image control. My thoughts. May be worth about what you just paid for them. Bif View Public Profile Send a private message to Bif Find More Posts by Bif 2009 Nov. 29, 16:54 #5 zagnut Senior Member Join Date: November 2009 Location: Iowa Posts: 490 I faced the same question a couple of months back. I like to storm chase in the spring and summer. I was thinking of going with the T1i, but faced the same problem. I wouldn't be able to take great pictures of storms if I was recording. My solution was a Rebel XS with 3 lenses, an HF11 and Azden smx-10 mic. All for under $1,500. Sure it's more equipment, but each is doing what it was deigned for and fits in a regular size Tamrac backpack. I purchased the XS new as a kit with a 18-55 mm lens for $450, a new Vivitar 500 mm f/6.3 mirror reflex lens for $180, a refurb'd Canon 55-250 mm IS lens ($200), HF11 was refurb'd (paid $600, BH has them new for $600 and refurb's for $480 now), Azden smx-10 $65. Not being able to shoot 720 @ 24 fps and having 1080 at 20 fps with the T1i was a huge turn off and also a deciding factor. Last edited by zagnut; 2009 Nov. 29 at 17:05. zagnut View Public Profile Send a private message to zagnut Find More Posts by zagnut 2009 Nov. 29, 16:57 #6 -Rogue5- Senior Member Join Date: May 2008 Posts: 449 I just skimmed through this thread, and second Bif's recommendation for the T1i . . . . It's incredibly cheap for what it offers, and while the video mode isn't going to be as user friendly as a camcorder (I'm referring mainly to the fact that doesn't have autofocus while recording), the picture of both stills and video are gonna be pretty awesome and will more than suffice for 99% of home uses. If you want/need autofocus, the GH1's system is pretty robust, however it's at least double the cost of the T1i (and you'd need expensive adapters for using any other lenses.) -Rogue5- -Rogue5- View Public Profile Send a private message to -Rogue5- Find More Posts by -Rogue5- 2009 Nov. 29, 17:38 #7 zagnut Senior Member Join Date: November 2009 Location: Iowa Posts: 490 Quote: Originally Posted by -Rogue5- If you want/need autofocus, the GH1's system is pretty robust, however it's at least double the cost of the T1i (and you'd need expensive adapters for using any other lenses.) -Rogue5- If he's gonna go that route, might as well spend another $400 and get a 7d. Bigger sensor, more resolution/fps options and no lame adapters for lenses. If taking pictures at the same time as shooting video hadn't been so important to me, I would have bought the 7d in a heartbeat. I also forgot to mention earlier that the T1i lacks a mic input, continuous AF mode, and manual aperture control. And full HD at only 20 fps? Canon dropped the ball right there. Last edited by zagnut; 2009 Nov. 29 at 17:53 . . . zagnut View Public Profile Send a private message to zagnut Find More Posts by zagnut 2009 Dec. 1, 11:38 #8 foundingfilms Junior Member Join Date: November 2009 Posts: 10 Quote: Originally Posted by zagnut If he's gonna go that route, might as well spend another $400 and get a 7d. Bigger sensor, more resolution/fps options and no lame adapters for lenses. If taking pictures at the same time as shooting video hadn't been so important to me, I would have bought the 7d in a heartbeat. I also forgot to mention earlier that the T1i lacks a mic input, continuous AF mode, and manual aperture control. And full HD at only 20 fps? Canon dropped the ball right there. Thanks for that everyone! After searching all over I think I may have just found my answer here: What's your take on this? foundingfilms View Public Profile Send a private message to foundingfilms Find More Posts by foundingfilms 2009 Dec. 1, 11:58 #9 Marshallator Senior Member Join Date: November 2007 Location: Right here Posts: 229 Interesting, but what would you gain by shooting the same shot with two cameras at the same angle? Human reason left to itself can neither preserve morals nor give duration to a free government. Noah Webster Marshallator View Public Profile Send a private message to Marshallator Find More Posts by Marshallator 2009 Dec. 1, 11:59 #10 foundingfilms Junior Member Join Date: November 2009 Posts: 10 Quote: Originally Posted by Marshallator Interesting, but what would you gain by shooting the same shot with two cameras at the same angle? Both continuous stills & video? foundingfilms View Public Profile Send a private message to foundingfilms Find More Posts by foundingfilms 2009 Dec. 1, 13:10 #11 Marshallator Senior Member Join Date: November 2007 Location: Right here Posts: 229 My apologies, I just skimmed over the previous posts. It might work for that, though as someone said above stills and videos are both full times jobs, would be pretty hard to do both effectively. Human reason left to itself can neither preserve morals nor give duration to a free government. Noah Webster Marshallator View Public Profile Send a private message to Marshallator Find More Posts by Marshallator 2009 Dec. 1, 16:41 #12 zagnut Senior Member Join Date: November 2009 Location: Iowa Posts: 490 I wouldn't waste money on buying it from them. I can build that with some angle iron, a vise, a drill and pliers. Shouldn't cost more than about $5 from the hardware store. If you want to paint it, add $3 for spray paint. zagnut View Public Profile Send a private message to zagnut Find More Posts by zagnut 2009 Dec. 1, 23:06 #13 foundingfilms Junior Member Join Date: November 2009 Posts: 10 Quote: Originally Posted by zagnut I wouldn't waste money on buying it from them. I can build that with some angle iron, a vise, a drill and pliers. Shouldn't cost more than about $5 from the hardware store. If you want to paint it, add $3 for spray paint. the other day i bought one of those hot-shoe-ball-socket-¼″ mounts for like 48 bucks! haha! ripoff!! didn't see a price on the site: http://dual45dueler.com it depends if you have to buy the vise, drill, and pliers first, and how much your wife will charge you for getting spray paint on the patio . . . mine would charge me a lot—haha. foundingfilms View Public Profile Send a private message to foundingfilms Find More Posts by foundingfilms 2009 Dec. 1, 23:39 #14 zagnut Senior Member Join Date: November 2009 Location: Iowa Posts: 490 Quote: Originally Posted by foundingfilms and how much your wife will charge you for getting spray paint on the patio mine would charge me a lot—haha. Ok, so add another 0.75 cents for some newspaper. Or just steal it off the neighbors porch. Yeah, I didn't see a price on the site either. I did see a lot of advertising for what appears to be their clothing though. Looks like they will sell hats, t-shirts and possibly bikini's. zagnut View Public Profile Send a private message to zagnut Find More Posts by zagnut 2009 Dec. 2, 01:28 #15 Bif Join Date: November 2007 Location: San Angelo, Tex. Posts: 955 Quote: Originally Posted by foundingfilms Both continuous stills & video? Lousy idea. Video and stills are different animals. Video features movement, both of the subjects and if done right—the camcorder. Stills are just that. Slices of imagery frozen in time. At a wedding many stills need to be set up and properly posed. The photographer has to pay attention to and often shape the drape of the wedding dress train. The wedding video will have different requirements often needing to be done from a totally different position. Let me rephrase the “lousy idea” statement. Stupid idea . . . Bif View Public Profile Send a private message to Bif Find More Posts by Bif 2009 Dec. 2, 10:08 #16 foundingfilms Junior Member Join Date: November 2009 Posts: 10 Quote: Originally Posted by Bif Lousy idea. Video and stills are different animals. Video features movement, both of the subjects and if done right—the camcorder. Stills are just that. Slices of imagery frozen in time. At a wedding many stills need to be set up and properly posed. The photographer has to pay attention to and often shape the drape of the wedding dress train. The wedding video will have different requirements often needing to be done from a totally different position. Let me rephrase the “lousy idea” statement. Stupid idea . . . . Yes—it would definitely make more sense to have both a dedicated videographer and photographer at a wedding . . . but too, why not attach an extra hd camera to the photographer's rig? As inexpensive as cameras are these days, it doesn't cost a lot extra to add and leave running, and the upside seems big . . . . Would have to test the ergonomics. foundingfilms View Public Profile Send a private message to foundingfilms Find More Posts by foundingfilms 2009 Dec. 13, 18:32 #17 Dman17 Junior Member Join Date: December 2008 Posts: 8 Here's my 2 cents. If you go with a “all in one”, I would suggest Panasonic GF1 or GH1 because of unlimited recording time. All other DSLR with HD have limited recording times, no good for events. Question, what are you going to do for a backup? I do wedding photography and videography as a paid hobby. I have for video 2 canon HV30 (I prefer the benefits of recording SD or HD on tape. For photography, I use a oldie but goodie Olympus E500 and E300. I feel the back up's are very important for “just in case” situations. I just bought a Panasonic GH1, so I'll sell my Olympus E300 and a Canon HV30. Good luck Future pro: Should I buy an hd video camcorder and DSLR, or just a DSLR with hd video User Name Remember Me? Password Register FAQ Community Calendar Today's Posts Search Notices Welcome to Digital Photography School—You are viewing these forums as a guest which gives you limited access features of the community. Gain free access to all features by registering as a member so you'll be able to post, share photos, ask questions, respond to polls and chat privately to other members. Registration is free and fast and we look forward to getting to know you and help you improve your Digital Photography. Note: this registration is separated to subscribing to our free weekly newsletter. Click Here to Join Our Community Today Community Links Social Groups Search Forums Show Threads Show Posts Tag Search Advanced Search Go to Page . . . Page 1 of 3 1 2 3>Thread Tools Display Modes #1 (permalink) Nov. 29, 2009, 04:56 PM foundingfilms New Member Join Date: November 2009 Posts: 6 http://digital-photography-school.com/forum/earning-photography/89807-future-pro-should-i-buy-hd-video-camcorder-dslr-just-dslr-hd-video.html Future pro: Should I buy an hd video camcorder and DSLR, or just a DSLR with hd video Should I buy an hd video camcorder and DSLR, or just a DSLR with hd video? My friend is looking into getting into wedding photography/videography sports/events photography/videography and this will be their present. Can any of the DSLR cameras shoot both stills and video at the same time? Or if one chooses to shoot stills, must one stop shooting hd video? With hd video camcorders available for around $500, I might just buy both an hd video camcorder and a DSLR. Any insights on this? Isn't the hdvideo camcorder easier to use for video/have better audio controls? Thanks for your feedback! #2 (permalink) Nov. 29, 2009, 06:13 PM candleman Senior Member Join Date: April 2008 Location: Auckland, New Zealand Posts: 4,622 i guess he needs to decide . . . is he a videographer or a photographer . . . ? anyone who's ever done a wedding will say its hard enough keeping up with a camera in hand . . . theres no way you could do both IMHO. (certainly not well at least) and to answer your question . . . to my knowledge current dslr models can only do video OR still . . . not both at the same time. i hope you find what you're after tho', all the best with it i wish my friends were kind enough to buy me expensive stuff flickr FlashPointPhotography My Gear Last edited by candleman; Nov. 29, 2009 at 06:16 PM. #3 (permalink) Nov. 29, 2009, 06:20 PM jdepould Critique Moderator Join Date: July 2007 Location: Syracuse, N.Y. Posts: 4,296 A $500 HD cam (say, Vixia or similar) will get you good results in some situations, but isn't going to have pro-grade audio (no XLR, minimal controls). I don't even like the $5000 V1U, which has better audio, but the IQ isn't as good as something like a 5D2. The trade-off on the VSLRs has a lot to do with lens ergonomics. The lenses aren't designed for video, and as such, make it extremely difficult to do certain things. The thing is, the image quality is so bloody good, it's hard to ignore. The audio controls are decent, or you can just record separate audio. It's just a lot harder to get the same kind of production value out of a video camera, because the sensors are smaller. CPOY this year: First place individual multimedia shot on a 5D2: http://media.cpoy.org/64/multimedia/C64-15-CorbJ-03.mov Second place shot on a regular video camera: http://media.cpoy.org/64/multimedia/C64-15-SimoT-01.mov Huge difference in feel and quality. The second one is arguably the better story (though it's a bit long), but the first one is just so darn pretty. There's supposed to be an announcement about Scarlet tomorrow, which maybe change things a bit. We'll see. JamieDePould.com, Flickr Nikon D300, D700 Nikkor 24-70 mm f/2.8 G, 45 mm f/2.8 Ai-P, 50 mm f/1.8 D, 70-200 f/2.8 VRII, SB-600 Please read the rules before posting a critique thread. Rules here. #4 (permalink) Nov. 30, 2009, 06:00 AM FrankLamont Member Join Date: February 2009 Posts: 418 Whoa, hang on. If there are two people, one can easily do video and the other photography. Ultimately, the DSLR will produce better videos than the video recorder producing better photos. #5 (permalink) Nov. 30, 2009, 09:11 AM fletch Senior Member Join Date: January 2008 Location: Sheffield, England Posts: 2,001 A 5DmkII can shoot stills and video at the same time. Whilst video is recording a press of the shutter records a full resolution still image without interrupting the video. I'm sure it wouldn't be useful in a wedding situation but a useful tool to have. Fletch <<blog>>—flickr Olympus E510—Ok to edit and re-post on DPS only #6 (permalink) Dec. 1, 2009, 07:32 PM foundingfilms New Member Join Date: November 2009 Posts: 6 Quote: Originally Posted by fletch A 5DmkII can shoot stills and video at the same time. Whilst video is recording a press of the shutter records a full resolution still image without interrupting the video. I'm sure it wouldn't be useful in a wedding situation but a useful tool to have. Thanks for that! So if you can shoot one still, can you shoot two, or three in a row? Can you shoot continuously? Or only one every few seconds? Or as fast as you can press the shutter? Seems that if the camera allows you to shoot a still while shooting video, then two ought be ok, so it might could shoot both continuous stills and video? Or not? How long would one have to wait between stills while shooting video? Also somebody just pointed me here: http://45surf.smugmug.com/Other/dslr . . . 93_bkGWP-L.jpg what's your take on this? thanks! #7 (permalink) Dec. 1, 2009, 08:06 PM jdepould Critique Moderator Join Date: July 2007 Location: Syracuse, N.Y. Posts: 4,296 Is that for serious? It looks like a joke. JamieDePould.com, Flickr Nikon D300, D700 Nikkor 24-70 mm f/2.8 G, 45 mm f/2.8 Ai-P, 50 mm f/1.8 D, 70-200 f/2.8 VRII, SB-600 Please read the rules before posting a critique thread. Rules here. #8 (permalink) Dec. 1, 2009, 08:53 PM foundingfilms New Member Join Date: November 2009 Posts: 6 Quote: Originally Posted by jdepould Is that for serious? It looks like a joke. haha yes—it's serious: when by the site: The Dual 45 Dueler™: Best DSLR Camera With HD Video talk about getting autofocus & hd in 24 p on (under) the canon 5d! haha! #9 (permalink) Dec. 2, 2009, 12:56 AM jdepould Critique Moderator Join Date: July 2007 Location: Syracuse, N.Y. Posts: 4,296 Yeah, I mean . . . I can't imagine you'd be able to do either one very well at the same time. JamieDePould.com, Flickr Nikon D300, D700 Nikkor 24-70 mm f/2.8 G, 45 mm f/2.8 Ai-P, 50 mm f/1.8 D, 70-200 f/2.8 VRII, SB-600 Please read the rules before posting a critique thread. Rules here. #10 (permalink) Dec. 2, 2009, 01:49 AM m.c.adams Senior Member Join Date: February 2008 Location: O'Fallon, Mo. Posts: 1,083 I really think that you really wouldn't be able to do both at the same time very well. The angles for the shots for photos would be different than the video. Just my opinion though. M.C.Adams Site: http://www.flickr.com/photos/hdmca Site: http://www.flickr.com/photos/mcadamsphotography/ Site:http://mcadamsphoto.zenfolio.com/ Gear: Canon XT 350D, 50D Welcome to Digital Photography School—You are viewing these forums as a guest which gives you limited access features of the community. Gain free access to all features by registering as a member so you'll be able to post, share photos, ask questions, respond to polls and chat privately to other members. Registration is free and fast and we look forward to getting to know you and help you improve your Digital Photography. Note: this registration is separated to subscribing to our free weekly newsletter. Click Here to Join Our Community Today Community Links Social Groups Search Forums Show Threads Show Posts Tag Search Advanced Search Go to Page . . . Page 2 of 3 <1 2 3> Thread Tools Display Modes #11 (permalink) Dec. 2, 2009, 02:00 PM foundingfilms New Member Join Date: November 2009 Posts: 6 Quote: Originally Posted by m.c.adams I really think that you really wouldn't be able to do both at the same time very well. The angles for the shots for photos would be different than the video. Just my opinion though. Was thinking about it—both stills and video require a steady hand, so that would be cool. Seems the cameras can be angled differently . . . and of course the zooms could be adjusted . . . and one could focus on just video, or just stills for a few moments. And even if you were focusing on stills, keeping the video camera running could rock and result in cool footage . . . when you think about the value of your time and the models'/clients' time . . . or the uniqueness of wedding events/occurrences, and how the winning goal is scored but once, and then how inexpensive the hd cameras are . . . well, could be a lot of upside. Especially for photojournalsists/documentarians who need to capture the moment . . . . Could see it used on red carpets . . . #12 (permalink) Dec. 2, 2009, 04:57 PM jdepould Critique Moderator Join Date: July 2007 Location: Syracuse, N.Y. Posts: 4,296 Quote: Originally Posted by foundingfilms Was thinking about it—both stills and video require a steady hand, so that would be cool. Seems the cameras can be angled differently . . . and of course the zooms could be adjusted . . . and one could focus on just video, or just stills for a few moments. And even if you were focusing on stills, keeping the video camera running could rock and result in cool footage . . . when you think about the value of your time and the models'/clients' time . . . or the uniqueness of wedding events/occurrences, and how the winning goal is scored but once, and then how inexpensive the hd cameras are . . . well, could be a lot of upside. Especially for photojournalsists/documentarians who need to capture the moment . . . . Could see it used on red carpets . . . . You really can't just concentrate on one “for a few moments” then skip to the other. You'll end up doing both poorly. It's hard enough doing both on the same shoot, let alone with the cameras attached to each other. JamieDePould.com, Flickr Nikon D300, D700 Nikkor 24-70 mm f/2.8 G, 45 mm f/2.8 Ai-P, 50 mm f/1.8 D, 70-200 f/2.8 VRII, SB-600 Please read the rules before posting a critique thread. Rules here. #13 (permalink) Dec. 2, 2009, 05:18 PM Sime™ iso 2500|f2.8| 1/125th|fire! Join Date: May 2007 Location: England Posts: 5,334 And, err . . . I have a 5DMk2 with a battery grip and when I pop the 24-70 on it, the combo weighs quite a bit! add an arm and a video camera . . . and that girl in that picture up there, she's got quite the muscly arm after two weddings!! 5DMk2 with a decent external (RODE) mic and a Zacuto to suit your needs . . . . DSLR Rapid Fire|Zacuto Lovely video . . . . Beautiful stills . . . . Sime Sime™ Just a regular guy . . . www|twitter|email #14 (permalink) Dec. 2, 2009, 07:53 PM LoveDSLR Senior Member Join Date: March 2009 Posts: 1,670 I preferred the Redrock for 5D Mk II video. Redrock for video DSLRs #15 (permalink) Dec. 3, 2009, 03:31 PM foundingfilms New Member Join Date: November 2009 Posts: 6 Quote: Originally Posted by jdepould You really can't just concentrate on one “for a few moments” then skip to the other. You'll end up doing both poorly. It's hard enough doing both on the same shoot, let alone with the cameras attached to each other. Well, I'll have to request a free one to test. Along with the model. But it seems that one could focus on the DSLR's stills, while the video was running, just taking some care to move fluidly. Both video/stills require a steady hand . . . #16 (permalink) Dec. 4, 2009, 12:12 AM jdepould Critique Moderator Join Date: July 2007 Location: Syracuse, N.Y. Posts: 4,296 Quote: Originally Posted by foundingfilms But it seems that one could focus on the DSLR's stills, while the video was running, just taking some care to move fluidly. Both video/stills require a steady hand . . . . Hope you're not planning to use the audio from the camcorder. JamieDePould.com, Flickr Nikon D300, D700 Nikkor 24-70 mm f/2.8 G, 45 mm f/2.8 Ai-P, 50 mm f/1.8 D, 70-200 f/2.8 VRII, SB-600 Please read the rules before posting a critique thread. Rules here. #17 (permalink) Dec. 4, 2009, 12:27 AM nathanbarlow Member Join Date: September 2009 Location: Auckland, New Zealand Posts: 206 can i just say that I do get the point of this, but the 5D does HD video too—and it seems you would be buying a HD dSLR and a HD camcorder—LOL Canon D60: 50 mm f/1.8, 28-80 mm f4.5-5.6, Circular Polariser, 8× (3 stop) Neutral Density[/COLOR] This work by Nathan Barlow is licensed under a Creative Commons Attribution-Non-Commercial-No Derivative Works 3.0 New Zealand License. Permission given for DPS users to post modified images. #18 (permalink) Dec. 6, 2009, 03:35 PM foundingfilms New Member Join Date: November 2009 Posts: 6 thanks for all that! what's your guys' take on this: here's an interesting thread on the dual stills/video camera system form those who oft photograph models: ModelMayhem.com—started shooting stills & video simultaneously . . . some pros: “I will have to try this I'm curious of the actual turnout. the perspective of the video might be useful.” “Wow I know I'm about to really get flamed but . . . I think it's a great ideal!! (Hear me out before anyone douses me with gas) My main function is as a photographer. That means my MAIN concern is still images. However, I'm looking for every single value-added step that I can take to gain extra profit with low/no extra effort. If I can add a rig like this to my shoots, I can run video as a secondary option. The video camera isn't important at that point as the stills are what my client's ORIGINALLY came to me for. After the shoot, I'll keep my normal workflow for the images. I'll slice up the video into individual clips, eliminating the 90% of it that shows my feet as I talk to the model, is shaky, etc. I'll take the best of those clips, use something automated like ANIMOTO to make it look “shiny and purty”, and offer that up as an extra service to the client. Every client loves it when I show it big-screen because it makes them look like a “SupaStar” when they put it on FB, MySpace, etc. It cost me nothing but the annual subscription (which I can easily recoup in two or three shoots) and after that, I can even use it to promote the studio and my services as much as I like, for free. We, as photographers, have to see the extra value that we can provide the clients these days. Anyone can take a good picture with today's technology. You have to separate yourself from the crowd by what you can offer . . . . Okay. I'm getting in my Speedos now, preparing for my gasoline bath . . . . EDIT: It's not a good system if you want a linear video of any good length but it's excellent for grabbing clips that can be used elsewhere . . . .” “The more I look at this idea the more I like it. And the dual camera rig is very interesting, also. But how does the union feel about this? You are putting a cameraman out of work. Have you considered wearing one of the cameras on your head like a hat? How might that work?” “I'm going to write a blog message about this convergence. I see a lot of resistance to the idea on this thread and I admit I have been too. But I just shot my first few videos myself and I have to say, it is absolutely compelling. Mixing video/audio/stills together is a bad ass media package for just about any event, depending on the intent of the end product. I see the convergence in technology forcing a convergence in the practitioners of both fields, video and stills. And I think we will see that convergence and I am formally here and now coining the phrase, the emergence of the “event artist”. The event artist captures the event, artistically. Neither a pure artist nor a pure photojournalist, but a mix of both, capturing the event artistically, but with a more compelling spin using the available technological media they have at their disposal. Some day it will be immersive, or 3D or some other as yet undeveloped form. And we will be forced to adapt, or be relegated to the remnant heap of increasingly marginalized old-school players. Its reality, its technology, its progress, and it cannot be avoided.” Here's the thread from last year which started it all: Dec. 1, 2009 07:11 pm http://www.modelmayhem.com/po.php?thread_id=531686 here's my new rig for catching video & stills @ the same time: http://45surf.smugmug.com/Other/dslr-wi . . . 4835_TcH5k http://45surf.smugmug.com/Other/dslr-with-hd-video-dslr-stills/45srf-double-45-dueler-TM/swimsuit/728931993_bkGWP-M.jpg http://45srf.smugmug.com/Other/dslr-with-hd-video-dslr-stills/45srf-double-45-dueler-TM/swimsuit/728920902_QjqT8-M.jpg it rox to catch both video and stills of this: http://45surf.smugmug.com/Other/dslr-with-hd-video-dslr-stills/45srf-double-45-dueler-TM/swimsuit/728934568_JPqeK-L.jpg anyone else shoot video? happy holidays!—http://www.modelmayhem.com/po.php?thread_id=531686&page=2 #19 (permalink) Dec. 7, 2009, 12:30 AM jdepould Critique Moderator Join Date: July 2007 Location: Syracuse, N.Y. Posts: 4,296 I don't think you're going to find many people opposed to mixed media. It's just that if you shoot stills and video simultaneously, with the cameras attached to each other, quality will suffer. JamieDePould.com, Flickr Nikon D300, D700 Nikkor 24-70 mm f/2.8 G, 45 mm f/2.8 Ai-P, 50 mm f/1.8 D, 70-200 f/2.8 VRII, SB-600 Please read the rules before posting a critique thread. Rules here. #20 (permalink) Dec. 7, 2009, 12:44 AM CaptainNH Senior Member Join Date: July 2009 Location: sydney, australia Posts: 840 I agree with Jamie regarding the degradation of quality if you try to shoot both stills and video. The fusion debate comes and goes, most recently at Fusion is Now—Solutions for Photographers which assures me that the future is fusion I keep asking what do you do when the minister says, “you may now kiss the bride”? Shoot video or photo? The video quality out of the 5D2 is great and you'll get far better DoF effects than you'd ever get out of a conventional video. Each to their own. I'm sticking with stills.

Prior Art & More Advantages of the Present Invention

The Device/mounts can be hot-shoe adapters/hot-shoe mounts/cold-shoe mounts/ballhead-socket mounts, or any other mounts, or devices, that can be attached to a hole in the bracket. One can see how even ten or eleven places for mounts or devices are available, if one is to mount on both sides of a hole beside mount 3 and mount 6 above. And too, instead of holes, the brackets could have continuous slots or grooves affording mounts at any point and mounts adjustable in a continuous manner. See the brackets with continuous slots below. The brackets could be endowed with continuous slots on both sides, instead of just one. may be used LineQuantityItem ReferenceShipsUnit price TotalTaxDelete1 Each 91034A100 Black-Oxide Steel Coupling Nut ¼″-20 Thread Size, ⅝″ Length, ½″ Width Your reference today $1.82 each 18.20 2 each 90264A435 Grade 2 Zinc-Plated Steel Coupling Nut ¼″-20 Thread Size, ⅞″ Length, ⅜″ Width Your reference today 0.16 each 1.60 3 pack 95475A542 Zinc-Plated Steel Fully Threaded Stud ¼″-20 Thread, 1″ Length, packs of 100 Your reference today 12.69 pack 12.69 4 packs 92815A115 Black-Oxide Steel Round Knurled Thumb Nut ¼″-20 Thrd Sz, ¾″ Head Dia, 7/32″ O'all Height Your reference today 2.69 pack 13.45 5 packs 91833A134 18-8 Stainless Steel Round Knurled Thumb Nut ¼″-20 Thrd Sz, ¾″ Head Dia, ½″ O'all Height Your reference today 4.20 pack 8.40 6 Need these products sooner? http://www.mcmaster.com/# http://web.me.com/jeffyr/Jrod/The_J-CUBE.html PRIOR ART: THE JROD & J-CUBE: THE NINE SHOOTER & TOTEM POLE MOUNT™ & MICRO MULTI MOUNT™ IS SUPERIOR TO THE J-ROD AND J-CUBE ON MULTIPLE LEVELS INCLUDING THE NUMBER OF DEVICES IT CAN HOLD AS WELL AS ITS FLEXIBILITY AND ITS ABILITY TO BE MOUNTED BOTH ABOVE AND BELOW THE CAMERA WITH FLASH SHOE ADAPTERS AND TRIPOD HEAD ADAPTER MOUNTS, AS WELL AS THE FACT THAT THE 9 SHOOTER HAS A HINGED BRACKET WHICH CAN BE EASILY ROTATED TO SUPPORT ROTATION OF MOUNTED DEVICES, AS WELL AS THE POSSIBILITY OF MOUNTING THEM USING A C BRACKET, U BRACKET, L BRACKET, OR S BRACKET CONFIGURATION. PRIOR ART J CUBE FROM: http://web.me.com/jeffyr/Jrod/The_J-CUBE.html: THE NINE SHOOTER CAN MOUNT SIMILAR DEVICES AND MORE THAN THE J CUBE & J ROD. PRIOR ART: THE JROD & J-CUBE: THE NINE SHOOTER IS SUPERIOR TO THE J-ROD AND J-CUBE AND OTHER FORMS OF PRIOR ART ON MULTIPLE LEVELS INCLUDING THE NUMBER OF DEVICES IT CAN HOLD AS WELL AS ITS FLEXIBILITY AND ITS ABILITY TO BE MOUNTED BOTH ABOVE AND BELOW THE CAMERA WITH FLASH SHOE ADAPTERS AND TRIPOD HEAD ADAPTER MOUNTS AND OTHER MOUNTS, AS WELL AS THE FACT THAT THE 9 SHOOTER HAS A HINGED BRACKET WHICH CAN BE EASILY ROTATED TO SUPPORT RELATIVE ROTATION OF MOUNTED DEVICES, AS WELL AS THE POSSIBILITY OF MOUNTING THEM USING A C BRACKET, U BRACKET, L BRACKET, OR S BRACKET CONFIGURATION. CAMERAS, MICS, LIGHTS, & MONITORS ARE GETTING SMALLER, AS MORE AND MORE PHOTOGRAPHERS COMBINE ALL THESE: THE NINE SHOOTER™ BRACKET SERVES THIS PARADIGM SHIFT. THE TOTEM POLE MOUNT SERVES THIS PARADIGM SHIFT.

### Possible Embodiments of Invention

The following figures detail possible embodiments of the present invention. Many other manifestations of the invention may be imagined and realized, and the following examples in no way limit the scope and reach of various manifestations of the present invention.

### BRIEF DESCRIPTION OF FIGURES

FIG. 1: FIG. 1 shows the present invention in a basic form which connects two cameras (1.1) and (1.7) in such a manner that the cameras can be angled relative to one-another in an adjustable manner. This is known as a simple implementation of the 9shooter bracket system.

FIG. 2: FIG. 2 is similar to FIG. 1, but is drawn in a more two-dimensional, simpler form. FIG. 2 inherits all the functionality of FIG. 1. This is known as a simple implementation of the 9shooter bracket system.

FIG. 3: FIG. 3 expands on the basic concept of the invention presented in FIG. 1 and FIG. 2. A plurality of L brackets (3.3) are combined in a configuration of four L brackets below the camera and four L brackets above the camera. The L brackets inherit the basic structure and functionality from FIG. 1 and FIG. 2.

FIG. 4: FIG. 4 shows how the invention's bracket system (4.2) may be mounted atop a camera or device (4.1) via mounting it on a flash shoe adapter. The bracket system (4.2) could be mounted in a variety of ways including being mounted on a flash shoe adapter or a flash-shoe adapter with a ball and socket swivel mount, so that its angle relative to the camera may be easily adjusted.

FIG. 5: FIG. 5 represents the fundamental invention in a simple manifestation. The invention consist of two L brackets (5.2) and (5.6) with a plurality of holes drilled in them (5.8).

FIG. 6: FIG. 6 depicts various configurations of the brackets comprising this invention. The brackets inherit the qualities and specifications of the brackets in the previous figures in this invention.

FIG. 7: FIG. 7 depicts further various configurations of the brackets comprising this invention. The brackets can be mounted above and below the camera and used with or without tripods or monopods.

FIG. 8: FIG. 8 represents the novel invention of the Totem Pole Mount which was inspired in part by various manifestations of the present invention. Particularly, one may wish to mount a plurality of brackets beneath a camera, but above the tripod or monopod. Thus a longer threaded rod is needed—longer than the one typically provided on the head (8.4) of a tripod or monopod. Thus the present invention provides a longer threaded screw, as well as methods and means for extending the screw even further via coupling nuts (8.1) and thumb screw nuts (8.2) and threaded rods (8.3).

FIG. 9: FIG. 9 represents the novel invention of the Totem Pole Mount which was inspired in part by various manifestations of the present invention.

FIG. 10: FIG. 10 represents a novel mechanism for connecting a plurality of devices in a compact, simple, flexible, customizable manner. This is known as Totem Pole Mounts.

FIG. 11: FIG. 11 illustrates how the 9shooter bracket mounting configuration which is well suited for working with a tripod or monopod (11.1).

FIG. 12: FIG. 12 combines the 9shooter brackets with the totem pole mount. FIG. 12 combines the 9shooter brackets and L-brackets discussed in earlier figures with the totem pole mount configuration discussed in earlier figures.

### FULL DESCRIPTION OF FIGURES

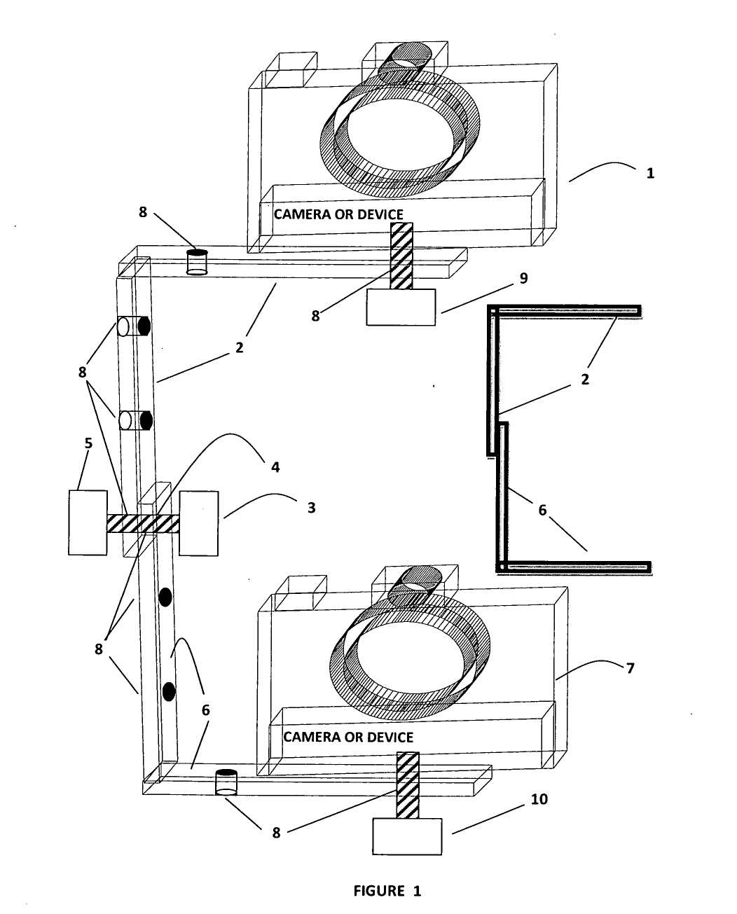

FIG. 1: FIG. 1 shows the present invention in a basic form which connects two cameras (1.1) and (1.7) in such a manner that the cameras can be angled relative to one-another in an adjustable manner. This setup is ideal for shooting stills and video simultaneously, while also adding mics, mount, and other possible devices on the holes drilled in the L brackets (1.2) and (1.6). This is known as a simple 9shooter bracket. A camera or recording or other device (1.1) may be connected to a second camera or recording or other device (1.7). The invention consists of two L brackets (1.2) and (1.6) with a plurality of holes drilled in them (1.8). The L brackets are connected via a threaded screw (1.4) run through holes (1.8) drilled through the L brackets (1.2) and (1.6), and the threaded screw or thumb screw (1.5) and nut or thumb nut (1.3) assembly (1.4), (1.3), and (1.5) serves as a flexible, adjustable hinge, allowing the brackets to be angled relative to one-another. Various devices including but not limited to mics, lights, monitors, flashes, and mounts including flash shoe mounts, flash shoe adapters, ball-socket swivel mounts, and ball-socket flash shoe mounts may be mounted via the holes (1.8) in the L brackets. Instead of holes, continuous slots, or elongated holes may be cut in the side of the L brackets, so as to provide the moving and sliding of various mounts and/or devices. A camera or recording or other device (1.1) may be connected to a second camera or recording or other device (1.7), as both the first device (1.1) and the second device (1.7) are mounted via threaded screws or thumb screws in their respective L brackets that run through holes (1.8) drilled in the brackets. The hinge assembly mechanism consists of a threaded thumbscrew (1.5) and thumb nut (1.3) combination—(1.3), (1.4), and (1.5). Various screws and thumbscrews may be used, and various kinds and sorts of washers may be added so as to provide and enhance both adjustability and stability at said hinge assembly. Neoprene or rubber washers may also be used under the cameras or devices, so as to protect them where they are mounted via thumb screws or thumb nuts (1.9), with the neoprene or rubber or other form of washers sitting between the cameras and the brackets. Many more brackets may be added, and many more relative rotations and constructions may be imagined between assorted brackets.

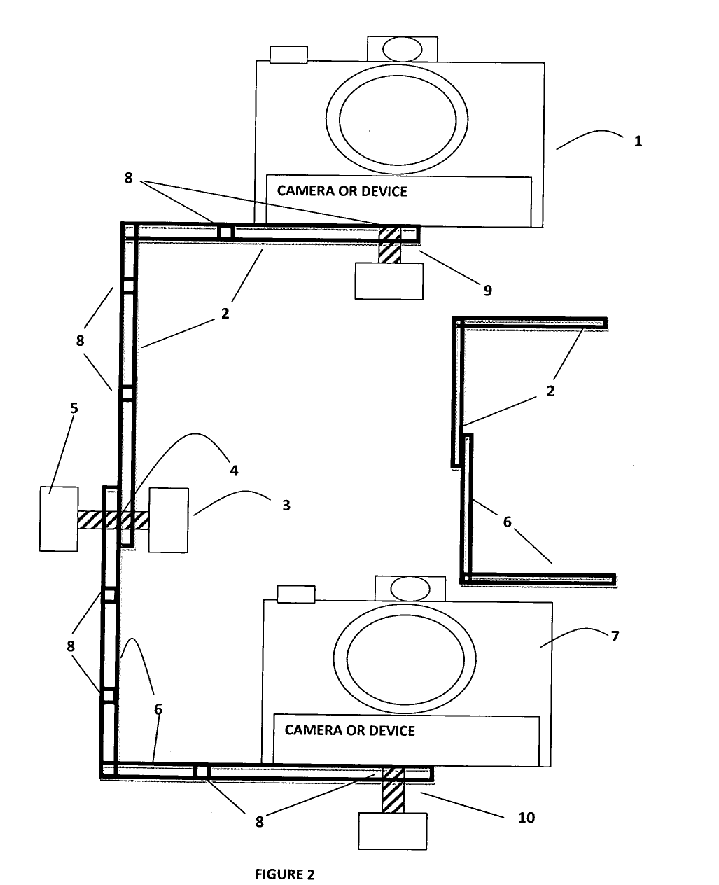

FIG. 2: FIG. 2 is similar to FIG. 1, but is drawn in a more two-dimensional, simpler form. FIG. 2 inherits all the functionality of FIG. 1. A camera or recording or other device (2.1) may be connected to a second camera or recording or other device (2.7). The invention consists of two L brackets (2.2) and (2.6) with a plurality of holes drilled in them (2.8). The L brackets are connected via a threaded screw (2.4) which serves as a flexible, adjustable hinge, allowing the brackets to be angled relative to one-another. Various devices including mics, lights, monitors, flashes, and mounts including flash shoe mounts, flash shoe adapters, ball-socket swivel mounts, and ball-socket flash shoe mounts may be mounted via the holes (2.8) in the L brackets. Instead of holes, continuous slots, or elongated holes may be cut in the side of the L brackets, so as to provide the moving and sliding of various mounts and/or devices. A camera or recording or other device (2.1) may be connected to a second camera or recording or other device (2.7), as both the first device (2.1) and the second device (2.7) are mounted via threaded screws or thumb screws in their respective L brackets that run through holes (2.8) drilled in the brackets. The hinge mechanism consists of a threaded thumbscrew (2.5) and thumb nut (2.3) combination—(2.3), (2.4), and (2.5). Various screws and thumbscrews may be used, and various kinds and sorts of washers may be added so as to provide and enhance both adjustability and stability. Neoprene or rubber washers may also be used under the cameras or devices, so as to protect them where they are mounted, with the neoprene or rubber or other form of washers sitting between the cameras and the brackets. FIG. 2 shows the present invention in a basic form which connects two cameras (2.1) and (2.7) in such a manner that the cameras can be angled relative to one-another in an adjustable manner. In addition to other things, this setup is ideal for shooting stills and video simultaneously, while also adding mics, mount, power supplies, and other possible devices on the holes drilled in the L brackets (2.2) and (2.6). A camera or recording or other device (2.1) may be connected to a second camera or recording or other device (2.7). The invention consists of two L brackets (2.2) and (2.6) with a plurality of holes drilled in them (2.8). The L brackets are connected via a threaded screw (2.4) run through holes (2.8) drilled through the L brackets (2.2) and (2.6), and the threaded screw or thumb screw (2.5) and nut or thumb nut (2.3) assembly (2.4), (2.3), and (2.5) serves as a flexible, adjustable hinge, allowing said L brackets (2.2) and (2.6) to be angled relative to one-another. Various devices including but not limited to mics, lights, monitors, flashes, and mounts including flash shoe mounts, flash shoe adapters, ball-socket swivel mounts, and ball-socket flash shoe mounts may be mounted via the holes (2.8) in the L brackets. Instead of holes, continuous slots, or elongated holes may be cut in the side of the L brackets, so as to provide the moving and sliding of various mounts and/or devices. A camera or recording or other device (2.1) may be connected to a second camera or recording or other device (2.7), as both the first device (2.1) and the second device (2.7) are mounted via threaded screws or thumb screws in their respective L brackets that run through holes (2.8) drilled in the brackets. The hinge assembly mechanism consists of a threaded thumbscrew (2.5) and thumb nut (2.3) combination—(2.3), (2.4), and (2.5). Various screws and thumbscrews may be used, and various kinds and sorts of washers may be added so as to provide and enhance both adjustability and stability at said hinge assembly. Neoprene or rubber washers may also be used under the cameras or devices, so as to protect them where they are mounted via thumb screws or wing screws or other threaded screws (2.9), with the optional neoprene or rubber or other form of washers sitting between the cameras and the brackets. Many more L brackets and straight brackets may be added, and many more relative rotations and constructions may be imagined between assorted brackets and devices. Ballhead mounts mounted upon the L brackets would provide easy mechanisms for rotating devices at relative angles.

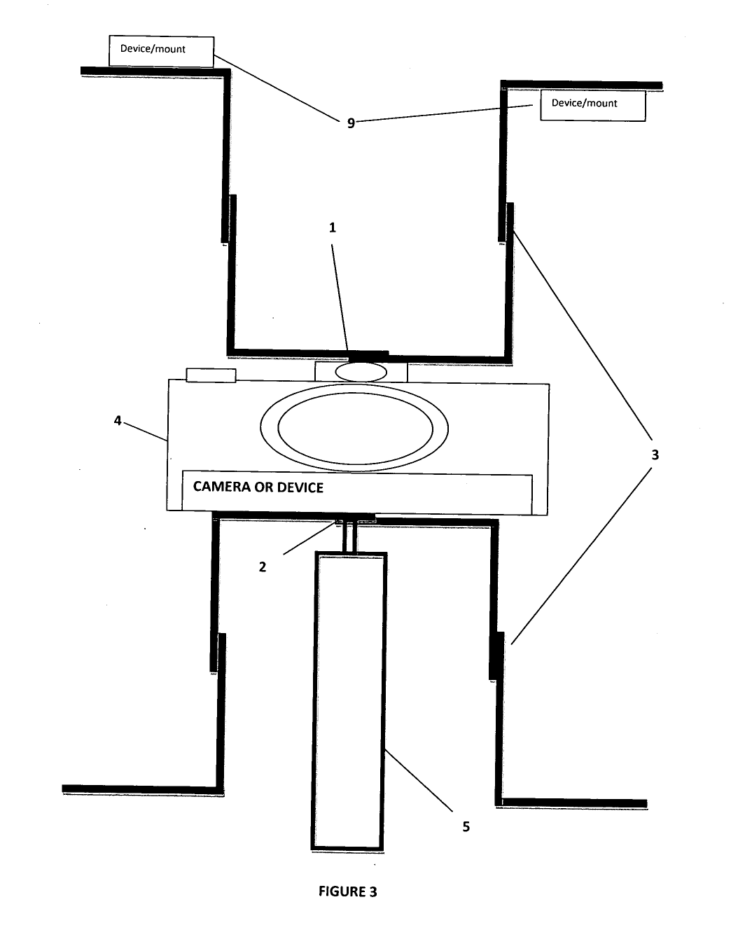

FIG. 3: FIG. 3 expands on the basic concept of the invention presented in FIG. 1 and FIG. 2. A plurality of L brackets (3.3) are combined in a configuration of four L brackets below the camera and four L brackets above the camera. The L brackets inherit the basic structure and functionality from FIG. 1 and FIG. 2. A multitude of devices may be mounted on the L brackets via the holes drilled in them, shown in FIG. 1 and FIG. 2, which the present Figure inherits. The camera or device (3.4) is mounted (3.2) on top of a monopod pole or tripod head (3.5). An off-the-shelf, industry standard quick release mounting system may be employed, or a totem pole mounting system described within this patent application.

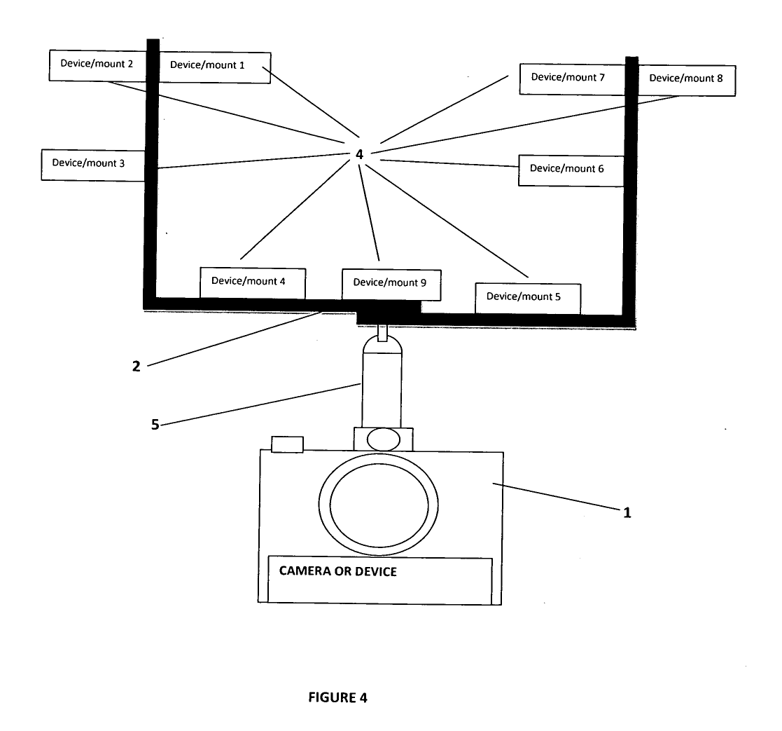

FIG. 4: FIG. 4 shows how the invention's bracket system (4.2) may be mounted atop a camera or device (4.1) via mounting it on a flash shoe adapter. The bracket system (4.2) could be mounted in a variety of ways including being mounted on a flash shoe adapter or a flash-shoe adapter with a ball and socket mount, so that its angle relative to the camera may be easily adjusted. A plurality of devices and/or mounts (4.4) may be mounted upon the bracket system, including but not limited to lights, light panels, mics, flashes, audio mixers, audio receivers, flash shoe mounts, flash shoe adapters, flash shoe ball-socket amounts, flash-shoe mount adapters, mounts using ¼″-20 threaded screws, and other mounts and devices. Furthermore, more L brackets or straight brackets may be added to the pictured brackets, as a hallmark of this invention is its flexibility and customizability. The ongoing miniaturization of equipment suggests the present invention, as photographers and videographers can and need to pack more and more power in smaller and smaller spaces. For instance, because a new DSLR (4.1) also shoots video and records audio, all of a sudden mics, lights, and monitors attached to the camera come in very handy. The present invention offers a simple, novel, and flexible way to serve this need.

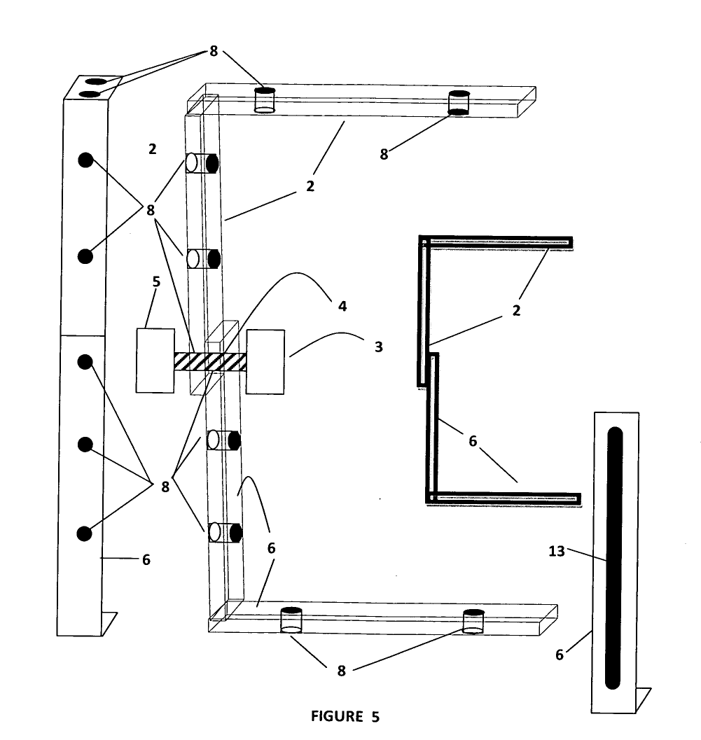

FIG. 5: FIG. 5 represents the fundamental invention in a simple manifestation. The invention consist of two L brackets (5.2) and (5.6) with a plurality of holes drilled in them (5.8). The L brackets are connected via a threaded screw (5.4)/thumb screw (5.5)/thumb nut (5.3) assembly which serves as a flexible, adjustable hinge, allowing the brackets to be angled relative to one-another. Various devices including mics, lights, monitors, flashes, and mounts including flash shoe mounts, flash shoe adapters, ball-socket mounts, and ball-socket flash shoe mounts may be mounted via the holes (5.8) in the L brackets. Instead of holes, continuous slots, or elongated holes may be cut in the side of the L brackets, so as to provide the moving and sliding of various mounts and/or devices. A camera or recording or other device are mounted via threaded screws or thumb screws in their respective L brackets that run through holes (5.8) drilled in the brackets. The hinge mechanism consists of a threaded thumbscrew (5.5) and thumb nut (5.3) combination—(5.3), (5.4), and (5.5). Various screws and thumbscrews may be used, and various kinds and sorts of washers may be added so as to provide and enhance both adjustability and stability. Neoprene or rubber washers may also be used under the cameras or devices, so as to protect them where they are mounted, with the neoprene or rubber or other form of washers sitting between the cameras and the brackets. The brackets may be flipped in different configurations, so as to manifest a U, C, S, or L-shapes configurations shown below and discussed in this patent. Instead of holes (5.8), running slots (5.13) may be cut in the sides of the L brackets (5.2) an (5.6). Slots (5.13) will provide greater flexibility in positioning and mounting devices, as well as positioning and attaching L-brackets.

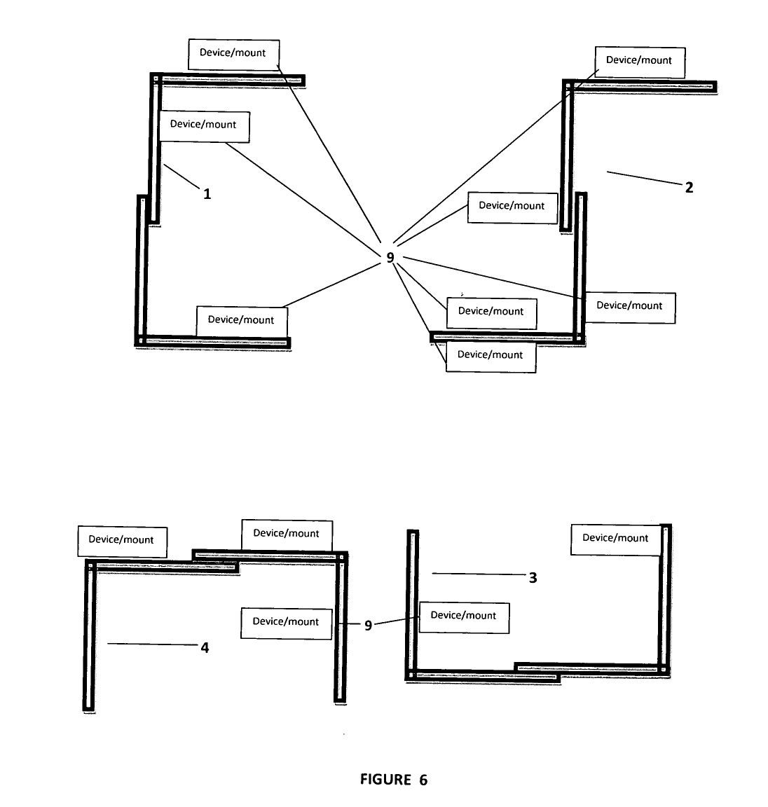

FIG. 6: FIG. 6 depicts various configurations of the brackets comprising this invention. The brackets inherit the qualities and specifications of the brackets in the previous figures in this invention. The brackets can be mounted above and below the camera and used with or without tripods or monopods. Various devices but not limited to including mics, lights, monitors, flashes, and mounts including flash shoe mounts, flash shoe adapters, ball-socket mounts, and ball-socket flash-shoe mounts, and ball-socket mount flash shoe adapters, and flash shoe adapters with ball-socket mounts, and other mounts may be mounted via the holes or slots in the L brackets. The “C” bracket configuration in (6.1) maybe used to attach one camera below another, as well as a plurality of other devices and mounts including mics, lights, audio receivers and more. The “S” bracket configuration in (6.2) may be used with a tripod or monopod, so as to mount two cameras or multiple devices, with one camera below and off to the side of the monopod or tripod head, and the other camera above the monopod or tripod head mount. An industry-standard quick-release mount mechanism may be employed. An ecommerce store may be envisioned where the shopper select from an assortment of L-brackets, ballhead mounts, flash shoe mounts, threaded rods, wing nuts, connecting bolts, connecting bolts with holes tapped in them, flash-shoe ballhead mounts, and said ecommerce store would be an invention in its own right. Mics, lights, and other camera components may all be added. (6.4) represents the upsidedown U configuration which may be mounted under the camera, and (6.3) represents the U configuration, which could be used atop the camera, so as to mount various devices (6.9) on or above the camera.

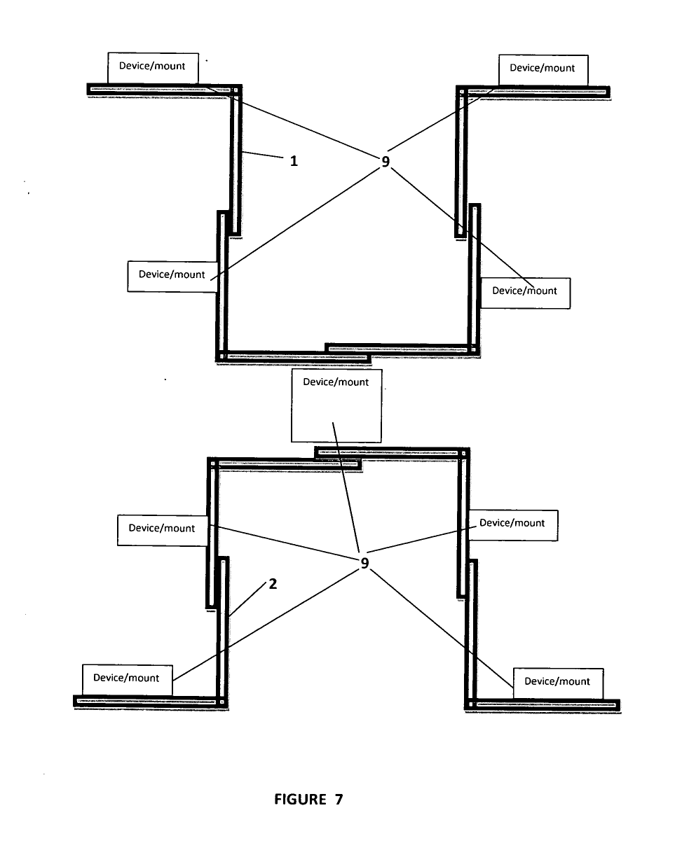

FIG. 7: FIG. 7 depicts further various configurations of the brackets comprising this invention. The brackets can be mounted above and below the camera and used with or without tripods or monopods. These current configurations employ 4 L brackets each, and an ecommerce store may be provided allowing people to buy as many L brackets as they need. Also, brackets, ballhead amounts, threaded screws, and other components may be packaged together in different packages, such as a two L bracket package or a 4-L bracket package, or an 8-L bracket package, say with two flash head mounts, two ballhead flash mounts, four threaded rods, four thumb screws, and four thumb nuts. Or each component could be cold separately. The “Bird” bracket configuration in (7.1) maybe used to attach a plurality of devices and/or mounts (7.9) including mics, lights, audio receivers and more above the camera. The inverted “Bird” bracket configuration in (7.2) may be used with a tripod or monopod, so as to mount two cameras, multiple devices, and/or mounts (7.9) with one camera below the monopod or tripod head, and the other camera above the monopod or tripod head mount. The inverted “Bird” bracket in (7.2) would most typically be mounted below the camera, and this invention also includes novel means for mounting brackets and devices below the camera known as the totem-pole mount. Standard quick-release mounts may be used with these configurations. An ecommerce store may be envisioned where the shopper select from an assortment of L-brackets, ballhead mounts, flash shoe mounts, threaded rods, wing nuts, connecting bolts, quick-release mounts and plates, connecting bolts with holes tapped in them, flash-shoe ballhead mounts, and other components including lights, mics, and hardware; and said novel ecommerce store would be an invention in its own right.

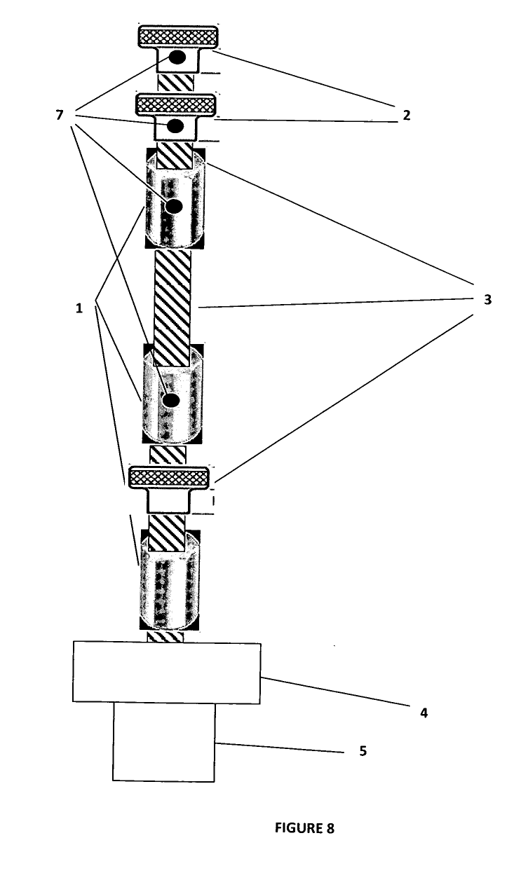

FIG. 8: FIG. 8 represents the novel invention of the Totem Pole Mount which was inspired in part by various manifestations of the present invention. Particularly, one may wish to mount a plurality of brackets beneath a camera, but above the tripod or monopod. Thus a longer threaded rod is needed—longer than the one typically provided on the head (8.4) of a tripod or monopod. Thus the present invention provides a longer threaded screw, as well as methods and means for extending the screw even further via coupling nuts (8.1) and thumb screw nuts (8.2) and threaded rods (8.3). The coupling nuts and thumb nuts and thumb screw nuts (8.1) and (8.2) may have threaded holes drilled in their sides (8.3) to accompany further threaded rods screwed into the thumb nuts and coupling nuts, perpendicular to the main rod. One can imagine selling packages including a set amount and combination of coupling nuts, threaded rods, thumb screws; or, one could imagine an ecommerce store that lets one select from an assortment of coupling nuts, threaded rods, and thumb screw mounts, thusly serving their own particular needs. Instead of mounting the Totem Pole Mount on a tripod or monopod head (8.4), it could be mounted on a hot shoe flash adapter, and then mounted atop a camera or any device with a hot shoe. Instead of mounting the Totem Pole Mount on a tripod or monopod head (8.4), it could be mounted on a ballhead hot shoe flash adapter, and then mounted atop a camera or any device with a hot shoe. Another novel innovation is that threaded holes (8.7) may be drilled in the thumb nuts (8.2), connecting or coupling nuts (8.1), and/or any kind of joining nuts. Further rods may be connected via the said novel holes (8.7) drilled in the sides of various coupling nuts (8.1), allowing the invention to be modified, extended, and customized in a variety of manners. This present innovation, pictured in this figure, may be referred to as a Totem Pole Mount in this patent application and beyond.

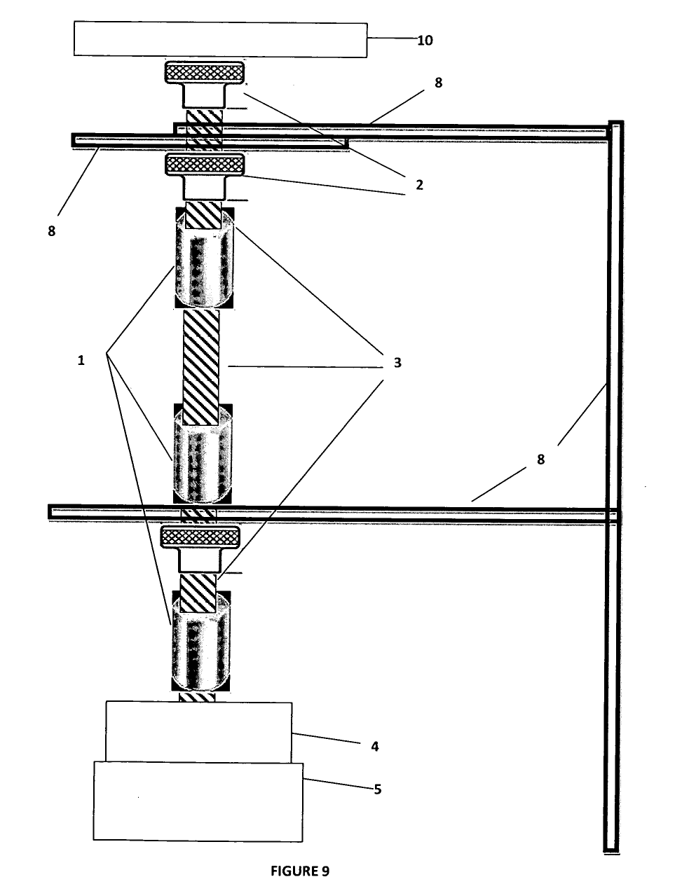

FIG. 9: FIG. 9 represents the novel invention of the Totem Pole Mount which was inspired in part by various manifestations of the present invention. Particularly, one may wish to mount a plurality of brackets beneath a camera, but above the tripod or monopod. Thus a longer threaded rod is needed—longer than the one typically provided on the head (9.4) of a tripod or monopod. Thus the present invention provides a longer threaded screw, as well as methods and means for extending the screw even further via coupling nuts (9.1) and thumb screw nuts (9.2) and threaded rods (9.3). One can imagine selling packages including a set amount and combination of coupling nuts, threaded rods, thumb screws; or, one could imagine an ecommerce store that lets one select from an assortment of coupling nuts, threaded rods, and thumb screw mounts, thusly serving their own particular needs. Instead of mounting the Totem Pole Mount on a tripod or monopod head), it could be mounted on a hot shoe flash adapter (9.4), and then mounted atop a camera or any device with a hot shoe (9.5). Instead of mounting the Totem Pole Mount on a tripod or monopod head (9.5), it could be mounted on a ballhead hot shoe flash adapter, and then mounted atop a camera or any device with a hot shoe. A quick-release camera mount (9.10) may be used above or below the totem pole mount. Various brackets (9.8) and bracket configurations may be used, and the brackets may inherit all of the qualities and functionality of those brackets discussed in this invention, including the L-brackets drawn in earlier figures, as well as straight-brackets which may be added at will. The invention's supreme simplicity is matched by its supreme flexibility. This present innovation, pictured in this figure, may be referred to as a Totem Pole Mount in this patent application and beyond, as it resembles a Totem Pole made famous in Native American history, legend, and folklore. The brackets (9.8) may be like those pictured in FIGS. 1 and 2, or other forms of the 9shooter bracket.

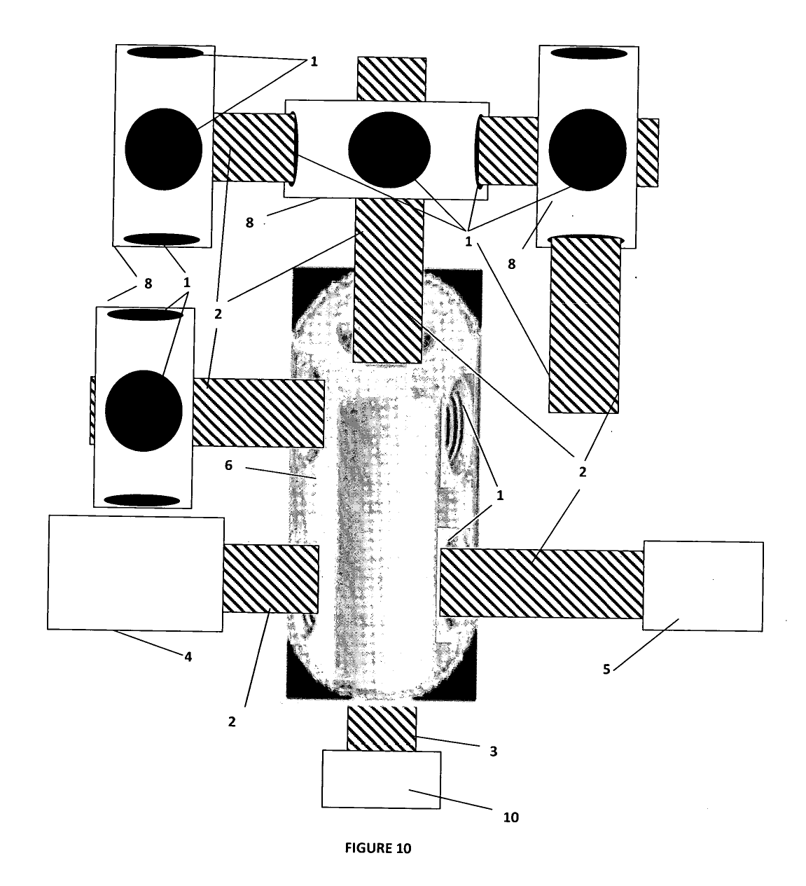

FIG. 10: FIG. 10 represents a novel mechanism for connecting a plurality of devices in a compact, simple, flexible, customizable manner. Threaded holes (10.1) are drilled in the side of a coupling nut (10.6) or thumb nut (10.8) or some other form of connecting nut or nut. Threaded rods (10.2) may be screwed into the said threaded holes (10.1). A device (10.4) or mount such as a flash shoe mount or ball-head flash shoe mount or a device or mount with a ¼″-20 thread mounting hole is mounted on a threaded rod (10.2) that is screwed into a side hole (10.1) in the coupling nut (10.6). A device (10.5) such as a mic, or light, or audio receiver, or other device or mount such as a flash shoe mount or ball-head flash shoe mount or a device or mount with a ¼″-20 thread mounting hole is mounted on a threaded rod (10.1). One can immediately imagine and conceive of a wide plurality of combinations and configurations of the present invention. Imagine the possibilities of the Totem Pole philosophy! The invention takes on a tinker-toys like quality, allowing great flexibility and customizability in small spaces. This present innovation, pictured in this figure, may be referred to as a Totem Pole Mount in this patent application and beyond, as it resembles a Totem Pole made famous in Native American history, legend, and folklore. The mount point at (10.10) could be a tripod head mount, a monopod head mount, a flash shoe mount atop a camera or device, a quick-release mount type, or other type of mount. FIG. 10 also presents a manner, mechanism, and means for elongating the threaded screw found in basic tripod and monopod heads.

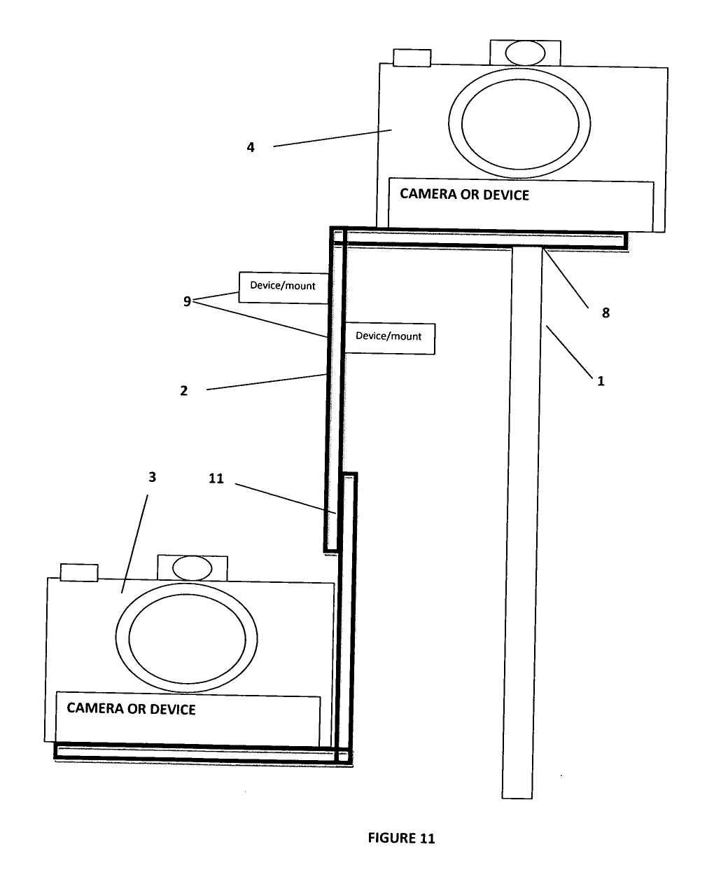

FIG. 11: FIG. 11 illustrates the mounting configuration which is well suited for working with a tripod or monopod (11.1). (11.8) may be a standard quick release mount, or a totem pole mount or mount discussed in FIGS. 9 and 10, or some other form of mount. The two L-brackets (11.2) pictured in FIG. 11 inherit the functionality and qualities of the L brackets shown and discussed in earlier figures, and in this figure, two L brackets are combined to for an S bracket (11.2) with a hinge assembly (4.11) inheriting the qualities of the hinge assemblies in earlier figures. The hinge mechanism (4.11) consists of a threaded thumbscrew (1.5) & (2.5) and thumb nut (1.3) & (2.3) combination—(1.3) & (2.3), (1.4) & (2.4), and (1.5) & (2.5). Various extra mounts and devices (11.9) may be added. The S bracket (11.2) is attached to a monopod or tripod (11.1), as the monopod and tripod heads are similar, and this configuration was used to simultaneously photograph and video surfers in May 2010 in California, during a high-surf Sunday. The simple two-L brackets of the Nine Shooter lend themselves to many variations in mounting, orientation, adjustable, relative rotations, and component hosting/carrying. Also, by using the Dual 45 Dueler/Nine Shooter Bracket as an S-shaped bracket, one can easily mount a second camera below the main camera when using a monopod or tripod, as shown in pictures below. This provides greater stabilization for both the camera and video camera and may be used to shoot distant moving objects such as surfers or athletes, or fashion shows. One could also mount a single L bracket above the camera or below the camera. I use the 9 shooter with a monopod (11.1) with the 9 shooter oriented in the S configuration to shoot surfers. Using a Canon 7D for the top device (11.4) with a zoom and a Canon HFS200 Vixia video camcorder (11.3) zoomed in full on the distant surfer, one can shoot continuous stills of the surfer, and the HFS200 naturally tracks them! In fact, in this case, the Canon 7D DSLR acts as a natural spotting scope for the canon HFS100/HFS 200 which don't have optical viewfinders. so it's actually easier to shoot video! Just think of the Canon 7D & zoom as a $2,000 spotting scope. For your $1,000 HFS 200. Although the Canon 7D (stills) and Vixia HFS200 (video) are used in this example, any cameras or devices me be employed with similar results.

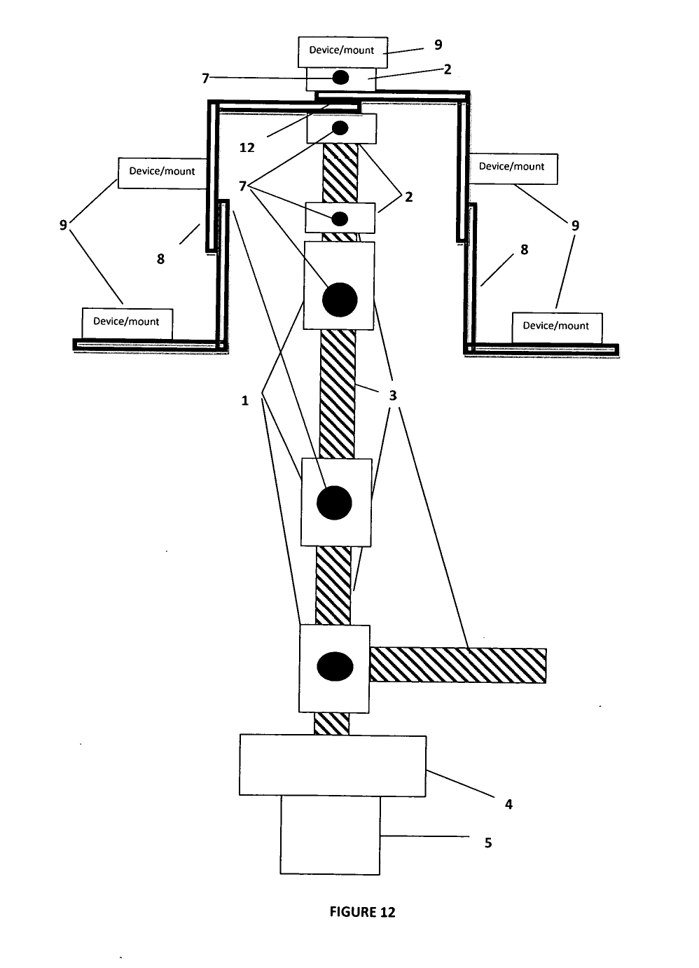

FIG. 12: FIG. 12 combines the 9shooter brackets with the totem pole mount. FIG. 12 combines the 9shooter brackets and L-brackets discussed in earlier figures with the totem pole mount configuration discussed in earlier figures. The brackets and totem pole configurations in FIG. 12 inherit the qualities and functionality of similar apparatuses discussed in earlier figure disclosures. Threaded rods (12.3) are connected by coupling nuts (12.1) and/or connecting nuts (12.1). Threaded holes (12.7) may be drilled in the sides of connecting and coupling nuts (12.7). Adjustable thumb nuts (12.2) can be tightened so as to mount the L bracket configurations (12.8) and 9shooter configurations disclosed and discussed in FIGS. 1-7 (12.8). Various devices and/or mounts (12.9) can be mounted on these L-brackets (12.8). The S-brackets (12.8) have adjustable hinges like those discussed earlier, including in FIG. 1 and FIG. 2, as well as in FIG. 11, thusly allowing for the various devices/mounts (12.9) to be oriented at variable angles relative to one another. Furthermore, the two S brackets (12.8) may be rotated relative to one-another by adjusting their relative angle at their mounting point (12.12). Various devices (12.9) including, but not limited to mics, lights, audio recorders, monitors, power supplies, and more and/or mounts in including hot shoe adapters, hot shoe mounts, hot-shoe ball-socket mounts, and hot-shoe ball-socket adapters (12.9) can be mounted on these S-brackets (12.8). In addition, further L brackets or straight-brackets may also be attached to the S brackets (12.8), and/or Totem-Pole assemblies disclosed in FIGS. 8, 9, and 10 may also be attached to the L-brackets (12.8). (12.4) may be a hot shoe mount or a ballhead flash shoe adapter mount or a tripod head or a quick release mount, or some other sort of mount. (12.5) may be a tripod, monopod, or some other device, such as a camera. The apparatus in FIG. 12 may be mounted above or below a camera. Many more configurations and combinations of the apparatuses and devices disclosed in the above figures may be imagined, all within the scope of this invention.

One could also mount a single L bracket above the camera or below the camera. I use the 9 shooter with a monopod with the 9 shooter oriented in the S configuration to shoot surfers. Using a canon 7d for the top device (11.4) with a zoom and a Canon HFS200 Vixia video camcorder (11.3) zoomed in full on the distant surfer, one can shoot continuous stills of the surfer, and the HFS200 naturally tracks them! in fact, in this case, the canon 7d acts as a natural spotting scope for the canon HFS100/HFS 200 which don't have optical viewfinders. so it's actually easier to shoot video! Just think of the Canon 7D & zoom as a $2,000 spotting scope. For your $1,000 HFS 200. Although the Canon 7d and Vixia HFS200 are used in this example, any cameras or devices me be employed with similar results.

A combination of threaded thumb nuts, coupling nuts, and threaded rods/screws can be used in a basic totem pole mount. Note how numerous metal brackets (or any other materials with appropriate holes) can be mounted on the totem pole screw. The Device/mounts can be hot shoe appters/hot shoe mounts/cold shoe mounts/ballhead-socket mounts, or any other mounts, or devices, that can be attached to a hole in the bracket. One can see how even ten or eleven places for mounts or devices are available, if one is to mount on both sides of a hole beside mount 3 and mount 6 above. And too, instead of holes, the brackets could have continuous slots or grooves affording mounts at any point and mounts adjustable in a continuous manner, via a bracket with continuous slots cut in the sides, as opposed to holes. The brackets could be endowed with continuous slots on both sides, instead of just one. The totem pole mount may be mounted on a tripod, or it may be mounted on a quick-release plate/mount that is mounted on a tripod, and a quick release type mounting bracket may be attached at the very top of the totem pole mount. A combination of threaded thumb nuts, coupling nuts, and threaded rods/screws can be used in a basic totem pole mount. Note how numerous metal brackets (or any other materials with appropriate holes) can be mounted on the totem pole screw. A Newtech quick release clamp (or similar quick release clamp) attached to camera to facilitate quick release from totem pole/nine shooter.

The entire totem pole could consist of but one threaded rod of arbitrary length. In one case the totem pole mount is mounted on a tripod, and a quick release type mounting bracket is attached at the very top of the Totem Pole micro-mini-mount. A combination of threaded thumb nuts, coupling nuts, and threaded rods/screws can be used in a basic totem pole mount. Note how numerous metal brackets (or any other materials with appropriate holes) can be mounted on the totem pole screw. In the above case the totem pole mount is mounted on a tripod, and a quick release type mounting bracket is attached at the very top of the totem pole mount™. A combination of threaded thumb nuts, coupling nuts, and threaded rods/screws can be used in a basic totem pole mount. Note how numerous metal brackets (or any other materials with appropriate holes) can be mounted on the totem pole screw, sandwiched in between entities such as coupling nuts and/or threaded thumb screws.

One can easily imagine multiple combinations of totem pole mounts and metal brackets or “nine shooter brackets.” Totem pole mounts need not be mounted on only tripods, monopods, or camera flash shoes, but they can be mounted on any device which has either a ¼″ hole or a flash shoe type mount or some other sort of standard mount. Thus like the nine shooter, the totem pole mole mount could be mounted on standard camera cages, steadicams, redrock mounts, zacuto, idc photography mounts, follow focus setups, run and gun setups, stabilizers, rigs, dslr rigs video/dslr rigs, and other sorts of cameras/mounts, both those listed above and others not listed. Nine Shooter Brackets could be mounted on Totem Pole mounts and vice-versa, in an infinite assortment of combinations utilizing a varying plurality of components, as needed. In no way is this patent disclosure meant to limit the possibilities for mounting nine shooter brackets and totem pole brackets. In no way are the descriptions and drawings of this invention's disclosure meant to limit the possibilities for mounting nine shooter brackets and totem pole brackets, combining them in assorted manners and in various arrays, attached to different devices, as well as to one-another, in a plurality of manners, with a plurality of components. For instance, one could attach a totem pole mount to a tripod or monopod head, and then attach a couple or more 9 shooter brackets or other type brackets to the totem pole mount. Then, one could attach further totem pole mounts to holes or mount points of the nine shooter rackets or other type of brackets. Then, one could attach various nine shooter or other type brackets to the totem pole mounts, as needed. This could be improvised and expanded on in a multitude of ways, all brought about by the novelty and flexibility of the nineshooter and totem pole mounting systems. Drilling holes in side of hex coupling nut leads to brand new totem pole mount!!!! This patent-pending design of coupling nut with threaded holes in the sides could replace all the coupling nuts in all the above nine shooter and totem pole assembles and diagrams. In the above cases, the COUPLING NUTS COULD ALL BE TOTEM POLE COUPLING NUTS WITH HOLES DRILLED IN THE SIDE MOUNTS. A combination of threaded thumb nuts, coupling nuts, totem pole coupling nuts with holes drilled in the side, and threaded rods/screws can be used in a basic totem pole mount. Note how numerous metal brackets (or any other materials with appropriate holes) can be mounted on the totem pole screw, sandwiched in-between entities such as coupling nuts and/or threaded thumb screws. One can easily imagine multiple combinations of totem pole mounts and metal brackets or “nine shooter brackets.” Totem pole mounts need not be mounted on only tripods, monopods, or camera flash shoes, but they can be mounted on any device which has either a ¼″ hole or a flash shoe type mount or some other sort of standard mount. Thus like the nine shooter, the totem pole mole mount could be mounted on standard camera cages, steadicams, redrock mounts, zacuto, idc photography mounts, run and gun setups, stabilizers, rigs, dslr rigs video/dslr rigs, and other sorts of cameras/mounts, both those listed above and others not listed. Nine Shooter Brackets could be mounted on Totem Pole mounts and vice-versa, in an infinite assortment of combinations utilizing a varying plurality of components, as needed. In no way is this patent disclosure meant to limit the possibilities for mounting nine shooter brackets and totem pole brackets. In no way are the descriptions and drawings of this invention's disclosure meant to limit the possibilities for mounting nine shooter brackets and totem pole brackets, combining them in assorted manners and in various arrays, attached to different devices, as well as to one-another, in a plurality of manners, with a plurality of components. For instance, one could attach a totem pole mount to a tripod or monopod head, and then attach a couple or more 9 shooter brackets or other type brackets to the totem pole mount. Then, one could attach further totem pole mounts to holes or mount points of the nine shooter rackets or other type o brackets. Then, one could attach various nine shooter or other type brackets to the totem pole mounts, as needed. This could be improvised and expanded on in a multitude of ways, all brought about by the novelty and flexibility of the nineshooter and totem pole mounting systems. WE CAN CALL IT MICRO MULTI MOUNTS!!! Micromultimounts.com or totempolemounts.com or micromultimountbrackets.com or nineshootermicromultimounts.com or minimultimounts.com! THE NINE SHOOTER DERIVES ITS NAME FROM IT'S ABILITY TO EASILY MOUNT DEVICES IN NINE+ WAYS. There is no reason that mounts/devices cannot be mounted on both sides of the holes, such as the case with device/mount 1 & 2 below and 7 & 8. Instead of holes, the L brackets could be imagined with continuous slots, so that even more devices/mounts could be attached, with continuously-variable spacing. The below bracket could be easily moved below the DSLR or rotated as a C bracket or s bracket as shown above. The device/mounts could include: hotshoe mounts, pro-screw mounts, cold shoe mounts, flash mounts, microphone mounts ¼″-20 screw mounts, screw mounts of various sizes, tripod mounts, ball and socket mounts, light monitor mounts, and more.

The nine shooter bracket may also be used to mount two dslrs, either upon, or not upon, a tripod. In order to mount them on a tripod, the S configuration of the 1 bracket would be used. Such a mounting could be used to provide for two different scene captures and depths of fields. If the bottom DSLR is rotated facing out away from the bracket so as to fit, with the top one being rotated in the same direction, a monitor can be attached to the bottom dslr and the monitor can be positioned next to the top dslr, with perhaps another 9 shooter bracket. If the bottom DSLR is rotated facing out away from the bracket so as to fit in the above S configuration, with the top one being rotated in the same direction, a monitor can be attached to the bottom dslr and the monitor can be positioned next to the top dslr, with perhaps another 9 shooter bracket. If a tripod or monopod should ever get in the way of the screen on the lower dslr, then a monitor can be used, preferably mounted close to the monitor of the above dslr. Perhaps this will even be better, as the monitor will be closer to the screen of the above dslr—perhaps two monitors could be used, right next to one another even. The nine shooter/9shooter bracket may also be used to mount two dslrs, either upon, or not upon, a tripod. In order to mount them on a tripod, the S configuration of the 1 bracket would be used. Such a mounting could be used to provide for two different scene captures and depths of fields. If the bottom DSLR is rotated facing out away from the bracket so as to fit, with the top one being rotated in the same direction, a monitor can be attached to the bottom dslr and the monitor can be positioned next to the top dslr, with perhaps another 9shooter bracket. This patent-pending design of coupling nut with threaded holes in the sides could replace all the coupling nuts in all the nine shooter and totem pole assembles and diagrams. In the above cases, the COUPLING NUTS COULD ALL BE TOTEM POLE COUPLING NUTS WITH HOLES DRILLED IN THE SIDE MOUNTS. A combination of threaded thumb nuts, coupling nuts, totem pole coupling nuts with holes drilled in the side, and threaded rods/screws can be used in a basic totem pole mount. Note how numerous metal brackets (or any other materials with appropriate holes) can be mounted on the totem pole screw, sandwiched in-between entities such as coupling nuts and/or threaded thumb screws. One can easily imagine multiple combinations of totem pole mounts and metal brackets or “nine shooter brackets.” Totem pole mounts need not be mounted on only tripods, monopods, or camera flash shoes, but they can be mounted on any device which has either a ¼″ hole or a flash shoe type mount or some other sort of standard mount. Thus like the nine shooter, the totem pole mole mount could be mounted on standard camera cages, steadicams, redrock mounts, zacuto, idc photography mounts, run and gun setups, stabilizers, rigs, dslr rigs video/dslr rigs, and other sorts of cameras/mounts, both those listed above and others not listed. Nine Shooter Brackets could be mounted on Totem Pole mounts and vice-versa, in an infinite assortment of combinations utilizing a varying plurality of components, as needed. In no way is this patent disclosure meant to limit the possibilities for mounting nine shooter brackets and totem pole brackets. In no way are the descriptions and drawings of this invention's disclosure meant to limit the possibilities for mounting nine shooter brackets and totem pole brackets, combining them in assorted manners and in various arrays, attached to different devices, as well as to one-another, in a plurality of manners, with a plurality of components. For instance, one could attach a totem pole mount to a tripod or monopod head, and then attach a couple or more 9 shooter brackets or other type brackets to the totem pole mount. Then, one could attach further totem pole mounts to holes or mount points of the nine shooter rackets or other type o brackets. Then, one could attach various nine shooter or other type brackets to the totem pole mounts, as needed. This could be improvised and expanded on in a multitude of ways, all brought about by the novelty and flexibility of the nineshooter and totem pole mounting systems. WE CAN CALL IT MICRO MULTI MOUNTS!!! Micromultimounts.com or totempolemounts.com or micromultimountbrackets.com or nineshootermicromultimounts.com or minimultimounts.com!

THE NINE SHOOTER DERIVES ITS NAME FROM IT'S ABILITY TO EASILY MOUNT DEVICES IN NINE+ WAYS. There is no reason that mounts/devices cannot be mounted on both sides of the holes in the coupling nuts. Instead of holes, the L brackets could be imagined with continuous slots, so that even more devices/mounts could be attached, with continuously-variable spacing. The bracket could be easily moved below the DSLR or rotated as a C bracket or S bracket. The device/mounts could include: hotshoe mounts, pro-screw mounts, cold shoe mounts, flash mounts, microphone mounts ¼″-20 screw mounts, screw mounts of various sizes, tripod mounts, ball and socket mounts, light monitor mounts, and more. In the above case, the entire totem pole could consist of but one threaded rod of arbitrary length. In the above case the totem pole mount is mounted on a tripod, and a quick release type mounting bracket is attached at the very top of the totem pole mount™. A combination of threaded thumb nuts, coupling nuts, and threaded rods/screws can be used in a basic totem pole mount. Note how numerous metal brackets (or any other materials with appropriate holes) can be mounted on the totem pole screw, sandwiched in between entities such as coupling nuts and/or threaded thumb screws.

One can easily imagine multiple combinations of totem pole mounts and metal brackets or “nine shooter brackets.” Totem pole mounts need not be mounted on only tripods, monopods, or camera flash shoes, but they can be mounted on any device which has either a ¼″ hole or a flash shoe type mount or some other sort of standard mount. Thus like the nine shooter, the totem pole mole mount could be mounted on standard camera cages, steadicams, redrock mounts, zacuto, idc photography mounts, run and gun setups, stabilizers, rigs, dslr rigs video/dslr rigs, and other sorts of cameras/mounts, both those listed above and others not listed. Nine Shooter Brackets could be mounted on Totem Pole mounts and vice-versa, in an infinite assortment of combinations utilizing a varying plurality of components, as needed. In no way is this patent disclosure meant to limit the possibilities for mounting nine shooter brackets and totem pole brackets. In no way are the descriptions and drawings of this invention's disclosure meant to limit the possibilities for mounting nine shooter brackets and totem pole brackets, combining them in assorted manners and in various arrays, attached to different devices, as well as to one-another, in a plurality of manners, with a plurality of components. For instance, one could attach a totem pole mount to a tripod or monopod head, and then attach a couple or more 9shooter brackets or other type brackets to the totem pole mount. Then, one could attach further totem pole mounts to holes or mount points of the nine shooter rackets or other type o brackets. Then, one could attach various nine shooter or other type brackets to the totem pole mounts, as needed. This could be improvised and expanded on in a multitude of ways, all brought about by the novelty and flexibility of the nineshooter and totem pole mounting systems. The Device/mounts can be hot shoe appters/hot shoe mounts/cold shoe mounts/ballhead-socket mounts, or any other mounts, or devices, that can be attached to a hole in the bracket. One can see how even ten or eleven places for mounts or devices are available, if one is to mount on both sides of a hole beside mount 3 and mount 6 above. And too, instead of holes, the brackets could have continuous slots or grooves affording mounts at any point and mounts adjustable in a continuous manner. See the brackets with continuous slots below. The brackets could be endowed with continuous slots on both sides, instead of just one.

Further Descriptions and Advantages Over Prior Art:

No longer are photographers only thinking about photography, but today they oft go into shoots armed for high-quality video, audio, continuous lighting, and more. Video and stills cameras, mics, lights, and other common components are all getting smaller and combining more features; while photographers/videographers are acquiring and combining more and more skill sets, including stills photography, video, and sound. The Nine Shooter™ bracket system serves this paradigm shift. The Nine Shooter™ allows one to easily mount multiple combinations of the following in conjunction with a dslr and/or video camera and optional tripod/monopod: External mics Monitors Lights RF transceivers Multiple flashes Audio recorders Multiple cameras The Nine Shooter™ can be used with leading shoulder mounts and cages to provide additional mounting points, flexibility, and a flexible hinge. The nine shooter could be mounted on a z cage and used with the z cage. An advantage the 9 shooter has over the z cage is that it is smaller and more compact. The nine shooter can be used to attach a video camera under a dslr, unlike the z cage. The nine shooter, when used in the s configuration and mounted under a camera on a tripod, allows one to mount components underneath the camera, while using a tripod. The Nine Shooter™ offers unparalleled flexibility and customization for all your multi-mounting needs, in a compact, portable package that is great for travel! The nine shooter could be mounted atop the view factor cage and used alongside the view factor cage or underneath it, or off to the side of it. The nine shooter could be used with the striker and the target shooter. Instead of mounting the nine shooter between the camera and base plate, one could mount the nine shooter under the base plate of the camera. http://store.zacuto.com/107-11-1-12.html The nine shooter could be used with the dslr cinema kits. The nine shooter/totem pole mount could be used with red rock camera gear, mounted above or below it, or in any one of a number of possible mount points: The nine shooter™/totem pole mount™ can grow with your needs, as it can be used alongside/in conjunction with multiple camera mount types and all camera gear. The nine shooter offers a flexible, inexpensive way to mount multiple devices alongside your camera, whether you are shooting stills, video, or both. A combination of threaded thumb nuts, coupling nuts, and threaded rods/screws can be used in a basic totem pole mount. Note how numerous metal brackets (or any other materials with appropriate holes) can be mounted on the totem pole screw. A combination of threaded thumb nuts, coupling nuts, and threaded rods/screws can be used in a basic totem pole mount. Note how numerous metal brackets (or any other materials with appropriate holes) can be mounted on the totem pole screw. A combination of threaded thumb nuts, coupling nuts, and threaded rods/screws can be used in a basic totem pole mount. Note how numerous metal brackets (or any other materials with appropriate holes) can be mounted on the totem pole screw. In this case the totem pole mount is mounted above the camera. A combination of threaded thumb nuts, coupling nuts, and threaded rods/screws can be used in a basic totem pole mount. Note how numerous metal brackets (or any other materials with appropriate holes) can be mounted on the totem pole screw. In the above case the totem pole mount is mounted on a tripod, and a quick release type mounting bracket is attached at the very top of the totem pole mount™. A combination of threaded thumb nuts, coupling nuts, and threaded rods/screws can be used in a basic totem pole mount. Note how numerous metal brackets (or any other materials with appropriate holes) can be mounted on the totem pole screw.

Further Specification and Advantages Over Prior Art:

In the various cases, the entire totem pole could consist of but one threaded rod of arbitrary length. In the above case the totem pole mount is mounted on a tripod, and a quick release type mounting bracket is attached at the very top of the totem pole mount™. A combination of threaded thumb nuts, coupling nuts, and threaded rods/screws can be used in a basic totem pole mount. Note how numerous metal brackets (or any other materials with appropriate holes) can be mounted on the totem pole screw. In the above case, the entire totem pole could consist of but one threaded rod of arbitrary length. In the above case the totem pole mount is mounted on a tripod, and a quick release type mounting bracket is attached at the very top of the totem pole mount™. A combination of threaded thumb nuts, coupling nuts, and threaded rods/screws can be used in a basic totem pole mount. Note how numerous metal brackets (or any other materials with appropriate holes) can be mounted on the totem pole screw, sandwiched in between entities such as coupling nuts and/or threaded thumb screws. One can easily imagine multiple combinations of totem pole mounts and metal brackets or “nine shooter brackets.” Totem pole mounts need not be mounted on only tripods, monopods, or camera flash shoes, but they can be mounted on any device which has either a ¼″ hole or a flash shoe type mount or some other sort of standard mount. Thus like the nine shooter, the totem pole mole mount could be mounted on standard camera cages, steadicams, redrock mounts, zacuto, idc photography mounts, run and gun setups, stabilizers, rigs, dslr rigs video/dslr rigs, and other sorts of cameras/mounts, both those listed above and others not listed. Nine Shooter Brackets could be mounted on Totem Pole mounts and vice-versa, in an infinite assortment of combinations utilizing a varying plurality of components, as needed. In no way is this patent disclosure meant to limit the possibilities for mounting nine shooter brackets and totem pole brackets. In no way are the descriptions and drawings of this invention's disclosure meant to limit the possibilities for mounting nine shooter brackets and totem pole brackets, combining them in assorted manners and in various arrays, attached to different devices, as well as to one-another, in a plurality of manners, with a plurality of components. For instance, one could attach a totem pole mount to a tripod or monopod head, and then attach a couple or more 9 shooter brackets or other type brackets to the totem pole mount. Then, one could attach further totem pole mounts to holes or mount points of the nine shooter rackets or other type o brackets. Then, one could attach various nine shooter or other type brackets to the totem pole mounts, as needed. This could be improvised and expanded on in a multitude of ways, all brought about by the novelty and flexibility of the nineshooter and totem pole mounting systems. The nine shooter could be mounted atop the view factor cage and used alongside the view factor cage or underneath it, or off to the side of it. The nine shooter could be used with the striker and the target shooter. Instead of mounting the nine shooter between the camera and base plate, one could mount the nine shooter under the base plate of the camera. http://store.zacuto.com/107-11-1-12.html The nine shooter could be used with the dslr cinema kits. The present invention, also known as the nine shooter/totem pole mount, could be used with red rock camera gear, mounted above or below it, or in any one of a number of possible mount points: The nine shooter™/totem pole mount™ can grow with your needs, as it can be used alongside/in conjunction with multiple camera mount types and all camera gear. The nine shooter offers a flexible, inexpensive way to mount multiple devices alongside your camera, whether you are shooting stills, video, or both. A combination of threaded thumb nuts, coupling nuts, and threaded rods/screws can be used in a basic totem pole mount. Note how numerous metal brackets (or any other materials with appropriate holes) can be mounted on the totem pole screw. A combination of threaded thumb nuts, coupling nuts, and threaded rods/screws can be used in a basic totem pole mount. Note how numerous metal brackets (or any other materials with appropriate holes) can be mounted on the totem pole screw. A combination of threaded thumb nuts, coupling nuts, and threaded rods/screws can be used in a basic totem pole mount. Note how numerous metal brackets (or any other materials with appropriate holes) can be mounted on the totem pole screw. In this case the totem pole mount is mounted above the camera. A combination of threaded thumb nuts, coupling nuts, and threaded rods/screws can be used in a basic totem pole mount. Note how numerous metal brackets (or any other materials with appropriate holes) can be mounted on the totem pole screw. In the above case the totem pole mount is mounted on a tripod, and a quick release type mounting bracket is attached at the very top of the totem pole mount™. A combination of threaded thumb nuts, coupling nuts, and threaded rods/screws can be used in a basic totem pole mount. Note how numerous metal brackets (or any other materials with appropriate holes) can be mounted on the totem pole screw. In the above and below case, the entire totem pole could consist of but one threaded rod of arbitrary length. In the above case the totem pole mount is mounted on a tripod, and a quick release type mounting bracket is attached at the very top of the totem pole mount™. A combination of threaded thumb nuts, coupling nuts, and threaded rods/screws can be used in a basic totem pole mount. Note how numerous metal brackets (or any other materials with appropriate holes) can be mounted on the totem pole screw. In the above case, the entire totem pole could consist of but one threaded rod of arbitrary length. In the above case the totem pole mount is mounted on a tripod, and a quick release type mounting bracket is attached at the very top of the totem pole mount™. A combination of threaded thumb nuts, coupling nuts, and threaded rods/screws can be used in a basic totem pole mount. Note how numerous metal brackets (or any other materials with appropriate holes) can be mounted on the totem pole screw, sandwiched in between entities such as coupling nuts and/or threaded thumb screws. One can easily imagine multiple combinations of totem pole mounts and metal brackets or “nine shooter brackets.” Totem pole mounts need not be mounted on only tripods, monopods, or camera flash shoes, but they can be mounted on any device which has either a ¼″ hole or a flash shoe type mount or some other sort of standard mount. Thus like the nine shooter, the totem pole mole mount could be mounted on standard camera cages, steadicams, redrock mounts, zacuto, idc photography mounts, run and gun setups, stabilizers, rigs, dslr rigs video/dslr rigs, and other sorts of cameras/mounts, both those listed above and others not listed. Nine Shooter Brackets could be mounted on Totem Pole mounts and vice-versa, in an infinite assortment of combinations utilizing a varying plurality of components, as needed. In no way is this patent disclosure meant to limit the possibilities for mounting nine shooter brackets and totem pole brackets. In no way are the descriptions and drawings of this invention's disclosure meant to limit the possibilities for mounting nine shooter brackets and totem pole brackets, combining them in assorted manners and in various arrays, attached to different devices, as well as to one-another, in a plurality of manners, with a plurality of components. For instance, one could attach a totem pole mount to a tripod or monopod head, and then attach a couple or more 9 shooter brackets or other type brackets to the totem pole mount. Then, one could attach further totem pole mounts to holes or mount points of the nine shooter rackets or other type o brackets. Then, one could attach various nine shooter or other type brackets to the totem pole mounts, as needed. This could be improvised and expanded on in a multitude of ways, all brought about by the novelty and flexibility of the nineshooter and totem pole mounting systems. Select to Business Type Factory Audit Type Markins camera mounting plate 7 Similar Anti-twist flange type mounting plate, compatible with Arca-Swiss type quick release clamps . . . . Min. Order: 10 Pieces DIGITAL DEALER [Trading Company, Distributor/Wholesaler] South Korea Gold Supplier [Verified Member] Offline Markins camera mounting plate P50D 7 Similar Anti-twist flange type mounting plate for Canon 50D camera, compatible with Arca-Swiss type quick release clamps . . . . Min. Order: 10 Pieces DIGITAL DEALER [Trading Company, Distributor/Wholesaler] South Korea Gold Supplier [Verified Member] Offline Markins camera mounting plate P3U 7 Similar Double anti-twist flange type mounting plate for Nikon D3, compatible with Arca-Swiss type quick release clamps . . . . Min. Order: 10 Pieces DIGITAL DEALER [Trading Company, Distributor/Wholesaler] South Korea Gold Supplier [Verified Member] Offline Markins camera mounting plate 7 Similar Anti-twist flange type mounting plate for Nikon D80, compatible with Arca-Swiss type quick release clamps . . . . Min. Order: 10 Pieces DIGITAL DEALER [Trading Company, Distributor/Wholesaler] South Korea Gold Supplier [Verified Member] Offline Markins camera mounting plate 7 Similar Anti-twist flange type bidirectional mounting plate for Canon 40D, 450D compatible with Arca-Swiss type quick release clamps . . . . Min. Order: 10 Pieces DIGITAL DEALER [Trading Company, Distributor/Wholesaler] South Korea Gold Supplier [Verified Member] Offline Markins camera mounting plate P300U 7 Similar Anti-twist flange type mounting plate for Nikon D300, compatible with Arca-Swiss type quick release clamps . . . . Min. Order: 10 Pieces DIGITAL DEALER [Trading Company, Distributor/Wholesaler] South Korea Gold Supplier [Verified Member] Offline Markins camera mounting plate P700U 7 Similar Anti-twist flange type mounting plate for Nikon D700, compatible with Arca-Swiss type quick release clamps . . . . Min. Order: 10 Pieces DIGITAL DEALER [Trading Company, Distributor/Wholesaler] South Korea Gold Supplier [Verified Member] Offline Forums>Photography Talk>extending the ¼″ tripod screw on tripod heads? Search Reply Photographer malibucanyonphotography Posts: 111 Las Flores, Calif., US hello! the typical tripod screw extends ¼″ above the tripod head. this screws into your standard camera. i need it to extend ⅜″ to ½″ so as to mount some brackets under the camera. is there some sort of adapter which screws onto the ¼″ existing screw so as to present a longer thread such as ⅜″ to ½″? thanks so much! was looking at bel air camera & sammy's today but could find nothing. best. May 9, 2010 10:27 pm Link Quote Photographer Mikes Images—Mike #4 Posts: 8,074 Minneapolis, Minn., US ¼″ is the industry standard. If you need it to be longer, you need to find a way to replace the threaded pin that is too short with a longer one. You might need to start with a longer ¼-20 bolt from your local hardware store. A lot will depend on the tripod head you are using. The type of head will determine what you need to do. For starters, remove the (too short), threaded pin you currently have and see if taking a longer bolt to a machine shop could get you what you need. You might find it easier to switch heads. Although your new head likely won't come with a longer pin, you might find one (like a Manfrotto), that utilizes a quick release plate. I think it would be easier to add a longer pin to a quick release plate than to a tripod head. Doing it this way would also leave your head with a normal pin making it more usable for other purposes. If your head has a pin that is too long, you won't be able to simply mount a camera on it, because the pin will bottom out in the camera's tripod socket before it's tight to the tripod head. Modifying your brackets by adding a threaded bolt (to mount your camera), will also work. Good luck. May 9, 2010 11:58 pm Link Quote Photographer PDF IMAGES PHOTOGRAPHY Posts: 2,568 Jacksonville, Fla., US Try local hardware store, like Lowes/Home Depot, they or a tool/die shop can customize it I'm sure, good luck. May 10, 2010 12:04 am Link Quote Photographer ARTOGRAPHI Posts: 435 Burbank, Calif., US PDF IMAGES PHOTOGRAPHY wrote: Try local hardware store, like Lowes/Home Depot, they or a tool/die shop can customize it I'm sure, good luck. If Samy's doesn't have the adapter you need then possibly you might be able to use a ¼-20 coupler with a small piece of ¼-20 all-thread extending out the open end of the coupler to what ever length you need. You might need a Hacksaw to help cut the all-thread to the length you need. (Of course I'd always be leary of ever jury-rigging anything that is totally supporting today's expensive cameras. A decent machine shop would also be able to manufacture a solid adaptor that has a little more strength to it.) May 10, 2010 12:18 am Link Quote Photographer PDF IMAGES PHOTOGRAPHY Posts: 2,568 Jacksonville, Fla., US

ARTOGRAPHI wrote: If Samy's doesn't have the adapter you need then possibly you might be able to use a ¼-20 coupler with a small piece of ¼-20 all-thread extending out the open end of the coupler to what ever length you need. You might need a Hacksaw to help cut the all-thread to the length you need. (Of course I'd always be leary of ever jury-rigging anything that is totally supporting today's expensive cameras. A decent machine shop would also be able to manufacture a solid adaptor that has a little more strength to it.) yep, when I said tool/die shop I meant machine shop . . . ty for that May 10, 2010 12:24 am Link Quote Photographer Leonard Gee Photography Posts: 8,923 Sacramento, Calif., US Find a cheap, used standard camera bracket somewhere. You want one that has a camera locking screw that also has a tripod thread mount on the bottom. Remove it from the bracket and it will be long enough without the thickness of the bracket and you can screw the tripod into the bottom of it. May 10, 2010 12:27 am Link Quote Photographer DMHolman Posts: 1,803 Edmonds, Wash., US What's the bracket you're trying to use? May 10, 2010 12:39 am Link Quote Photographer WMcK Posts: 3,222

Some screws at the bottom of camera cases have longer threads to accommodate the thickness of the case. They usually have threads to allow the camera to be tripod mounted while in the case. One of these may be your answer. You can also get cheap flash brackets with a similar longer screw in them.

May 10, 2010 12:45 am Link Quote Photographer J M PACKARD Posts: 223 Valhalla, N.Y., US Maybe your bracket also has a ¼″-20 thread hole on its under side? Like L-bracket from RRS does . . . May 10, 2010 09:43 am Link Quote Photographer Dream-foto Posts: 1,717 Chico, Calif., US

If you can remove the tripod screw from your head, you can replace it with a longer ¼-20 bolt from the hardware store. May 10, 2010 11:36 am Link Quote Search Reply—http://www.modelmayhem.com/po.php?thread_id=588730&page=1 Ridiculous answers from dpreview: http://forums.dpreview.com/forums/readflat.asp?forum=1018&message=35295711&changemode=1 User: Threaded view Actions: ̂ Forum Forum Open Talk Thread extending the ¼″ tripod screw on tripod heads? (9 messages) Started by motor24 Date/Time 1:57:02 AM, Wednesday, May 12, 2010 (GMT) [SHOW/HIDE] extending the ¼″ tripod screw on tripod heads? [SIMILAR] motor24—3 months ago hello! the typical tripod screw extends ¼″ above the tripod head. this screws into your standard camera. i need it to extend ⅜″ to ½″ so as to mount some brackets under the camera. is there some sort of adapter which screws onto the ¼″ existing screw so as to present a longer thread such as ⅜″ to ½″? thanks so much! was looking at bel air camera & sammy's today but could find nothing. best. [COMPLAIN] [REPLY] [QUOTE] [SHOW/HIDE] Re: extending the ¼″ tripod screw on tripod heads? [SIMILAR] nickoly—3 months ago motor24 wrote: i need it to extend ⅜″ to ½″ so as to mount some brackets under the camera. is there some sort of adapter which screws onto the ¼″ existing screw so as to present a longer thread such as ⅜″ to ½″? That sounds like a physical impossibility—unless the the bracket was specially made or modified for the occasion. You would be better off using a screw more appropriate for the purpose, or having a thread on the bracket. Another solution may be to use a scrap of aluminum box section between the tripod head and the gear. The example below was simply to enable a ¼″ camera onto a ⅜″ tripod and a standard tripod screw was used, but any bolt would have sufficed and there is room for a locknut. Image control:Zoom outZoom 100% Zoom inExpand AllOpen in new window [COMPLAIN] [REPLY] [QUOTE] [SHOW/HIDE] Re: extending the ¼″ tripod screw on tripod heads? [SIMILAR] Brunobl—3 months ago There are screw extenders (male one side, female on the other) that might do what you want. Other than that, you'll find ¼-20 screws with just about any required length at hardware stores.—show signature—[COMPLAIN] [REPLY] [QUOTE] [SHOW/HIDE] Re: extending the ¼″ tripod screw on tripod heads? [SIMILAR] Mike Worley—3 months ago is there some sort of adapter which screws onto the ¼″ existing screw so as to present a longer thread such as ⅜″ to ½″? The “standard” nut is ⅜″ and 16 tpi [threads per inch]. It's a common enough diameter and tpi, but removing it to replace it with something longer can strip the threads of both the tripod plate and the nut. [I've done it.] Easy enough to retap the threads and replace the stripped bolt with something longer, but the ease of ruining two sets of threads suggests the parts were not meant to be separated to begin with. What most people do is screw a ballhead onto the exposed part of the nut, and attach any accessories or brackets to the ballhead. Any number of accessories are designed to fit the Arca type mount [L-brackets for cameras, lens and camera brackets and mounts, etc.] There are adapters to make smaller nuts equal to the standard ⅜″. They're common. They just thread onto the smaller nut. But I don't know of adapters meant to fit over ⅜″ nuts and make them longer. Probably because such an adapter would make the “standard” ⅜″ nut into some non-standard and not very useful diameter. [COMPLAIN] [REPLY] [QUOTE] [SHOW/HIDE] Re: extending the ¼″ tripod screw on tripod heads? [SIMILAR] BIP2007—3 months ago there are adapters available e.g. Manfrotto 088LBP Female ¼″-20 to Male ⅜″ Thread Adapter. available from B&H (http://www.bhphotovideo.com/ . . . /Manfrotto_{—}088LBP_{—}088LBP_Female_{—}1_{—}4_{—}20_to.html). hope that helps [COMPLAIN] [REPLY] [QUOTE] [SHOW/HIDE] Re: extending the ¼″ tripod screw on tripod heads? [SIMILAR] motor24—3 months ago hello!! i think i may have been misunderstood. i do not want to change the thread size nor screw diameter. iw chi to extend the length of the screw that protrudes form the end of the tripod. right now it protrudes by ¼″ or so above the tripod head. I need a screw that protrudes ⅜″ or ½″ so that I can include brackets underneath the camera when i screw it on the tripod head. thanks!! [COMPLAIN] [REPLY] [QUOTE] [SHOW/HIDE] Replace it [SIMILAR] Leonard Migliore—3 months ago motor24 wrote: hello!! i think i may have been misunderstood. i do not want to change the thread size nor screw diameter. iw chi to extend the length of the screw that protrudes form the end of the tripod. right now it protrudes by ¼″ or so above the tripod head. I need a screw that protrudes ⅜″ or ½″ so that I can include brackets underneath the camera when i screw it on the tripod head. thanks!! If I had to do this, I would remove the existing screw and replace it with a longer one. You may have to add washers or something but it can't be that difficult.—show signature—[COMPLAIN] [REPLY] [QUOTE] [SHOW/HIDE] Re: extending the ¼″ tripod screw on tripod heads? [SIMILAR] Leswick—3 months ago I'll send you a sketch. Leswick [COMPLAIN] [REPLY] [QUOTE] [SHOW/HIDE] I did not misunderstand you. [SIMILAR] nickoly—3 months ago Changing the thread size would be absurd, and simply make a bad situation worse. Just change the screw, or use an adapter as described. The latter may be the simplest solution, particularly if your tripod is cursed with a quick release plate, as the original screw is likely to have a head that you are not likely to match in a hardware store. Another option may be to sink a ¼thread into the bracket. Most flash brackets already have one. Those that don't would surely have a bush in the camera mounting screw, and maybe a spare one of those would be your salvation. motor24 wrote: hello!! i think i may have been misunderstood. i do not want to change the thread size nor screw diameter. Further Prior Art and Advantages of the Current Invention http://forums.dpreview.com/forums/readflatasp?forum=1018&message=35295711&changemode=1—http://cheesycam.com/beachtek-for-dslr-video-accessories/writes, Not long after posting about Multiple Mounting brackets you can use to add accessories to your DSLR, I was submitted this neat little mount by olahf. This Beachtek Multimount looks like it adds quite a bit of shoe type mounts which should hold up on Framed cameras such as the 5D Mark II and Canon 7D. Although it's a little too crowded for me personally, I can see this being a cool little bracket add-on for a DSLR cage, Tripod, or even Shoulder Rig. The brackets can be purchased from bhphotovideo, by clicking this link.—http://cheesycam.com/beachtek-for-dslr-video-accessories/ Thanks olahf! Anyone else have anything to share, drop a comment, or use the contact form. dr. elliot Jul. 31, 2010 at 11:11 am you wrote, “Not long after posting about Multiple Mounting brackets you can use to add accessories to your DSLR,” where can i find your earlier post about multiple mounting brackets? thanks!! NO ANSWER AT!!!!—http://cheesycam.com/beachtek-for-dslr-video-accessories/ http://photography-on-the.net/forum/showthread.php?p=10631035 whitesell Member Join Date: February 2009 Location: St. Albert, AB Canada Posts: 100 IMAGE EDITING OK Default Beach Tek MultiMount I've been looking for some way to mount multiple shoe-mounted accessories (mic and litepanel) to my 7D. I just came across this: Beach Tek MultiMount Has anyone tried one, or do you know of a similar device that will allow mounting a couple shoe-mounted accessories? Thanks, Jim Default Re: Beach Tek MultiMount No experience . . . but I think I'd be worried amount the loading on the hot shoe mount Default Re: Beach Tek MultiMount The two things I want to mount on-camera are a Rode Videomic and a LitePanels Pro, both very lightweight. For this use the camera is almost always on a tripod or my igus slider (aka zazaslider) so there won't be much in the way of outside forces stressing the shoe mount like you would have if the camera was on a shoulder-mounted rig or similar . . . . I'm still looking at other options, just not sure which way I want to go. I just picked up a Zoom H4N for sound so may not need to mount the Videomic on the camera after all. Regards, Jim—http://photography-on-the.net/forum/showthread.php?p=10631035 The present invention is superior to the beach tek mount as it allows the mounting of devices both above and below the camera. The present invention is superior to the beach tek mount as it allows the mounting of devices both above and below the camera while being used in a C, U, L, or S configuration. The present invention is superior to the beach tek mount as it allows more space for the mounting of devices both above and below the camera while being used in a C, U, L, or S configuration. The present invention is superior to the beach tek mount as it allows more space for the mounting of devices as well as more flexibility. THE PRESENT INVENTION AKA THE NINE SHOOTER IS SUPERIOR TO THE BEACH TEK 5D MULTI MOUNT AS IT ALLOWS FOR MORE SPACE FOR MOUNTING DEVICES AND CAN BE MOUNTED BELOW THE CAMERA!!! THE NINE SHOOTER ALLOWS FOR MORE FLEXIBILITY AND MORE SPREAD-OUT CONFIGURATIONS WHICH COULD MOUNT MORE DEVICES, SOLVING THE BELOW PROBLEMS FOUND IN THE PRIOR ART DISCUSSED @: http://www.dvinfo.net/forum/canon-eos-5d-mk-ii-hd/200897-beachtek-multimount-5d-thanks-edmond-terakopian.html—http://www.dvinfo.net/forum/canon-eos-5d-mk-ii-hd/200897-beachtek-multimount-5d-thanks-edmond-terakopian.html Chris Hurd Obstreperous Rex Join Date: January 2001 Location: San Marcos, Tex. Posts: 24,090 Images: 513 Beachtek Multimount 5D (thanks Edmond Terakopian) Edmond Terakopian, a DVi member who first told us about the Beachtek DXA-5D XLR adapter, has updated his blog to include another forthcoming Beachtek product, the MiniMount 5D, which provides four accessory shoe mounting points to your D-SLR. Edmond's blog is located at photo this & that: BeachTek Accessories for 5D MkII Attached Thumbnails CH Search DV Info Net for quick answers The best in the business: DV Info Net Sponsors| . . . Tuesday is Soylent Green Day! Apr. 15, 2009, 04:12 PM #2 Glen Elliott Wrangler Join Date: April 2003 Location: Philadelphia, Pa. Posts: 2,750 Cool looking product but worried what accessories do they think we can successfully mount that close to each other?! (THE NINE SHOOTER™/TOTEM POLE MOUNTS™ ALLOW FOR MORE FLEXIBILITY AND MORE SPREAD-OUT CONFIGURATIONS WHICH COULD MOUNT MORE DEVICES) Glen Elliott *Training for the Modem Wedding/Event Videographer* Apr. 15, 2009, 05:21 PM #3 Chris Hurd Obstreperous Rex Join Date: January 2001 Location: San Marcos, Tex. Posts: 24,090 Images: 513 Good question . . . the idea might be to either use just the top center shoe, or just the top left and right shoes . . . not sure that you could fit three things across the top row there. (THE PRESENT INVENTION AKA THE 9SHOOTER OR NINE SHOOTER™ ALLOWS FOR MORE FLEXIBILITY AND MORE SPREAD-OUT CONFIGURATIONS WHICH COULD MOUNT MORE DEVICES THAN THE BEACH TEK 5D MULTIMOUNT) CH Search DV Info Net for quick answers|The best in the business: DV Info Net Sponsors| . . . Tuesday is Soylent Green Day! Apr. 15, 2009, 06:35 PM #4 Min Lee Regular Crew Join Date: September 2005 Location: San Francisco, Calif. Posts: 163 Looks cool. Makes me want to use it as a top handle though, which makes me wonder if it would be safe to mount something so big on the shoe. I'd be a little concern that something might break or bend. Apr. 15, 2009, 08:03 PM #5 Glen Elliott Wrangler Join Date: April 2003 Location: Philadelphia, Pa. Posts: 2,750 I bought a similar product a while back and ran into the issue where the accessories were to large to be mounted next to each other. Regardless it's quite an interesting product, especially from Beachtek. Glen Elliott *Training for the Modern Wedding/Event Videographer* Quick Release: U-Boat Video Rig Product ID: 05-0025K Accepts Camcorder or HDSLR cameras within 5″ tall×6″ wide. Price: $459.00 Ikan k-tek steadicam merlin redrock micro bushhawk vareizoom zacuto tripod heads giottos silk titall gitzo manfrotto sunpack Oconnor Sachtler Vinten AUGUST 3rd for posting dual 45 dueler From: Possible Embodiments and Further Advantages of the Current Invention:

Imagine welding a coupling nut to a hot shoe adapter/flash mount adapter! Or drilling a threaded hole in the side of a coupling nut—so that one could mount a flash shoe adapter mount or another device. A three holed coupling nut or three-way coupling nut!! One could weld a coupling nut onto a coupling nut to achieve a three-holed or three way or t coupling nut. Is the hole in the side of your coupling nut a threaded hole? Contact Supplier Welcome Dr. Elliot, Sign In (Not you?) Hyperlink reference not valid. Is the hole in the side of your coupling nut a threaded hole? Send a message direct to supplier(s) Required information From: Enter email or Member ID. To: Cixi Nonger Hardware Co., Ltd. Hexagonal Coupling Nut, Bolt, Fastener SIDE HOLES NOT THREADED!!!! Can you make a hex coupling nut for ¼″-20 threads with a threaded hole in the side? Can you make a hex coupling nut for ¼″-20 threads with a threaded ¼″-20 hole in the side? How much would this be for 100 and for 1000? http://www.directindustry.com/prod/hansa-flex-hydraulik/pipe-fitting-14764-253638.html http://img.directindustry.com/images_di/photo-p/pipe-fitting-253638.jpg invention!!! Drill a threaded hole into the side of a hex nut! Drilling holes in side of hex coupling nut leads to brand new totem pole mount!!!! THE TOTEM POLE COUPLING NUT MOUNT! OR THE NINE SHOOTER COUPLING NUT! This patent-pending design of coupling nut with threaded holes in the sides could replace all the coupling nuts in all of this present invention's nine shooter and totem pole assembles and diagrams. In the above cases, the COUPLING NUTS COULD ALL BE TOTEM POLE COUPLING NUTS WITH HOLES DRILLED IN THE SIDE MOUNTS. A combination of threaded thumb nuts, coupling nuts, totem pole coupling nuts with holes drilled in the side, and threaded rods/screws can be used in a basic totem pole mount. Note how numerous metal brackets (or any other materials with appropriate holes) can be mounted on the totem pole screw, sandwiched in-between entities such as coupling nuts and/or threaded thumb screws. One can easily imagine multiple combinations of totem pole mounts and metal brackets or “nine shooter brackets.” Totem pole mounts need not be mounted on only tripods, monopods, or camera flash shoes, but they can be mounted on any device which has either a ¼″ hole or a flash shoe type mount or some other sort of standard mount. Thus like the nine shooter, the totem pole mole mount could be mounted on standard camera cages, steadicams, redrock mounts, zacuto, idc photography mounts, run and gun setups, stabilizers, rigs, dslr rigs video/dslr rigs, and other sorts of cameras/mounts, both those listed above and others not listed. Nine Shooter Brackets could be mounted on Totem Pole mounts and vice-versa, in an infinite assortment of combinations utilizing a varying plurality of components, as needed. A Tinker-Toys paradigm could be established. A store could be set up wherein one could selected angled L brackets, flash shoe mounts, threaded rods, wing nuts, thumb nuts, thumb screws, connecting nuts, coupling nuts with threaded holes tapped in their sides, coupling nuts, and more.

In no way is this patent disclosure meant to limit the possibilities for mounting nine shooter brackets and totem pole brackets. In no way are the descriptions and drawings of this invention's disclosure meant to limit the possibilities for mounting nine shooter brackets and totem pole brackets, combining them in assorted manners and in various arrays, attached to different devices, as well as to one-another, in a plurality of manners, with a plurality of components, and a plurality of end results.

For instance, one could attach a totem pole mount to a tripod or monopod head, and then attach a couple or more 9 shooter brackets or other type brackets to the totem pole mount. Then, one could attach further totem pole mounts to holes or mount points of the nine shooter rackets or other type o brackets. Then, one could attach various nine shooter or other type brackets to the totem pole mounts, as needed. This could be improvised and expanded on in a multitude of ways, all brought about by the novelty and flexibility of the nineshooter and totem pole mounting systems. WE CAN CALL IT MICRO MULTI MOUNTS!!! Micromultimounts.com or totempolemounts.com or micromultimountbrackets.com or nineshootermicromultimounts.com or minimultimounts.com! TOTEM POLE MOUNTS WITH STANDARD MOUNTINGS AND BRACKETS!!

I had holes drilled in the hexagonal thumb nuts to give a more tinker-toys-like flexibility and usability for the multi brackets and mini multi brackets. Flash shoe, ⅜″, ¼″ and other mount types may all be easily accommodated.

Note how L brackets underneath a canon 5d dslr camera can be rotated independently and adjusted independently, and the angle of each bottom bracket can be changed by rotating the bottom arm about the joint connecting the upper brackets to the lower brackets, thusly allowing mics and cameras and other devices to be positioned and rotated in optimum manners. The simple totem pole mount underneath the canon 5d could be enhanced with various adjustable thumb nuts and other assorted nuts including round nuts, as well as extended threaded rods, so as to allow for the mounting of multiple brackets, each with their own potential orientation and rotation, each with their won adjustability and tightening nut. A multitude of brackets/threaded rods/nuts/screws could be combined, and in no way is this invention's embodiment meant to limit the multitude of possible embodiment s with tripods/devices/brackets/mounts/rods/threaded rods/nuts.

Mounting the mics/cameras components below the main camera adds more stability. And it saves the camera's hot shoe and leaves it free! Any and every device may be mounted on the totem pole mount and the dual 45 dueler mount and the nine shooter mount. Mounting the mics/cameras components below the main camera adds more stability! And saves the camera's hot shoe! TOTEM POLE MOUNT™ and MICRO MULTI MOUNT™ and MINI MULTI MOUNT™ can be mounted on standard camera hot shoe, or underneath camera via the top ¼″ 20 thread, which would replace the flash bracket mount or ball socket mount above. A very simple totem pole mount could be used to add the brackets below the camera on the tripod head. The totem pole mount is used to extend the ¼″ tripod head screw and also allow for the mounting of the camera. More threaded rods and brackets may be added as illustrated earlier. TOTEM POLE MOUNT™ and MICRO MULTI MOUNT™ and MINI MULTI MOUNT™ can be mounted on standard camera hot shoe, or underneath camera via the top ¼″ 20 thread, which would replace the flash bracket mount or ball socket mount above. Mounting the mics/cameras components below the main camera adds more stability! And it saves the camera's hot shoe! One can easily imagine multiple combinations of totem pole mounts and metal brackets or “nine shooter brackets.” Totem pole mounts need not be mounted on only tripods, monopods, or camera flash shoes, but they can be mounted on any device which has either a ¼″ hole or a flash shoe type mount or some other sort of standard mount. Thus like the nine shooter, the totem pole mole mount could be mounted on standard camera cages, steadicams, redrock mounts, zacuto, idc photography mounts, run and gun setups, stabilizers, rigs, dslr rigs video/dslr rigs, and other sorts of cameras/mounts, both those listed above and others not listed. Nine Shooter Brackets could be mounted on Totem Pole mounts and vice-versa, in an infinite assortment of combinations utilizing a varying plurality of components, as needed. In no way is this patent disclosure meant to limit the possibilities for mounting nine shooter brackets and totem pole brackets. In no way are the descriptions and drawings of this invention's disclosure meant to limit the possibilities for mounting nine shooter brackets and totem pole brackets, combining them in assorted manners and in various arrays, attached to different devices, as well as to one-another, in a plurality of manners, with a plurality of components. For instance, one could attach a totem pole mount to a tripod or monopod head, and then attach a couple or more 9 shooter brackets or other type brackets to the totem pole mount. Then, one could attach further totem pole mounts to holes or mount points of the nine shooter rackets or other type o brackets. Then, one could attach various nine shooter or other type brackets to the totem pole mounts, as needed. This could be improvised on and expanded on in a multitude of ways, all brought about by the novelty and flexibility of the 9shooter and totem pole mounting systems. This could allow for the mounting of a number of devices/mounts requiring their own rotations/orientations.

### A New Philosophy of Individualistic Power and Freedom

jpeg vs. raw, machine-gun shooting, & video: have fun & rock out developing your own style! There is no one right solution in art. But yet, the internet plays home to many people who want you to only shoot photography their way. Many of them tend to be anti-technology, and they do not want you shooting burst sequences, nor using your DSLR to shoot video, nor enjoying the 10 fps capabilities of your camera. They have even gone so far as to rail against the very existence of video on canon and Nikon dslrs, suggesting that nikon and canon ought remove these wonderful features! And then, although famous full-time pro photographers regularly shoot 15-20 frames in burst mode, the internet naysayers insist that if the pros were really all that good, they would only need 2-4 clicks. lol! Well, i say listen to the pros! And rock out with DSLR video—a prevalent theme of this blog. have fun learning from those who are shooting full-time, making money, & covering prestigious events such as the Olympics! http://cpn.canon-europe.com/content/education/technical/shooting_sport. Generally speaking, on a windy day outdoors, machine-gun shooting can come in handy. Especially if the model has long hair and/or is in motion. in a studio setting, machine-gun shooting is not quite so necessary, unless the model is in motion. when one has full control over light and has experience with a given camera, then jpg can be great. When the exposure may be in question, and/or when one is shooting a dark object against a bright background, or vice versa, raw would be the better way to go. raw gives more flexibility in post-processing, so if it's an image you're going to want to photoshop a lot, go with raw! also, many say that ultimately raw can give sharper images, but that would depend on a lot! the general trends are towards 1) less expensive hard drives 2) less expensive CF/SD cards, so the fact that both raw shooting and machine-gun shooting tend to take up a lot of space fast, is becoming less and less a factor. also, jpeg oft works better for machine-gun shooting as it allows for faster/more continuous shots—so if you're shooting a model with long hair on a windy day, continous/jpeg is probably your best bet for catching a usable photo. long story short—shoot both jpegs and raw—shoot both machine-gun style and short bursts! see what works for you and your camera, as the raw vs. jpeg feel varies form camera to camera! keep the options open and use them creatively in the shoot, as needed. and finally, play around with the video on your camera! i recently saw many people in a forum adamantly stating that they wanted canon and nikon to *remove* the video from their dslr cameras, and i don't think they were joking! last night i was reading a magazine and all the up-and-coming pros featured were talking about how they were using the canon 5d to shoot video too—i'll find the article and post some excerpts here. the bottom line—have fun playing around with the video! rock on, have fun, & shoot it all! :) develop your own style. & remember it's not about the camera, nor you even, but the photograph. Hero's Journey Entrepreneurship Principle #51: Play. Carl Jung: The creation of something new is not accomplished by the intellect but by the play instinct acting from inner necessity. The creative mind plays with the objects it loves. Heraclitus: Man is most nearly himself when he achieves the seriousness of a child at play. Michael Jordan: Just play. Have fun. Enjoy the game. George Bernard Shaw: We don't stop playing because we grow old; we grow old because we stop playing. R. P. Feynman: I was in the cafeteria (at Cornell) and some guy, fooling around, throws a plate in the air. As the plate went up in the air I saw it wobble, and I noticed the red medallion of Cornell on the plate going around. It was pretty obvious to me that the medallion went around faster than the wobbling. I had nothing to do, so I start figuring out the motion of the rotating plate. I discovered that when the angle is very slight, the medallion rotates twice as fast as the wobble rate—two to one. It came out of a complicated equation! I went on to work out equations for wobbles. Then I thought about how the electron orbits start to move in relativity. Then there's the Dirac equation in electrodynamics. And then quantum electrodynamics. And before I knew it . . . the whole business that I got the Nobel prize for came from that piddling around with the wobbling plate.—Surely Your Joking, Mr. Feynman Plato: You can discover more about a person in an hour of play than in a year of conversation. Tiger Woods: Don't force your kids into sports. I never was. To this day, my dad has never asked me to go play golf. I ask him. It's the child's desire to play that matters, not the parent's desire to have the child play. Fun. Keep it fun. G K Chesterton: The true object of all human life is play. Earth is a task garden; heaven is a playground. Carl Jung: Without the playing with fantasy, no creative work has ever yet come to birth. The debt we owe to the play of imagination is incalculable. Share/Bookmark jpeg vs. raw, machine-gun shooting, & video: have fun & rock out developing your own style! Posted by 9SHOOTER 45SURF HD video audio stills photography at 1:53 PM 0 comments Email This BlogThis! Share to Twitter Share to Facebook Share to Google Buzz Wednesday, Sep. 8, 2010

### More Advantages of the Present Invention:

The Ultimate One-Man Patent-Pending 9SHOOTER Rig: Increasing Annual Revenue/Money/Cashflow/$$$$ With Audio, Video, and Stills Capability SOME FEEDBACK FOR THE PATENT-PENDING 9SHOOTER™! “I like your red bracket. What brand is that?”—D-Lens “Nice equipment :)”—Wojtek Toman “Wow, that's an insane setup.”—Evan Bey, flickr pro “I love the setup . . . one of the setups I'm looking for . . . cool . . . .” Rushh (Colors of Life) “Nice Idea.”—kaneohe247 flickr pro “I will have to try this I'm curious of the actual turnout. the perspective of the video might be useful.”—lawrence james “I think it's a great idea! My main function is as a photographer. That means my MAIN concern is still images. However, I'm looking for every single value-added step that I can take to gain extra profit with low/no extra effort. If I can add a rig like this to my shoots, I can run video as a secondary option. The video camera isn't important at that point as the stills are what my client's ORIGINALLY came to me for . . . . We, as photographers, have to see the extra value that we can provide the clients these days. Anyone can take a good picture with today's technology. You have to separate yourself from the crowd by what you can offer . . . .”—Mark Ellison “The more I look at this idea the more I like it. And the dual camera rig is very interesting, also. But how does the union feel about this? You are putting a cameraman out of work.”—Amazing Productions “I'm going to write a blog message about this convergence. I see a lot of resistance to the idea on this thread and I admit I have been too. But I just shot my first few videos myself and I have to say, it is absolutely compelling. Mixing video/audio/stills together is a bad ass media package for just about any event, depending on the intent of the end product.”—DarioImpiniPhotography “After the shoot, I'll keep my normal workflow for the images. I'll slice up the video into individual clips, eliminating the 90% of it that shows my feet as I talk to the model, is shaky, etc. I'll take the best of those clips, use something automated like ANIMOTO to make it look “shiny and purty”, and offer that up as an extra service to the client. Every client loves it when I show it big-screen because it makes them look like a “SupaStar” when they put it on FB, MySpace, etc.”—Mark Ellison 45surf bikini model swimsuit model dual 45 dueler 9 shooter nine 659.,.gr.,., dual 45 dueler 9 shooter invention comic con nine shooter photo journalism photo video journalism photo video audio journalism The 9SHOOTER: A compact, flexible, versatile, & SIMPLE mini-multi-mount bracket philosophy for a new era of cameras and shooters. Well, it's tough times for business out there, so we artists and entrepreneurs need every advantage we can get. The 9shooter philosophy is all about improving and expanding one's skills while surfing the technological revolutions to the max. How much money/revenue/cashflow could you add to each shoot by incorporating audio and video? $200? $500? $700+? If you do 30+ shoots a year, this could easily boost your income by $10,000-$20,000 or more, while also expanding your client base! And $10,000 would be more than enough to cover all the pro equipment below, with cash to spare, even if you were starting from scratch! How much value would the ability to capture HD video & HD audio be during a photoshoot for you? For that matter, how much value would it add to be able to capture high-quality stills while recording audio and video? Suppose you mounted an HD video camera under your DSLR and offered your clients—be it a wedding party or newspaper editor—a running, unedited video of everything you shot that day? A few hundred dollars here and there extra on each shoot, and it would all begin to add up! And too, imagine the marketing potential of generating interest amongst local realtors with pictures of your rig, which would allow you to capture both HD video and stills simultaneously of any of their properties. And if you work with an assistant/partner, imagine if you both rocked out with the 9shooter philosophy? Suppose you are a documentarian, photojournalist, or wedding photographer. Suppose you have been called to perform a fashion shoot for a clothing line, and the client just asked if perhaps you could film a video too—some audio and video from the shoot, and some behind-the-scenes video too. Well, in addition to getting a couple extra video cameras and mounting them on tripods, or mounting your backup hd-capable dslr on a tripod—perhaps you could rig up something like the following below with a compact 9shooter multi-mount bracket or two. 45surf bikini model swimsuit model dual 45 dueler 9 shooter nine 498.,,.gr.,.,. 45surf dual 45 dueler 9 shooter invention comic con nine shooter photo journalism photo video journalism photo video audio journalism nine shooter multi mount bracket 45surf. Cameras have gotten smaller and more powerful, and mics and lights have followed suit in becoming miniaturized! Compared to just a couple years ago microphones, wireless receivers, audio recorders and lights have all shrunk immensely, and it's time for a bracketology (bracket philosophy) that capitalizes on these trends, allowing each and every photographer/videographer to pack the maximum amount of power in the minimum amount of space. Or, we could literally spend more on one of the older, bulkier brackets than we do on quality lights/mics/audio recorders combined! (future article on this!) MOUNT THE 9SHOOTER ABOVE OR BELOW THE CAMERA, USE 1-4 BRACKETS OR MORE AS NEEDED, & USE THE 9SHOOTER WITH STEADICAMS, TRIPODS, FLUID-HEADS, AND DSLR/FOLLOW-FOCUS RIGS: Even the below simple 9shooter bracket configuration would allow one to mount a quality microphone/audio recorder/wireless receiver on the 9shooter bracket: swimsuit bikini.DSC_{—}0121 . . . , beautiful 45surf swimsuit model surf cowboy model swimsuit bikini model 097 patent pending dual 45 dueler™ patent pending 9 shooter™ Even if you do work with a partner or two, imagine the revenue increase if all of you rocked out with the 9shooter philosophy! SOME FEEDBACK FOR THE PATENT-PENDING 9SHOOTER! “I like your red bracket. What brand is that?”—D-Lens “Nice equipment :)”—Wojtek Toman “Wow, that's an insane setup.”—Evan Bey, flickr pro “I love the setup . . . one of the setups I'm looking for . . . cool . . . .”—Rushh (Colors of Life) “Nice Idea.”—kaneohe247 flickr pro The 9SHOOTER received the “My Gear & Me” Award from flickr, as well as the “My Gear and Me Premium” award. Check out the 9SHOOTER's unmatched versatility! Suppose you want to . . . . . . add lights and mics to your run & gun rig—9SHOOTER! . . . shoot stills and video simultaneously—9SHOOTER! . . . add an audio recorder under your DSLR—9SHOOTER! . . . add a wireless receiver & lights to your run & gun rig—9SHOOTER! . . . have an extra camera angle throughout the wedding—9SHOOTER! . . . capture stills & video at a red carpet event—9SHOOTER! . . . be able to rotate your video camera relative to the dslr—9SHOOTER! . . . add a shotgun mic while keeping your flash shoe free—9SHOOTER! . . . capture stills and video as a photojournalist—9SHOOTER! Perfect for shooting simultaneous stills & video of surfers and action sports! Share/Bookmark The Ultimate One-Man Patent-Pending 9SHOOTER Rig: Increasing Annual Revenue/Money/Cashflow/$$$$ With Audio, Video, and Stills Capability Posted by 9SHOOTER 45SURF HD video audio stills photography at 12:00 PM 0 comments Email This BlogThis! Share to Twitter Share to Facebook Share to Google Buzz Labels: multimount bracket multi mount increasing revenues augmenting business wedding photography increasing cash flow arts entrepreneurship artists Monday, Sep. 6, 2010 “National Geographic now looks to only hire still photographers who are also video-trained!” Well, you can't ignore National Geographic photographers and editors with over 25-years of career experience! From the luminous landscape website: Chris Sandberg I attended a lecture/slide show/presentation by photographer Sam Abell last week, as part of the National Geographic Live! season in Minneapolis. Mr. Abell has had a 25-year career shooting for National Geographic, and he was asked what an aspiring young photographer who wanted to follow in his footsteps should do, He responded that the National Geographic now looks to only hire still photographers who are also video-trained! His advice was that young photographers should be sure they are versed in both disciplines. So, we may be seeing not only the tip of the iceberg on the technology side, but truly a convergence on the artistic side, as well.—http://www.luminous-landscape.com/essays/convergence.shtml Share/Bookmark “National Geographic now looks to only hire still photographers who are also video-trained!” Posted by 9SHOOTER 45SURF HD video audio stills photography at 12:38 PM 0 comments Email This BlogThis! Share to Twitter Share to Facebook Share to Google Buzz Labels: business photography video hd video entrepreneur stills money revenue art future of photography hd video Great issue of DIGITAL SLR PHOTOGRAPHY magazine from the UK on the stands right now!!! “pros will be eventually expected to deliver web-worthy package of movies and stills.” Great issue of DIGITAL SLR PHOTOGRAPHY magazine from the UK on the stands right now!!! “pros will be eventually expected to deliver web-worthy package of movies and stills.” Check out the very last page where Caroline Wilikinson writes: “. . . . HD video is slowly entering the marketplace as standard in DSLRs and pros will be eventually expected to deliver web-worthy package of movies and stills. There are already examples of where stills and moves have been merged. For instance, have you noticed the moving magazine covers or corporate portraits on website? Video is already starting to take the place of pictures on news provider's websites too. It was always said a picture is worth a thousand words, well now you can get 24 frames-per-second—now that's a lot more words . . . . HD video is set to take over commercial and advertising photography as campaigns turn from print to online. And editorial photography is in question too . . . . People argue that the magazine industry is solid, that most people like the feel of a magazine each month in the hands . . . . But is the apple ipad just a fad or the start of something far more progressive? Photographers will more than likely have to learn how to shoot multimedia, edit video and more importantly come up with creative solutions that blow the amateur out of the water, if they're to continue earning incomes as a full-time pro.”—Caroline Wilikinson, p. 146, Parting Shot, August 2010, Digital SLR Photography, (from the UK) “Photographers will more than likely have to learn how to shoot multimedia, edit video and more importantly come up with creative solutions that blow the amateur out of the water, if they're to continue earning incomes as a full-time pro.”—Digital SLR Photography, (from the UK) I think this is one of those “multimedia creative solutions that blow the amateur out of the water:” http://www.diyphotography net/a-diy-9shooter-shooting-stills-video-simultaneously-audio-too A DIY 9Shooter: Shooting Stills & Video Simultaneously & Audio Too! I DIYPhotography.net Imagine you master this!:) Revenues might not double, but they will increase! Or are we to doubt the experts in the UK published in professional magazines? “Having regular contact with industry leaders, and many of the UK's professionals, has shown me that the goalposts are already starting to shift for full-time pros—and as a result they have to up their game and change strategy . . . pros will be eventually expected to deliver web-worthy package of movies and stills.”—Caroline Wilikinson, p. 146, Parting Shot, August 2010, Digital SLR Photography, (from the UK) Share/Bookmark Great issue of DIGITAL SLR PHOTOGRAPHY magazine from the UK on the stands right now!!! “pros will be eventually expected to deliver web-worthy package of movies and stills.” Posted by 9SHOOTER 45SURF HD video audio stills photography at 12:35 PM 0 comments Email This BlogThis! Share to Twitter Share to Facebook Share to Google Buzz Labels: business photography video hd video entrepreneur stills money revenue art future of photography hd video Home—http://9shooter.blogspot.com and http://blog.9shooter.com—http://www.cinema5d.com/viewtopic.php?f=21&t=19744&st=0&sk=t&sd=a&sid=84baf79263df6b5d886 8c12bf51211f4&start=10 where can i buy these multi-mount bracket 4 audio/lights whi Post a reply 12 posts•Page 2 of 2•1, 2 Re: where can i buy these multi-mount bracket 4 audio/lights whi Post by MJMP on 11 Oct. 2010 18:12 I'm not calling you an idiot but I am calling the product you are obviously promoting ridiculous and I have every right to that opinion. Your post is nothing more than spam. That said, I'm outta here. Michael Canon 5D Mark II Canon 7D Go Pro Hero HD User avatar Posts: 750 Joined: December 2009 *E-mail MJMP Defeats Epic Defeats Epic Top Re: where can i buy these multi-mount bracket 4 audio/lights whi Post by photographyrox on 11 Oct. 2010 18:34 MJMP wrote: I'm not calling you an idiot but I am calling the product you are obviously promoting ridiculous and I have every right to that opinion. Your post is nothing more than spam. That said, I'm outta here. lol! “That said, I'm outta here.” it's funny how people label bold new ideas “spam,” “idiotic,” and “ridiculous,” and then announce “i'm out of here! lzozlzlzlzllzllzlzlzl! pw3d!” but why are you running away before you share with us *Why* the novel idea is ridiculous? it will save a lot of people a lot of money while adding a lot of functionality. please do explain why saving money is “ridiculous” and “idiotic.” why is that ridiculous . . . unless you work for a manufacturer of multi-thousand-dollar camera rigs/mounts? If at first an idea does not seem insane, there is no hope for it.—Einstein I am but mad North-North-West—when the wind is southerly, I know a hawk from a handsaw.—Shakespeare's Hamlet There is a method to his madness.—Shakespeare's Hamlet Here's to the crazy ones. The misfits. The rebels. The troublemakers. The round pegs in the square holes. The ones who see things differently. They're not fond of rules. And they have no respect for the status quo. You can quote them, disagree with them, glorify or vilify them. About the only thing you can't do is ignore them. Because they change things. They push the human race forward. And while some may see them as the crazy ones, we see genius. Because the people who are crazy enough to think they can change the world, are the ones who do.—Steven Jobs All truth passes through three stages. First, it is ridiculed. Second, it is violently opposed. Third, it is accepted as being self-evident. Arthur Schopenhauer German philosopher (1788-1860) why is it “ridiculous” and “idiotic,” in your estimation, to shoot stills and video simultaneously? if you could please elaborate, perhaps we could remove those elements which make the act of shooting stills and video simultaneously “idiotic and ridiculous.” please do help! hurling insults and then running away, while a common tactic employed by forum fanboyz throughout the internet, doesn't really advance the world's knowledge nor well-being. so instead of insulting/running, please do stay/enlighten us! thanks in advance! and it is not spam. it is an idea. it is an idea exalting a brand new philosophy of value, an idea 4 saving money on rigs and mounts, n idea for saving time, an idea supporting the novel concept of shooting stills and video at the same time and thusly increasing revenues, and hot chix. do it yourself! http://www.diyphotography.net/a-diy-9sh . . . -audio-too surf the industry trends! oppose or protest the future @ your own risk! http://9shooter.blogspot.com “National Geographic now looks to only hire still photographers who are also video-trained!” Well, you can't ignore National Geographic photographers and editors with over 25-years of career experience! From the luminous landscape website: Chris Sandberg I attended a lecture/slide show/presentation by photographer Sam Abell last week, as part of the National Geographic Live! season in Minneapolis. Mr. Abell has had a 25-year career shooting for National Geographic, and he was asked what an aspiring young photographer who wanted to follow in his footsteps should do, He responded that the National Geographic now looks to only hire still photographers who are also video-trained! His advice was that young photographers should be sure they are versed in both disciplines. So, we may be seeing not only the tip of the iceberg on the technology side, but truly a convergence on the artistic side, as well.—http://www.luminous-landscape.com/essays/convergence.shtml [/quote]—http://9shooter.blogspot.com/ have fun! no need to spend $1,000 on camera mounts just to feel sexy. after all, it is the end product that matters, not the mounts you used, which few will ever see, while thousands will see your end work—hopefully millions. that is why it is more important to spend money on lenses and equipment than mounts. now i can understand why manufacturers of expensive rigs could label this philosophy spam and idiotic and ridiculous, but i say 1) save money on mounts and 2) spend money on equipment! rock on! :) User avatar Posts: 8 Joined: August 2010 *E-mail photographyrox

The Dual 45 Dueler™: The Best DSLR Camera With HD Video THE BLOG: THE DUAL 45 DUELER/BEST HD VIDEO WITH DSLR STILLS BLOG! Whether it's a Nikon Stills/DSLR Camera with a Sony HD Video Camera, or a Canon DSLR with a JVC HD Camcorder, or a Panasonic Stills Camera with a Canon HD Camcorder, or a Nikon and a Sony, or a Sony and a Sony, The Dual 45 Dueler™ offers the best of both worlds, by simply offering both worlds, by allowing you to attach two devices optimized for different tasks. No longer must you choose to shoot the winning goal in stills or video, but you can now shoot them both—continuously & simultaneously! No longer must you choose to catch the bride kissing the groom in stills or video—immortalize the event both ways! Shoot once-in-a-lifetime events twice!™ In high-quality, continuous stills and video! Go into your next shoot with both guns a-blazin'!™ Contact us @ dual45dueler@gmail.com. Sign up to be notified regarding the 45surf DUAL 45 DUELER™—http://dual45dueler.com/. Imagine a store that allowed shoppers to customize brackets by selecting from a plurality of L brackets, hot-shoe mounts, threaded rods, wing-nuts, thumb-nuts, thumb-screws, coupling nuts, coupling nuts with threaded holes drilled in the side, thumb nuts with threaded holes drilled in the side, ball-socket mounts, flash shoe adapters, ball-socket flash-shoe adapters, and/or quick release plates, and more.

What is claimed is:

1. A mounting apparatus for supporting a plurality devices including cameras, microphones, audio recorders, power supplies, flash shoe mounts, ball-head swivel mounts, flash shoe adapter mounts, monitors, and more, comprising: an L-shaped bracket arm; a second L-shaped bracket arm connected to the first via a screw and nut assembly such that said first bracket is manually adjustable to a range of different angular positions relative to said second bracket arm to provide flexibility in relatively positioning the cameras, mounts, and devices which may be attached to either of the two said L brackets, where both said first bracket and said second bracket have a plurality of holes or slots for attaching and mounting mounts and devices;

2. The apparatus of claim 1, further comprising additional L brackets and/or additional straight-brackets.

3. The apparatus of claim 1, further comprising a ball-socket swivel mechanism connected to the said first bracket and/or said second bracket.

4. The apparatus of claim 1, further comprising a hot shoe mount connected to the said first bracket and/or said second bracket.

5. A mounting apparatus for supporting devices including cameras, microphones, audio recorders, flash mounts, and monitors, comprising: a threaded rod; a coupling nut with said coupling nut having threaded holes drilled in the side;

6. The apparatus of claim 5, further comprising a second threaded rod screwed into said threaded holes drilled into said connecting nut.

7. The apparatus of claim 6, further comprising flash shoe mounts connected to the free ends of said first threaded rod and said second threaded rod.

8. The apparatus of claim 6, further comprising ball socket swivel mounts are connected to the free ends of said first threaded rod and said second threaded rod.

9. The apparatus of claim 1, further comprising the apparatus of claim 6 mounted on said first bracket or the said second bracket.

10. The apparatus of claim 6, where the said connecting nut is screwed onto a tripod or monopod head, and the said threaded rod is screwed into the said coupling nuts, thusly extending the screw of the tripod or monopod head.

11. The apparatus of claim 10, further comprising additional threaded rods which are screwed into the said threaded holes drilled in the sides of said coupling nuts.

12. The apparatus of claim 6, further comprising thumb nuts with threaded holes drilled in their sides.

13. The apparatus of claim 1, further comprising the apparatus of claim 6 is mounted on said first bracket or said second bracket.

13. The apparatus of claim 1, further comprising a camera hotshoe mount on top of which said apparatus of claim 1 is mounted.

14. The apparatus of claim 1, further comprising a monopod or tripod head on top of which said apparatus of claim 1 is mounted.

15. The apparatus of claim 13, further comprising the apparatus of claim 6, which is mounted upon the apparatus of claim 13.

16. The apparatus of claim 14, further comprising the apparatus of claim 6, which is mounted upon the apparatus of claim 14.

17. The apparatus of claim 1, further comprising another or a plurality of apparatuses of claim 1.

18. The apparatus of claim 6, further comprising another or a plurality of apparatuses of claim 6.

19. A plurality of apparatuses in claim 1, further comprising a plurality of apparatuses in claim 6.

20. A store or ecommerce site allowing one to buy the components of the apparatus in claim 1 and the apparatus in claim 6 as individual components, customizable packages, or pre-selected packages.
